(19) United States
(12) Patent Application Publication
(10) Pub. No.: US 2023/0358677 A1
(43) Pub. Date: Nov. 9, 2023

(54) Reversible Excited-State Photoacids and Photobases as Dynamic Fluorescence Sensors of Protonic Species

(71) Applicants: California Institute of Technology, Pasadena, CA (US); The Regents of the University of California, Oakland, CA (US)

(72) Inventors: Annette Boehme, Pasadena, CA (US); Alexandra J. Welch, Los Angeles, CA (US); Rohit Bhide, Irvine, CA (US); Cassidy Feltenberger, San Pedro, CA (US); Shane Ardo, Irvine, CA (US); Harry A. Atwater, South Pasadena, CA (US); Dennis Tang, Irvine, CA (US)

(73) Assignees: California Institute of Technology, Pasadena, CA (US); The Regents of the University of California, Oakland, CA (US)

(21) Appl. No.: 18/303,528

(22) Filed: Apr. 19, 2023

Related U.S. Application Data
(60) Provisional application No. 63/332,540, filed on Apr. 19, 2022.
(60) Provisional application No. 63/484,978, filed on Feb. 14, 2023.

(51) Int. Cl. G01N 21/64; G01N 21/80

(52) U.S. Cl. CPC G01N 21/6428; G01N 21/80; G01N 2021/6441; G01N 2021/6443

(57) ABSTRACT

Systems and methods for sensing and measuring local pH, pOH, and other protonic species using reversible excited-state photoacids and photobases are described. Various reversible excited-state photoacids and/or photobases are described that through a dynamic sensing mechanism exhibit varied fluorescence or phosphorescence intensity based on local activity of protonic species. Photoacids and photobases can be used in combination with confocal fluorescent microscopy for quantifying local activity of protonic species.

### CROSS-REFERENCE TO RELATED APPLICATIONS

The current application claims the benefit of and priority under 35 U.S.C. § 119 (e) to U.S. Provisional Patent Application No. 63/332,540 entitled “Reversible Excited-State Weak Photoacids and Photobases as Dynamic Fluorescence Sensors of Local OH− and H+ Activity” filed Apr. 19, 2022, U.S. Provisional Patent Application No. 63/484,978 entitled “Direct Observation of the Local Microenvironment in Inhomogeneous CO₂ Reduction Gas Diffusion Electrodes via Versatile pOH Imaging” filed Feb. 14, 2023. The disclosures of U.S. Provisional Patent Application No. 63/332,540, U.S. Provisional Patent Application No. 63/484,978 is hereby incorporated by reference in its entirety for all purposes.

### GOVERNMENT SPONSORED RESEARCH

This invention was made with government support under Grant No. DE-SC0021266 awarded by the Department of Energy. The government has certain rights in the invention.

### FIELD OF THE INVENTION

The present invention generally relates to systems and methods of measuring local protonic species; and more particularly to systems and methods of using photoacids and photobases to quantify the local activity of protonic species.

### BACKGROUND OF THE INVENTION

Photoacids and photobases are molecules that, through absorption of light via an electronic transition alter their acidity, and perform reversible excited-state proton transfer (ESPT) to or from another species, thus causing a change in acidity. Acidity can be measured using an acid dissociation constant (also known as acidity constant, or acid-ionization constant, Kₐ), and/or pKₐ (the base-10 logarithm of Kₐ, pKₐ=−log₁₀ Kₐ).

Measurements of localized pH and activity of protonic species are important in various areas of electrochemistry, from corrosion to bio-electrochemistry and electrocatalysis, and various biological processes. Different techniques are available to perform these measurements and offer possibilities in terms of spatial and temporal resolution, sensitivity, and precision. Measurements of localized pH and activity of protonic species can be performed using scanning probe techniques (such as, scanning electrochemical microscopy (SECM), scanning ion conductance microscopy (SICM), scanning ion-selective electrode technique (SIET)), laser (confocal) fluorescence microscopy, rotating ring-disc electrode (RRDE) voltammetry, and infrared spectroscopy, among others.

### BRIEF SUMMARY OF THE INVENTION

Many embodiments are directed to systems and methods for measurement and sensing of local pH and activity of protonic species using reversible excited-state photoacids and photobases.

One embodiment includes a measurement system comprising: a confocal microscope; and an electrochemical cell comprising an electrode submerged in an electrolyte comprising a photochemical compound; wherein a change in a species concentration in the electrolyte at the electrode changes a fluorescent signal of the photochemical compound such that the confocal microscope detects the fluorescent signal change to measure the concentration of the species; wherein the photochemical compound comprises a photoacid or a photobase; wherein the species is selected from the group consisting of: OH⁻, H⁺, a proton acceptor, a proton donor, a dissolved inorganic carbon, formate, acetate, glycine, and phosphate; and wherein the measured concentration signal has a time resolution of less than one second, and a spatial resolution of less than one micron.

In a further embodiment, the photoacid or the photobase is a ratiometric fluorescent dye and the fluorescent signal is independent of the photoacid or the photobase concentration.

In an additional embodiment, a base-10 logarithm of an acid dissociation constant (pKₐ) of the photoacid in ground-state is greater than 14.

In another embodiment, the photoacid is selected from the group consisting of: 8-aminopyrene-1,3,6-trisulfonic acid trisodium salt (APTS), 8-anilinonaphthalene-1-sulfonic acid sodium salt, 5-((2-aminoethyl)amino)naphthalene-1-sulfonic acid sodium salt, 5-aminonaphthalene-1-sulfonic acid sodium salt (NS—NH2), 6-bromo-5-aminonaphthalene-1-sulfonic acid sodium salt, and any combinations thereof.

In a further embodiment again, the photoacid comprises APTS and DHPDS, and the measured concentration signal is pOH ranging from 0 to 8.

In a yet further embodiment, the photoacid comprises APTS, and the measured concentration signal is pH ranging from 0 to 4.

In another embodiment again, the photoacid comprises 5-((2-aminoethyl)amino)naphthalene-1-sulfonic acid sodium salt, and the measured concentration signal is pOH ranging from 0 to 6.

In yet another embodiment, the photoacid comprises 9-hydroxyphenanthrene-3,10-disufonic acid disodium salt, and the species is a dissolved inorganic carbon, formate, acetate, or a proton acceptor.

In yet another embodiment again, the photoacid comprises 1-hydroxypyrene, and the species is a dissolved inorganic carbon.

In another additional embodiment, the photoacid comprises 6-bromo-5-aminonaphthalene-1-sulfonic acid sodium salt, and the species is a proton acceptor; wherein the detection occurs from a triplet electronic excited state.

In another embodiment again, the measured concentration signal has a spatial resolution from 250 nm to one micron.

In another yet embodiment, the confocal microscope is selected from the group consisting of: a confocal laser scanning microscope, a laser confocal scanning microscope, a fluorescence confocal laser scanning microscope.

Another embodiment further comprises a gas chamber in contact with the electrode and the electrode is a gas diffusion electrode.

In a further yet embodiment, gaseous carbon dioxide is fed through the gas chamber and reacts with OH⁻ to form bicarbonate and carbonate anions, resulting in a decrease in OH⁻ concentration.

In a further embodiment again, an applied current at the electrode induces carbon dioxide reduction reactions that generate OH⁻; wherein an increase in applied current density results in a decrease in pOH.

In another further embodiment, the current density ranges from 0 mA/cm² to 200 mA/cm² in magnitude.

In yet another further embodiment, the gas diffusion electrode comprises a macro-porous gas diffusion layer, a hydrophobic microporous layer, and a catalyst.

In an additional further embodiment, the gas diffusion electrode comprises a surface with a plurality of trenches.

In a yet further embodiment, the plurality of trenches has an irregular pattern with a width ranging from 5 microns to 30 microns.

In a further yet embodiment, a pOH inside the plurality of trenches is lower than the gas diffusion electrode surface.

Another embodiment includes a method for measuring pOH comprising:
connecting a confocal microscope with an electrochemical cell comprising an electrode submerged in an electrolyte comprising a photochemical compound; wherein a change in a species concentration in the electrolyte at the electrode changes a fluorescent signal of the photochemical compound;
measuring the fluorescent signal with the confocal microscope; and
generating a concentration of the species based on the measured fluorescent signal;
   wherein the photochemical compound comprises a photoacid or a photobase; wherein the species is selected from the group consisting of: OH−, H+, a proton acceptor, a proton donor, a dissolved inorganic carbon, formate, acetate, glycine, and phosphate; and wherein the measured concentration signal has a time resolution of less than one second, and a spatial resolution of less than one micron.

In an additional embodiment again, the photoacid or the photobase is a ratiometric fluorescent dye and the fluorescent signal is independent of the photoacid or the photobase concentration.

In another yet embodiment, a base-10 logarithm of an acid dissociation constant (pKa) of the photoacid in ground-state is greater than 14.

In yet another further embodiment, the photoacid is selected from the group consisting of: 8-aminopyrene-1,3,6-trisulfonic acid trisodium salt (APTS), 8-anilinonaphthalene-1-sulfonic acid sodium salt, 5-((2-aminoethyl)amino)naphthalene-1-sulfonic acid sodium salt, 5-aminonaphthalene-1-sulfonic acid sodium salt (NS—NH2), 6-bromo-5-aminonaphthalene-1-sulfonic acid sodium salt, and any combinations thereof.

In a further embodiment again, the photoacid comprises APTS and DHPDS, and the measured concentration signal is pOH ranging from 0 to 8.

In another embodiment again, the photoacid comprises APTS, and the measured concentration signal is pH ranging from 0 to 4.

In an additional further embodiment, the photoacid comprises 5-((2-aminoethyl)amino)naphthalene-1-sulfonic acid sodium salt, and the measured concentration signal is pOH ranging from 0 to 6.

In a further yet embodiment, the photoacid comprises 9-hydroxyphenanthrene-3,10-disufonic acid disodium salt, and the species is a dissolved inorganic carbon, formate, acetate, or a proton acceptor.

In yet another embodiment, the photoacid comprises 1-hydroxypyrene, and the species is a dissolved inorganic carbon.

In a further yet embodiment, the photoacid comprises 6-bromo-5-aminonaphthalene-1-sulfonic acid sodium salt, and the species is a proton acceptor; wherein the measurement occurs from a triplet electronic excited state.

In an additional embodiment again, the measured pOH has a spatial resolution from 250 nm to one micron.

In yet another further embodiment again, the confocal microscope is selected from the group consisting of: a confocal laser scanning microscope, a laser confocal scanning microscope, a fluorescence confocal laser scanning microscope.

In a further embodiment, the electrochemical cell further comprises a gas chamber in contact with the electrode and the electrode is a gas diffusion electrode.

In another yet embodiment again, gaseous carbon dioxide is fed through the gas chamber and reacts with OH⁻ to form bicarbonate and carbonate anions, resulting in a decrease in OH⁻ concentration.

In another additional embodiment, an applied current at the electrode induces carbon dioxide reduction reactions that generates OH⁻; wherein an increase in applied current density results in a decrease in pOH.

In a yet further embodiment, the current density ranges from 0 mA/cm² to 200 mA/cm² in magnitude.

In yet another embodiment, the gas diffusion electrode comprises a macro-porous gas diffusion layer, a hydrophobic microporous layer, and a catalyst.

In a further additional embodiment, the gas diffusion electrode comprises a surface with a plurality of trenches.

In another further embodiment, the plurality of trenches has an irregular pattern with a width ranging from 5 microns to 30 microns.

In a further yet embodiment again, the pOH inside the plurality of trenches is lower than the gas diffusion electrode surface.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description will be more fully understood with reference to the following figures, which are presented as exemplary embodiments of the invention and should not be construed as a complete recitation of the scope of the invention, wherein:

FIGS. 1A and 1B illustrate a Förster cycle square scheme for a photoacid, and hypothetical photoluminescence titration data used to determine pK*_{a pseudo}.

FIGS. 2A through 2C illustrate acid-base titration of an aqueous solution of NS—NH₂ photoacid with absorption and photoluminescence detection in accordance with an embodiment.

FIGS. 3A and 3B illustrate time-resolved photoluminescence spectroscopy of aqueous solutions of the sodium salts of aminoarene photoacids in accordance with an embodiment.

FIGS. 4A and 4B illustrate acid-base titrations of aqueous trisodium 8-aminopyrene-1,3,6-trisulfonate with steady-state absorption and photoluminescence detection in accordance with an embodiment.

FIGS. 5A and 5B illustrate acid-base titrations of aqueous sodium 5-((2-aminoethyl)amino)naphthalene-1-sulfonate with steady-state absorption and photoluminescence detection in accordance with an embodiment.

FIGS. 6A and 6B illustrate acid-base titrations of aqueous sodium 8-anilinonaphthalene-1-sulfonate with steady-state absorption and photoluminescence detection in accordance with an embodiment.

FIGS. 7A and 7B illustrate photoacid lifetime-dependent pK*_{a pseudo} values in accordance with an embodiment.

FIGS. 8A and 8B illustrate transient absorption spectroscopy of NS—NH₂ in accordance with an embodiment.

FIGS. 9A through 9D illustrate Acid-base titrations of aqueous solutions of NS—NH₂ in the presence of proton-accepting quenchers with absorption and photoluminescence detection in accordance with an embodiment.

FIGS. 10A and 10B illustrate acid-base titrations of aqueous NS—NH₂ in the presence of potassium phosphate as the proton-accepting quencher with absorption and photoluminescence detection in accordance with an embodiment.

FIGS. 11A and 11B illustrate acid-base titrations of aqueous NS—NH₂ in the presence of glycine as the proton-accepting quencher with absorption and photoluminescence detection in accordance with an embodiment.

FIGS. 12A through 12C illustrate best fits of photoluminescence data obtained by acid-base titrations of aqueous solutions of NS—NH₂ in the presence of proton-accepting quenchers to the Stern-Volmer equation in accordance with an embodiment.

FIGS. 13A through 13D illustrate best fits of the inverse of the photoluminescence intensity data obtained by acid-base titrations of aqueous solutions of NS—NH₂ in the presence of proton-accepting quenchers to the Stern-Volmer equation in accordance with an embodiment.

FIGS. 14A through 14C illustrate determination of pKₐ values of proton-accepting quenchers using acid-base titration curves in accordance with an embodiment.

FIG. 15 illustrates various aromatic and heterocyclic amine based compounds as photoacids in accordance with an embodiment.

FIG. 16 illustrates various aromatic and heterocyclic amine based compounds as photoacids in accordance with an embodiment.

FIG. 17 illustrates aromatic hydroxy based compounds as photoacids in accordance with an embodiment.

FIG. 18 illustrates design rules for photoacid sensing in accordance with an embodiment. Analogous processes exist for photobases.

FIGS. 19A and 19B illustrate acid-base titrations of aqueous disodium 9-hydroxyphenanthrene-3,10-disufonate with steady-state absorption and photoluminescence detection in accordance with an embodiment.

FIG. 20 illustrates the ability of aqueous disodium 9-hydroxyphenanthrene-3,10-disufonate to sense various proton acceptors with representative structures shown in accordance with an embodiment.

FIGS. 21A and 21B illustrate Stern-Volmer analysis to determine the quenching constant Kₛᵥ for sensing proton-accepting species shown in the previous figure (color-coded the same) in accordance with an embodiment.

FIG. 22 illustrates static quenching of aqueous disodium 9-hydroxyphenanthrene-3,10-disufonate due to quenching by sodium carbonate in accordance with an embodiment.

FIGS. 23A and 23B illustrate changes in photoluminescence intensity of aqueous disodium 9-hydroxyphenanthrene-3,10-disufonate due to quenching by sodium acetate in accordance with an embodiment.

FIGS. 24A and 24B illustrate static and dynamic quenching of aqueous 1-hydroxypyrene due to quenching by dissolved inorganic carbon species in accordance with an embodiment.

FIGS. 25A through 25C illustrate a local pOH measurement setup in accordance with an embodiment.

FIGS. 26A through 26D illustrate local pOH mapping near a GDE with and without electrolyte flow in accordance with an embodiment.

FIGS. 27A through 27C illustrate local pOH mapping near a GDE with and without trenches in accordance with an embodiment.

FIGS. 28A through 28F illustrate schematic representation of the structure of both a carbon paper GDE and a PTFE GDE together with SEM images in accordance with an embodiment.

FIGS. 29A through 29C illustrate comparison of the flow patterns through PTFE GDEs with different pore sizes in accordance with an embodiment.

FIGS. 30A and 30B illustrate Faradic efficiency and partial current density of copper GDEs in accordance with an embodiment.

FIG. 31 illustrates displays pOH maps in the plane parallel to the electrode surface in accordance with an embodiment.

FIGS. 32A-32D illustrate electronic absorption spectra of aqueous sodium 8-aminopyrene-1,3,6-trisulfonate in accordance with an embodiment.

FIGS. 33A and 33B illustrate acid-base titrations of aqueous disodium 6,8-dihydroxy-1,3-pyrenedisulfonate with steady-state photoluminescence detection for calibration in accordance with an embodiment.

FIGS. 34A and 34B illustrate acid-base titrations of aqueous sodium 8-aminopyrene-1,3,6-trisulfonate with steady-state photoluminescence detection for calibration in basic pH in accordance with an embodiment.

FIGS. 35A and 35B illustrate acid-base titrations of aqueous sodium 8-aminopyrene-1,3,6-trisulfonate with steady-state photoluminescence detection for calibration in acidic pH in accordance with an embodiment.

FIG. 36 illustrates a synthesis scheme of sodium 6-bromo-5-aminonaphthalene-1-sulfonate in accordance with an embodiment of the invention.

FIG. 37A illustrates acid-base titrations of aqueous sodium 6-bromo-5-aminonaphthalene-1-sulfonate with absorption detection in accordance with an embodiment of the invention.

FIG. 37B illustrates acid-base titrations of aqueous sodium 6-bromo-5-aminonaphthalene-1-sulfonate with steady-state photoluminescence detection in accordance with an embodiment of the invention.

FIG. 38 illustrates the photoluminescence intensity of sodium 6-bromo-5-aminonaphthalene-1-sulfonate in a frozen ethanol/methanol glass (4:1, v/v) at 77 K in accordance with an embodiment of the invention.

### DETAILED DESCRIPTION OF THE INVENTION

Turning now to the drawings and data, systems and methods for local pH measurement and sensing using reversible excited-state photoacids and photobases are described. In many embodiments, various reversible excited-state weak photoacids can be used as dynamic fluorescent sensors of the local OH⁻ activity. In several embodiments, various reversible excited-state weak photobases can be used as dynamic fluorescent sensors of the local protonic activity. The photoacids and photobases can be used in combination with confocal fluorescent microscopy for measuring local OH⁻ and H⁺ activity, activity of protonic species including (but not limited to) phosphate, glycine, dissolved inorganic carbon (DIC) species such as bicarbonate and carbonate, and/or species such as acetate, formate. The base-10 logarithm of an acid dissociation constant (pKₐ) of a weak photoacid in ground-state is greater than about 14. The base-10 logarithm of a base dissociation constant (pK_{b}) of a weak photobase in ground-state is greater than about 14. Examples of weak photoacids for local OH⁻ activity measurement include (but are not limited to) 8-aminopyrene-1,3,6-trisulfonic acid trisodium salt (APTS), 8-anilinonaphthalene-1-sulfonic acid sodium salt, 5-((2-aminoethyl)amino)naphthalene-1-sulfonic acid sodium salt, 5-aminonaphthalene-1-sulfonic acid sodium salt (NS—NH₂), and 6-bromo-5-aminonaphthalene-1-sulfonic acid sodium salt. Various embodiments include sodium salt of the photoacid molecules. As can be readily appreciated, any types of salt (such as lithium, potassium, N-tetrabutylammonium) of the photoacids can be applied in accordance with various embodiments with the invention.

Photoacids and photobases are molecules that, through absorption of light via an electronic transition, perform reversible excited-state proton transfer (ESPT) to or from another species. Reversibility means that photoacids and/or photobases can be used for sustained light-to-ionic power conversion. In aqueous environments, ESPT can occur among others to and from OH⁻ and H⁺. Therefore, the presence of OH⁻ can quench the photoluminescence intensity of a weak photoacid while the presence of H⁺ can quench the photoluminescence of a weak photobase.

In many embodiments, various reversible excited-state weak photoacids or moderate photobases can be used as probes for measuring local OH⁻ activity. In several embodiments, various moderate photoacids or weak photobases can be used as probes for measuring local H⁺ activity. Under equilibrium conditions, the OH⁻ activity can be connected to the pH and pOH values with pOH=−log(a_{OH-}) and pH=pK_{w}−pOH≈14−pOH. Knowing the OH⁻ activity also allows to determine the local pOH and pH values under equilibrium conditions. However, under non-equilibrium steady-state conditions, pH and pOH are unrelated.

Several embodiments use various reversible excited-state weak photoacids as fluorescent sensors for measuring the local OH⁻ activity using confocal fluorescent microscopy. A confocal microscope can measure the local fluorescent signal of a probe time-resolved and spatially-resolved in three dimensions. As the fluorescent signal of photoacids is sensitive to the OH⁻ activity, it can create three-dimensional, time-resolved maps of the local OH⁻ activity with resolution on the micrometer scale. Photoacids such as APTS have additional advantage that they are ratiometric. Ratiometric fluorescent dye' refers to a probe with a spectrum that exhibits at least two distinct peaks with intensities changing in opposite directions upon varying the parameter to which the probe is sensitive. By evaluating the ratio between the peak intensities, the observed signal becomes independent of the local dye concentration. For APTS, its fluorescent spectrum has two distinct peaks whose intensity changes in different directions upon change of the OH⁻ activity. By calculating the ratio of the signals integrated over the two distinct peaks, the signal becomes independent of the APTS concentration.

Systems and methods for measuring the local OH⁻ activity have spatial resolution on the micron-scale and can create OH⁻ activity maps on all planes in the three-dimensional space. It also allows mapping of the OH⁻ activity around and in complex geometrical features, such as inside trenches on a surface.

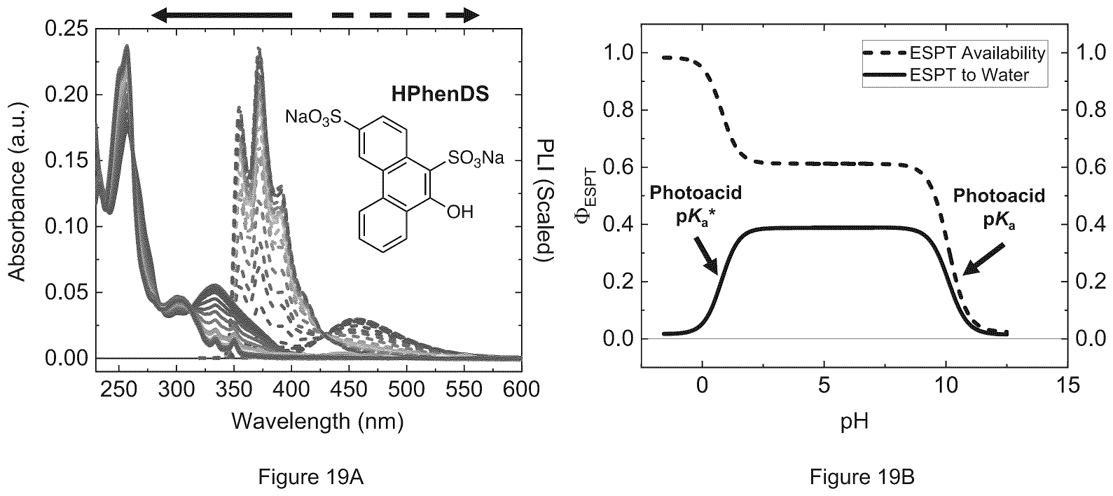

The accessible pOH range of APTS is approximately from about 0 to about 3, which corresponds to pH of about 11 to about 14 under equilibrium conditions. Furthermore, APTS is a dual photoacid. In addition to OH⁻ activity, APTS can also detect H⁺ activity under acidic conditions with a pH between about −4 and about 0 with a dynamic excited-state mechanism, as illustrated for disodium 9-hydroxyphenanthrene-3,10-disufonate in FIGS. 19A and 19B with pH sensing between about −1 and about 3, and with a pH between about 0 and about 4 with a ground-state mechanism. Therefore, under equilibrium conditions, the accessible pH range spans approximately from about −4 to about 4 and from about 11 to about 14.

In many embodiments, weak photoacids can be used for sensing and mapping local pOH (or pH) in the pOH range between about 0 and 8 and/or at current densities from about 0 mA/cm² to about −200 mA/cm². In several embodiments, weak photoacids can be used to map the local pOH value around gas diffusion electrodes (GDEs) for CO₂ reduction (CO₂R). The micrometer-scale morphology of a carbon dioxide reduction GDE can affect the mass transport properties and the local CO₂R performance. GDEs are porous electrodes coated with a catalyst that can create a three-phase interphase between solid (catalyst), liquid (electrolyte) and gas (CO₂) and allow to reduce CO₂ with much higher rates compared to a conventional setup. CO₂ undergoes reactions with the electrolyte and causes an increase in hydroxide anions (OH⁻) activity. The local activity of OH⁻, represented by the pOH value, around a GDE in contact with an aqueous electrolyte is an important parameter that governs the catalytic activity and CO₂R selectivity. The combination of weak photoacids and confocal microscopy can map the inhomogeneous CO₂ flow through the GDE via local pOH imaging with time- and three-dimensional spatial micrometer-scale resolution. Furthermore, upon applying an electrical current to the GDE, three-dimensional pOH maps around an operating GDE for CO₂ reduction can be created, which enables the observance of a decrease in pOH for increasing current density. The local pOH value inside trenches on the GDE surface can also be measured and mapped, which shows that the pOH inside trenches is lower than on the GDE surface.

In certain embodiments, confocal microscopy including (but not limited to) confocal laser scanning microscopy (CLSM), laser confocal scanning microscopy (LCSM), fluorescence confocal laser scanning microscopy, can be used to create maps of the local pOH around a copper GDE by combining various ratiometric fluorescent dyes including (but not limited to) DHPDS and APTS. The dyes may have different sensing mechanisms. The local pOH decreases when current is applied due to the creation of OH⁻ as a byproduct of CO₂R. The pOH is lower inside microtrenches of the GDE compared to the electrode surface and decreases further as trenches become narrower due to enhanced trapping of OH⁻. Multiphysics simulations correlate well with measurements and reveal that the decreased pOH inside microcavities in the surface of a CO₂R GDE leads to locally enhanced selectivity towards multicarbon (C₂₊) products. Narrow microstructures on the length scale of about 5 μm in a GDE surface can serve as local CO₂R hotspots.

### Excited-State Acidity pK*ₐ

Photoacids and photobases are molecules that, through absorption of light via an electronic transition, perform reversible excited-state proton transfer (ESPT) to or from another species, and undergo a reversible change in acidity (pKₐ). Reversibility means that photoacids/photobases can be used for sustained light-to-ionic power conversion, which differs from stoichiometric photoacid or photobase generators that are used in photolithography and undergo irreversible proton-transfer reactions. Reversible ESPT from photoacids has been exploited for high spatiotemporal sensing of local pH during electrochemical reactions, to study proton-coupled reaction mechanisms, to trigger processes in biological organisms relevant to energy transduction, and in the design of artificial light-driven proton pumps. (See, e.g., Leenheer, A. J.; et al., J. Electrochem. Soc. 2012, 159, H752-H757; Fuladpanjeh-Hojaghan, B.; et al., Angew. Chemie Int. Ed. 2019, 58 (47), 16815-16819; Pande, N.; et al., J. Phys. Chem. Lett 2020, 11 (17), 7042-7048; Welch, A. J.; et al., J. Phys. Chem. C 2021, 125 (38), 20896-20904; Dempsey, J. L.; et al., J. Am. Chem. Soc. 2010, 132 (47), 16774-16776; Haghighat, S.; et al., J. Phys. Chem. B 2016, 120 (5), 1002-1007; Shafaat, O. S.; et al., Chem Bio Chem 2016, 17 (14), 1323-1327; Xie, X.; et al., Nat. Chem. 2014, 6 (3), 202-207; White, W.; et al., J. Am. Chem. Soc. 2017, 139 (34), 11726-11733; White, W.; et al., Joule 2018, 2 (1), 94-109; Wang, L.; et al., Adv. Mater. 2019, 31 (36), 1903029; Schulte, L.; et al., Joule 2021, 5, 1-15; Luo, S.; et al, Energy Environ. Sci. 2021, 14, 4961-4978; the disclosures of which are herein incorporated by reference.) An important consideration for these applications is that ESPT is chemically specific. This means that ESPT in aqueous environments can at least occur to and from H₂O(l), from H⁺(aq), and to O⁻(aq), with rates dictated by the laws of mass action and mass transfer. These continuity of mass processes enable water to serve as a protonic semiconductor.

ESPT occurs due to a change in the energetics of a protic bond, which more broadly influences the Brønsted-Lowry acidity of the photoacid/photobase. This change in acidity is quantified through measurement of the acid dissociation equilibrium constant, Kₐ, which changes in the excited state to K*ₐ. Knowledge of the excited-state pKₐ value, pK*ₐ, is important for predicting ESPT behavior. (See, e.g., Ireland, J. F.; et al., In Advances in Physical Organic Chemistry; Academic Press, 1976; Vol. 12, pp 131-221; Shizuka, H.; Acc. Chem. Res. 1985, 18 (5), 141-147; Arnaut, L. G.; et al., J. Photochem. Photobiol. A Chem. 1993, 75 (1), 1-20; Tolbert, L. M.; et al., Acc. Chem. Res. 2002, 35 (1), 19-27; Agmon, N.; J. Phys. Chem. A 2005, 109 (1), 13-35; the disclosures of which are herein incorporated by reference.) Overall excited-state processes that occur for a hypothetical photoacid, PAH, are as follows,

$$\begin{matrix}{PAH}^{*} ( aq ) + B ( aq ) {⇌}_{{k}_{- q}}^{{k}_{+ q}} {PA}^{{-}^{*}} ( aq ) + {BH}^{+} ( aq ) & {K}_{q} = \frac{{k}_{+ q}}{{k}_{- q}}\end{matrix} \qquad ( 1 )$$

$${PAH}^{*} ( aq ) {⇌}_{h υ , Δ}^{{τ}_{{PAH}^{*}}^{- 1}} PAH ( aq ) \qquad ( 2 )$$

where B stands for the proton acceptor. When B=H₂O(l), K_{q}=K*ₐ, and when B=OH⁻(aq), K_{q}=(K*_{b})⁻¹, where K*_{b} stands for the excited-state base dissociation equilibrium constant and is related to K*ₐ as

$${K}_{b}^{*} = \frac{{K}_{w}}{{K}_{a}^{*}} ,$$

with K_{w} being the autoprotolysis equilibrium constant of water and is equal to 10⁻¹⁴ at room temperature.

For the purpose of the disclosure, the values are reported as pX. pX equals to “−log X” or “−log a_{X}”, where a_{X} stands for the activity of species X. In some instances, the general equilibrium constant K, can be used for photoacids and photobases, without specifying Kₐ for photoacids, and K_{b} for photobases. For example, pK* can represent pK*ₐ value for photoacids and/or pK*_{b} value for photobases.

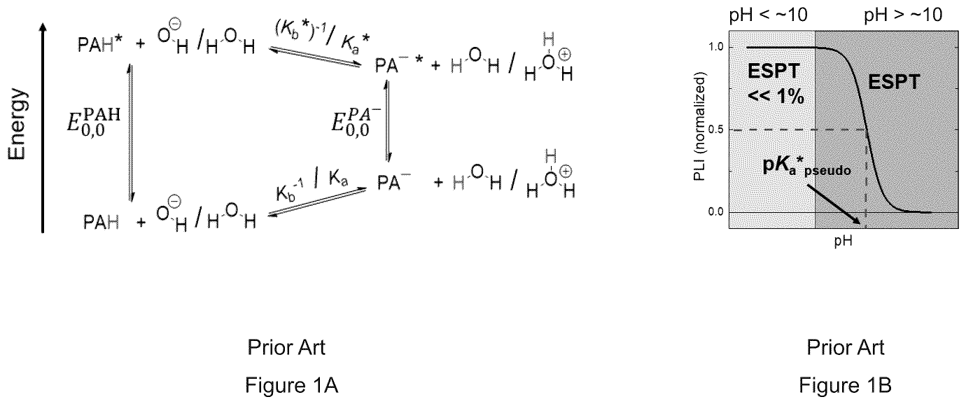

As the ESPT process is chemically specific, choosing a photoacid or a photobase for a particular application requires accurate quantification of its pK*. One way to approximate pK* is by adding the approximate value of ΔpK* to its ground-state pK value. Values for ΔpK* can be approximated based on the Förster cycle square scheme, via an analysis derived by Förster using the first law of thermodynamics. FIGS. 1A and 1B illustrate a Förster cycle square scheme for a photoacid, and hypothetical photoluminescence titration data used to determine pK*_{a pseudo}. FIG. 1A shows a Förster cycle square scheme illustrating the reversible processes of deprotonation/protonation of a photoacid/conjugate-base by a solvated hydroxide/water and/or solvated water/proton in its ground state (PAH/PA⁻) and excited state (PAH*/PA⁻*). FIG. 1B shows typical trend in data observed for normalized photoluminescence intensity as a function of solution pH for a photoacid that exhibits pH-dependent quantum yields for excited-state proton transfer (ESPT). Excited-state acidity can be quantified using standard analyses based on the Henderson-Hasselbalch equation, which may result in erroneous values for pK*ₐ (pK*_{a pseudo}) of weak photoacids. This analysis assumes that light absorption results in prompt formation of the thermally equilibrated excited state, and that changes in entropy ΔS^{o} that accompany proton transfer are similar for ground-state and excited-state species, such that ΔΔS^{o}≈0. While often these assumptions do not strictly hold, this analysis has been shown to provide rather accurate values of pK*, provided that ground-state pK is known. Ground-state pK can be measured when it falls within the thermodynamic window for the stability of water toward undergoing proton-transfer reactions, i.e. when 0≤pK≤14.

However, for weak photoacids and/or photobases, the ground state pK value is greater than about 14, and often greater than about 20. Because of this fundamental difference, the Förster cycle analysis cannot be used to approximate pK* values for weak photoacids and/or photobases. It is difficult to quantify acidity of weak photoacids and photobases with less acidic (basic) excited states (pK* greater than about 7) accurately in water.

Another method for determining pK* involves acid-base titrations with steady-state photoluminescence detection, and data analysis using the Henderson-Hasselbalch equation with adjustment for excited-state lifetimes. (See, e.g., Ireland, J. F., et al., In Advances in Physical Organic Chemistry; Academic Press, 1976; Vol. 12, pp 131-221; the disclosure of which is incorporated herein by reference.) This analysis assumes that the excited state reaches quasi-equilibrium, meaning that protonated and deprotonated excited-state species each persist long enough to speciate according to pK*. Strong photoacids/photo bases, whose pK* less than about 0, often reach excited-state chemical quasi-equilibrium, because of their rapid near-molecular-vibration-limited rate of ESPT with water (forward direction of Reaction 1 with B=H₂O(l)) and relatively longer excited-state lifetimes on the nanosecond timescale (forward direction of Reaction 2). However, the excited-state chemical quasi-equilibrium state may not occur for weak photoacids (photobases) due to slow rates of excited-state proton transfer. Many chromophoric protic molecules are weak photoacids/photobases, meaning that pK* greater than about 7, such that ESPT with water, whose pK_{b}=0 and whose conjugate acid (H⁺(aq)) has pKₐ=0, is moderately thermodynamically unfavorable and as such there is a significant kinetic barrier to proton transfer that greatly slows ESPT. When the excited-state lifetime of weak photoacids/photobases is too short and/or pK* is too large, excited-state chemical quasi-equilibrium cannot be reached, thus reported pK* values are inaccurate.

Given the inadequacy of thermodynamic analyses, such as the ones based on the Förster cycle square scheme and the Henderson-Hasselbalch equation, kinetic analyses should be considered in order to accurately quantify pK*ₐ values of weak photoacids. While a combination of short excited-state lifetime and weak photoacidity/photobasicity prohibits ESPT from occurring between photoacids/photobases and water, it also provides an opportunity to study ESPT with other proton-accepting/donating quenchers, even in liquid water. On the contrary, such experiments are more difficult to perform with strong photoacids/photobases due to competing ESPT with water. ESPT quenching of organic or inorganic photoacids with proton acceptors or photobases with proton donors has been previously reported. (See, e.g., Weller, A.; et al., Phys. Chemie 1954, 58 (10), 849-853; Weller, A.; Phys. Chemie 1957, 61 (8), 956-961; Weller, A. Prog. React. Kinet. 1961, 1, 187-214; Förster, T., Naturwissenschaften 1949, 36 (6), 186-187; Förster, T.; et al., Chem. Phys. Lett. 1975, 34 (1), 1-6; Gafni, A.; et al., Chem. Phys. Lett. 1978, 58 (3), 346-350; Laws, W. R.; et al., J. Phys. Chem. 1979, 83 (7), 795-802; Wan, P.; et al., J. Org. Chem. 1983, 48 (6), 869-876; Chattopadhyay, N.; et al., J. Photochem. 1987, 38, 301-309; Chattopadhyay, N.; J. Photochem. Photobiol. A Chem. 1989, 48 (1), 61-68; Chattopadhyay, N.; J. Photochem. Photobiol. A Chem. 1995, 88 (1), 1-4; Turro, C.; et al., J. Am. Chem. Soc. 1995, 117 (35), 9026-9032; Hicks, C.; Coord. Chem. Rev. 2001, 211 (1), 207-222; Stewart, D. J.; Proc. Natl. Acad. Sci. U.S.A. 2013, 110 (3), 876-880; Pines, E.; et al., Chem. Phys. Lett. 1997, 281 (4-6), 413-420; Mohammed, O. F.; et al., Chem. Phys. 2007, 341 (1-3), 240-257; Adamczyk, K.; et al., Science 2009, 326 (5960), 1690-1694; Adamczyk, K.; et al., Isr. J. Chem. 2009, 49, 217-225; Munitz, N.; et al., Isr. J. Chem. 2009, 49, 261-272; the disclosures of which are herein incorporated by reference.) Several of the prior studies focused specifically on weak photoacids or photobases, a few used the dynamic Stern-Volmer quenching analysis, and a few analyzed a series of proton-accepting quenchers each with a known pK value to obtain a suite of data that describes the dependence of the rate constant for ESPT on the proton-accepting ability, pK, of the quencher. When the driving force for such proton-transfer reactions is large and unfavorable, meaning ΔG^{o}>>0, a linear free energy relationship exists, as observed by Brønsted. (See, e.g., Brønsted, J. N.; et al., Phys. Chem. 1924, 108, 185; the disclosure of which is herein incorporated by reference.) When the driving force is small, meaning that the pK of the proton-accepting/donating quenchers is similar to the pK of the molecule of interest, non-linear free energy relationships exist due to a non-zero activation free energy (ΔG^{‡}), as observed by Eigen. (See, e.g., Eigen, M.; Pure Appl. Chem. 1963, 6 (1), 97-116; Eigen, M.; Angew. Chemie Int. Ed. English 1964, 3 (1), 1-19; Eigen, M.; Faraday Soc. 1965, 39, 7-15; the disclosures of which are herein incorporated by reference). This is because, like electron-transfer reactions, proton-transfer reactions with small driving forces, meaning ΔG^{o}≈0, do not exhibit a linear dependence between ΔG^{‡}and ΔG^{o}. Non-linear free energy relationships based on the semiempirical Rehm-Weller model for excited-state electron-transfer reactions, which include a steady-state approximation, have been applied to analyze data for ground-state and excited-state proton-transfer reactions between photoacids and water. (See, e.g., Solntsev, K. M.; et al., J. Phys. Chem. A 2004, 108 (40), 8212-8222; the disclosure of which is herein incorporated by reference.) Analogous semiempirical models for proton transfer, developed by Marcus and Cohen, Agmon and Levine, Arnaut and Formosinho, and Kiefer and Hynes, have been used to analyze data for ESPT between photoacids/photobases and various proton acceptors/donors. (See, e.g., Marcus, R. A.; J. Phys. Chem. 1968, 72 (3), 891-899; Cohen, A. O.; et al., J. Phys. Chem. 1968, 72 (12), 4249-4256; Agmon, N.; et al., Chem. Phys. Lett. 1977, 52 (2), 197-201; Agmon, N.; Int. J. Chem. Kinet. 1981, 13 (4), 333-365; Arnaut, L. G.; et al., J. Phys. Chem. 1988, 92 (3), 685-691; Kiefer, P. M.; et al., J. Phys. Chem. A 2002, 106 (9), 1834-1849; Kiefer, P. M.; et al., J. Phys. Chem. A 2002, 106 (9), 1850-1861; the disclosures of which are herein incorporated by reference). Each of these studies used ultrafast spectroscopy to quantify rate constants for ESPT, and in no cases were weak photoacids studied.

Many embodiments implement steady-state photoluminescence spectroscopy coupled to models for interpretation of excited-state electron-transfer dynamics to accurately quantify pK*ₐ of a weak photoacid based on analysis of its excited-state proton-transfer dynamics. Several embodiments use liquid water and aqueous hydroxide as proton-accepting quenchers of excited-state photoacids. Stern-Volmer quenching analysis is appropriate to extract rate constants for excited-state proton transfer from a weak photoacid to a series of proton-accepting quenchers. Analysis of the data by Marcus-Cohen bond-energy-bond-order theory yields an accurate value for pK*ₐ of a weak photoacid. The method can be broadly accessible because it only uses steady-state photoluminescence spectroscopy.

Accurate knowledge of pK* values for weak photoacids/photobases can be useful for applications including (but not limited to) direct sensing of proton-accepting or proton-donating species in water via dynamic ESPT quenching. In certain embodiments, quantifying pK* of a weak photoacid/photobase can provide benefit to ocean deacidification via carbon capture, where ESPT can impart direct protonation/deprotonation of bicarbonate. Moreover, protonation of anionic bicarbonate can also increase activities and/or vary selectivity for electrochemical CO₂ reduction by overcoming Coulombic repulsion with a negatively polarized electrode. Additionally, accurate knowledge of pK* values enables specific control over direct protonation/deprotonation of amino acid residues in proteins that influence processes, such as opening and/or closing of ion-selective channels, which will allow the processes to have larger per photon quantum yields in comparison to typical processes where light is used to alter bulk pH under steady-state conditions.

### Weak Photoacids NS—NH₂

Electronic absorption spectra obtained via acid-base titration of an aqueous solution of the sodium salt of 5-amino-1-naphthalenesulfonic acid (NS—NH₂) suggest that the protonation state of ground-state NS—NH₂ is unchanged over the pH/Hₒ range of 15.0 (strongly alkaline) to 6.8 (weakly acidic). This implies that NS—NH₂ exhibits pKₐ greater than about 17, which is consistent with pKₐ values of analogous aromatic amines, and not sulfonate groups. The sulfonate groups do not to participate in proton-transfer reactions over the intended pH range, but they may enhance desired water solubility and attenuate undesired aggregation. Steady-state photoluminescence spectra obtained over the same pH range vary in intensity, which suggests that a pH-dependent reaction(s) occurred in the excited state, most likely ESPT with the aromatic amine group on excited-state NS—NH₂*. An erroneous method to determine a value of the excited-state pKₐ (pK*_{a pseudo}) of about 12.34±0.02, as the mean±standard deviation from two independent measurements, is performed by simultaneous global analysis of both single-wavelength steady-state photoluminescence spectroscopy datasets to the Henderson-Hasselbalch equation,

$$θ = \frac{1}{1 + {10}^{( pH - {pK}_{a pseudo}^{*} )}} \qquad ( 3 )$$

where θ is the normalized photoluminescence intensity,

$$θ = \frac{PLI}{{PLI}_{max}} .$$

Because the Henderson-Hasselbalch equation is derived for proton-transfer reactions at thermal and chemical equilibrium, it is agnostic to whether the ESPT acceptor species are H₂O(l) or OH⁻(aq), but it does require that the system has reached excited-state quasi-equilibrium. Table 1 below lists ground-state and excited-state acidities of aromatic-amine-based photoacids.

TABLE 1
Ground-state and excited-state acidities of aromatic-amine-based photoacids.

| Photoacid | Chemical structure | pKₐ | pKₐ* pseudo | ΔpKₐ pseudo |
|---|---|---|---|---|
| indole | 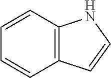 | 16.2 | 12.3 | −3.9 |
| carbazole | 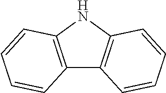 [SMILES: c1ccc2c(c1)[nH]c1ccccc12] | 21.1 | 11.9 | −9.2 |
| 3,5-diphenylpyrazole | 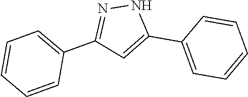 [SMILES: c1ccc(-c2cc(-c3ccccc3)[nH]n2)cc1] | 12.94 | 12.64 | −0.3 |
| 6-aminochrysene | 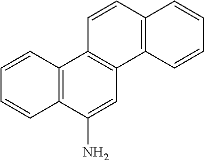 [SMILES: Nc1cc2c3ccccc3ccc2c2ccccc12] | >14 | 12.6 | < −1.4 |
| 1-naphthylamine | 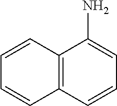 [SMILES: Nc1cccc2ccccc12] | >16 | 11.35 | < −4.65 |
| 2-naphthylamine | 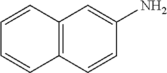 [SMILES: Nc1ccc2ccccc2c1] | 14.95 | 11.75 | −3.2 |
| m-anisidine | 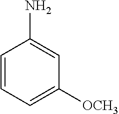 | >16 | 13.7 | < −2.3 |
| p-anisidine | 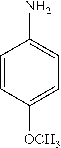 | >16 | 13.3 | < −2.7 |
| 2-amino-3-naphthoic acid | 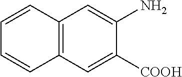 [SMILES: Nc1cc2ccccc2cc1C(=O)O] | >16 | 12.8 | < 3.2 |
| methyl-2-amino-3- naphthoate | 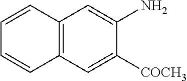 [SMILES: CC(=O)c1cc2ccccc2cc1N] | 14.6 | 12.1 | −2.5 |
| 3-aminoquinoline | 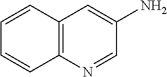 [SMILES: Nc1cnc2ccccc2c1] | — | 12.1 | — |
| 2-(2′-N-methyl- aminophenyl)-N- methylbenzimidazole | 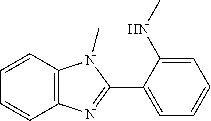 [SMILES: CNc1ccccc1-c1nc2ccccc2n1C] | — | 12.2 | — |
| 1,5-diaminoanthraquinone | 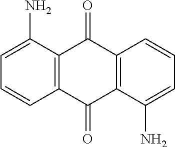 [SMILES: Nc1cccc2c1C(=O)c1cccc(N)c1C2=O] | >14 | 12.3 | < −1.7 |
| 2,6-diaminoanthraquinone | 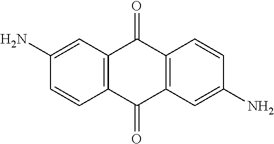 [SMILES: Nc1ccc2c(c1)C(=O)c1ccc(N)cc1C2=O] | >15.6 | 14.2 | < −1.4 |
| 4-aminodiphenylamine | 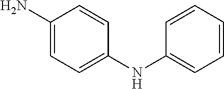 [SMILES: Nc1ccc(Nc2ccccc2)cc1] | >16.0 | 11.2 | < −4.8 |
| 4,4′-diaminodiphenylamine | 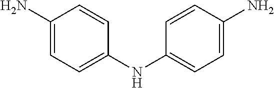 [SMILES: Nc1ccc(Nc2ccc(N)cc2)cc1] | >14.2 | 13.5 | < −0.7 |
| 6-aminonicotinic acid | 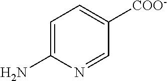 | — | 14.2 | — |
| methyl-6-aminonicotinate | 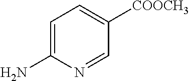 [SMILES: COC(=O)c1ccc(N)nc1] | — | 11.1 | — |
| 2-aminobiphenyl | 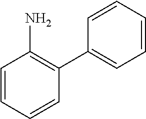 [SMILES: Nc1ccccc1-c1ccccc1] | >15.0 | 12.1 | < −2.9 |
| 3-aminobiphenyl | 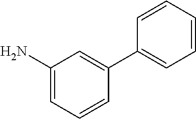 [SMILES: Nc1cccc(-c2ccccc2)c1] | >15.0 | 12.0 | < −3.0 |
| 4-aminobiphenyl | 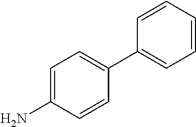 [SMILES: Nc1ccc(-c2ccccc2)cc1] | >15.5 | 14.25 | < −1.25 |
| 2-aminofluorene | 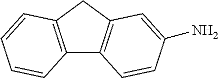 [SMILES: Nc1ccc2c(c1)Cc1ccccc1-2] | — | 13.0 | — |
| 2,3-diaminonaphthalene | 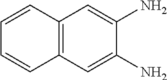 [SMILES: Nc1cc2ccccc2cc1N] | >16 | 12.9 | < −3.1 |
| indole-4-carboxylic acid | 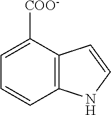 | 16.4 | 12.2 | −4.2 |
| 2,7-diaminofluorene | 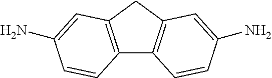 [SMILES: Nc1ccc2c(c1)Cc1cc(N)ccc1-2] | >16 | 13.9 | < −2.1 |
| 5-aminoindole | 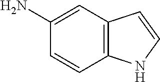 | 16.1 | 14 | −2.1 |
| 9-phenanthrylamine | 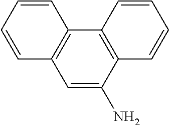 [SMILES: Nc1cc2ccccc2c2ccccc12] | >14 | 12.18 | < −1.82 |
| bis(4-aminophenyl)ether | 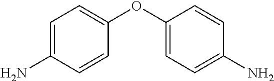 [SMILES: Nc1ccc(Oc2ccc(N)cc2)cc1] | — | 11.2 | — |
| indole-2-carboxylic acid | 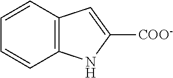 | 17.1 | 12.9 | −4.2 |
| indole-3-carboxylic acid | 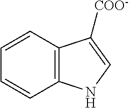 | 15.6 | 13.1 | −2.5 |
| indole-5-carboxylic acid | 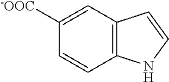 | 16.9 | 12.3 | −4.6 |
| 3-methoxyindazole | 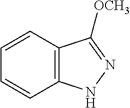 [SMILES: COc1n[nH]c2ccccc12] | 14.0 | 11.7 | −2.3 |
| 2-aminonaphthalene-6- sulfonate | 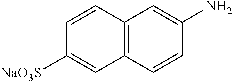 | — | 11.86 | — |

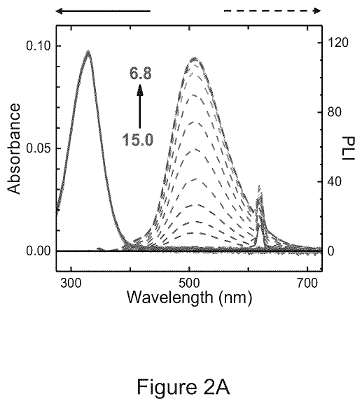

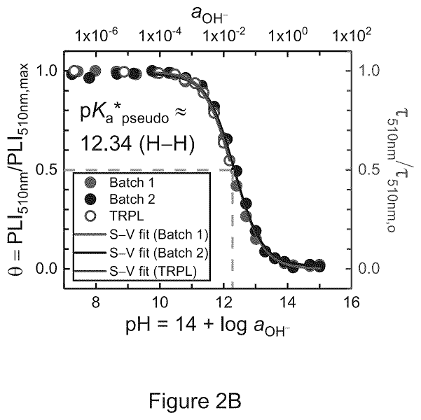

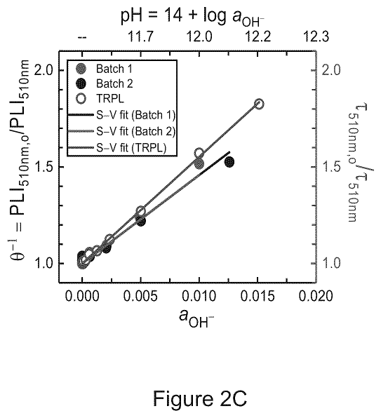

FIGS. 2A through 2C illustrate acid-base titration of an aqueous solution of NS—NH₂ photoacid with absorption and photoluminescence detection in accordance with an embodiment. FIG. 2A shows absorption spectra and corrected steady-state photoluminescence spectra during excitation at about 310 nm (with detection of its second-order diffraction at about 620 nm) for an aqueous solution of the sodium salt of 5-amino-1-naphthalenesulfonic acid (NS—NH₂) as the pH is varied between about 15.0 (using the Hammett basicity scale) and about 6.8. FIG. 2B shows normalized steady-state photoluminescence intensity (θ, left axis) at the emission maximum (510 nm) for the data in FIG. 2A (red), and a second trial (black), as well as normalized NS—NH₂* lifetimes (T/Tₒ, right axis) obtained at 510 nm using nanosecond time-resolved photoluminescence spectroscopy (open blue circles), each versus pH (bottom axis), and simultaneous global analysis of both steady-state datasets via non-linear least-squares best fits to the Henderson-Hasselbalch (H-H) equation (Equation 3), which is equivalent to the non-linear Stern-Volmer (S-V) equation with OH⁻(aq) as the quencher (Equation 4). Best fits of the steady-state data yield pK*_{a pseudo} equals to about 12.34±0.02 (H-H), K_{SV,ss,OH}_{^{−}} equals to about 47±1 M⁻¹ (S-V), and a bimolecular rate constant of about (10.0±0.3)×10⁹ M⁻¹ s⁻¹, and best fits of the lifetime data yield K_{SV,τ,OH}_{^{−}} equals to about 54±6 M⁻¹ and a bimolecular rate constant of about (12±1)×10⁹ M⁻¹ s⁻¹, each for the forward direction of Reaction 1 with B=OH⁻(aq). FIG. 2C shows reciprocal of the data in FIG. 2B versus the activity of OH⁻(aq) (a_{OH}_{^{−}}, bottom axis) each least-squares best fit to the traditional linearized Stern-Volmer equation with OH⁻(aq) as the quencher (reciprocal of Equation 4), which yields K_{SV, ssOH}_{^{−}} equals to about 46±1 M⁻¹ (left axis) and K_{SV,τ,OH}_{^{−}} equals to about 55±1 M⁻¹ (right axis).

Observed rate constants can be determined for excited-state proton transfer from weak photoacids to a series of proton-accepting quenchers. For most aromatic amines, whose pKₐ values are quite basic and excited-state lifetimes are about 1-10 ns, acid-base titration with photoluminescence detection and data analysis using the Henderson-Hasselbalch equation result in pK*_{a pseudo} about 12, irrespective of ground-state pKₐ value, which ranges from about 14 to about 21. The disparity in the size of the ranges of pKₐ and pK*_{a pseudo} values suggest that analyses used to determine at least one of them may be inaccurate. The simplicity and ubiquity of Henderson-Hasselbalch analysis for ground-state proton-transfer reactions suggest that ground-state pKₐ values are accurate but that application of the Henderson-Hasselbalch equation to ESPT processes with NS—NH₂* may be erroneous due to insufficient time to reach excited-state quasi-equilibrium. This implies that steady-state photoluminescence spectroscopy data are influenced by the rate of ESPT (forward direction of Reaction 1) in relation to the rate of excited-state deactivation (forward direction of Reaction 2) and that ESPT can be thought of as a quenching process of NS—NH₂* by OH⁻(aq), suggesting that the physically different Stern-Volmer analysis may be more accurate than Henderson-Hasselbalch analysis.

The Henderson-Hasselbalch equation is mathematically identical to the Stern-Volmer equation when the quencher is assumed to be OH⁻(aq) for photoacids (and H⁺(aq) for photobases),

$$θ = \frac{1}{1 + {10}^{( pH - ( {pK}_{w} {pK}_{b pseudo}^{*} ) )}} = \frac{1}{1 + {10}^{( {pK}_{b pseudo}^{*} - pOH )}} = \frac{1}{1 + {( {K}_{b pseudo}^{*} )}^{- 1} {a}_{{OH}^{-}}} = \frac{1}{1 + ( {K}_{SV , {OH}^{-}} ) {a}_{{OH}^{-}}} \qquad ( 4 )$$

where a_{OH}_{^{−}} is the activity of OH⁻(aq), K*_{b pseudo} is an erroneous observed equilibrium constant for base dissociation and K_{SV,OH}_{^{−}} is the Stern-Volmer quenching constant, which is strictly dimensionless but reported here in units of M⁻¹ to be consistent with its typical usage. Unlike the Henderson-Hasselbalch equation, the Stern-Volmer equation is also applicable to non-equilibrium processes. When interaction of NS—NH₂ and OH⁻ occurs in the dark, prompt static quenching of photoluminescence is often observed and K_{SV,OH}_{^{−}} stands for the equilibrium constant for the interaction. When NS—NH₂* and OH⁻ interact irreversibly during the excited-state lifetime of the photoacid, dynamic quenching of photoluminescence is observed, such that

$$θ = \frac{{τ}_{{PAH}^{*}}}{{τ}_{o , {PAH}^{*}}}$$

and K_{SV,OH}_{^{−}}=k_{+q,OH}_{^{−}}τ_{o,PAH*}, where τ is the excited-state lifetime (s) of NS—NH₂* in the absence (τ_{o,PAH*}) or presence (τ_{PAH*}) of OH⁻ quencher and k_{+q,OH-} is the bimolecular rate constant (M⁻¹ s⁻¹) for quenching of NS—NH₂* by OH⁻ (forward direction of Reaction 1 with B=OH⁻(aq)).

To decipher contributions from static and dynamic quenching processes between NS—NH₂* and OH⁻, time-resolved photoluminescence spectroscopy measurements with nanosecond time resolution are conducted, and data are best fit to a single decaying exponential function. Changes in observed excited-state lifetime are clear, thus supporting that dynamic quenching is operative, while changes in initial photoluminescence intensity are less clear and could not be quantified accurately due to signal convolution by the instrument response function, thus providing little insight into whether static quenching was operative. Excited-state lifetimes of NS—NH₂* in strongly alkaline solutions (pH greater than about 12) could not be measured, because the forward direction of Reaction 1 is faster than instrument time resolution, due to mass action and large a_{OH}_{^{−}}, and photoluminescence from NS—NH⁻* is not observed within the instrument signal detection limit. Nevertheless, the near identical results from Stern-Volmer analysis of steady-state photoluminescence spectroscopy data (K_{SV,SS,OH}_{^{−}} equals to about 47±1 M⁻¹) and excited-state lifetime data (K_{SV,τ,OH}_{^{−}} equals to about 54±6 M⁻¹) (FIG. 2B and 2C) support that dynamic quenching is the dominant process responsible for decreases in photoluminescence intensity. As such, K_{SV,OH}_{^{−}} values can be converted into bimolecular quenching rate constants using τ_{o,NS—NH}_{₂}_{*} of about 4.7 ns. Doing so yields values that are close to rate constants predicted for encounter-controlled diffusion-limited reactivity, K_{SV,ss,OH}_{^{−}} equals to about (10±0.3)×10⁹ M⁻¹ s⁻¹ and k_{+q,τ,OH}_{^{−}} equals to about (12±1)×10⁹ M⁻¹ sM⁻¹, which are consistent with proton-transfer rate constants measured by Brønsted and Eigen for ground-state proton-transfer processes.

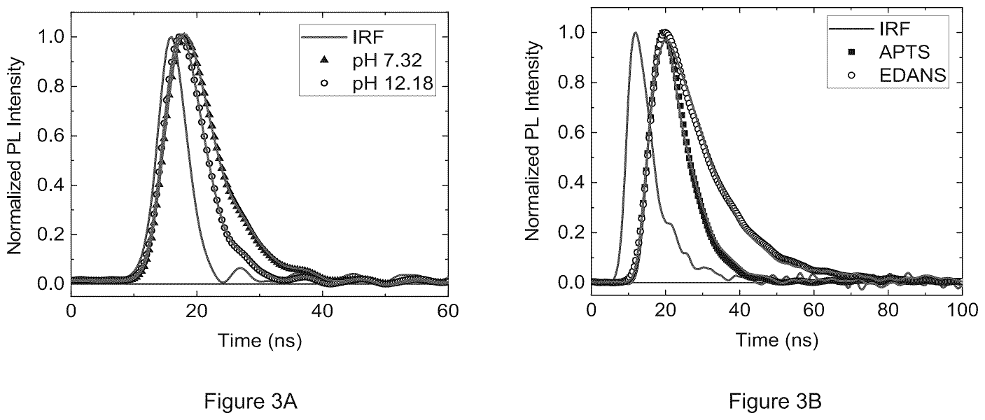

FIGS. 3A and 3B illustrate time-resolved photoluminescence spectroscopy of aqueous solutions of the sodium salts of aminoarene photoacids in accordance with an embodiment. FIG. 3A shows normalized photoluminescence intensity of NS—NH₂ at about 510 nm obtained using time-resolved photoluminescence spectroscopy plotted as a function of time at near-neutral pH (pH 7.32) and in alkaline solution (pH 12.18). Excited-state lifetimes of NS—NH₂ (τₒ4=.69 ns at pH 7.32 and τₒ=2.57 ns at pH 12.18) are obtained by best fitting of the data to a single decaying exponential function with deconvolution of the instrument response function (IRF). Both IRF and sample data are normalized for best fitting for ease of viewing, but utilizing non-normalized raw data yields the same lifetimes. FIG. 3B shows normalized photoluminescence intensity of aromatic amine photoacids obtained using time-resolved photoluminescence spectroscopy plotted as a function of time. The lifetimes of aqueous 8-aminopyrene-1,3,6-trisulfonate (APTS, τₒ=3.88 ns at pH 6.3) and aqueous 5-((2-aminoethyl)amino)naphthalene-1-sulfonate (EDANS, τₒ=8.82 ns at pH 6.2) are obtained by best fitting of the data to a single decaying exponential function with deconvolution of the IRF. Both IRF and sample data are normalized for best fitting for ease of viewing, but utilizing non-normalized raw data yields the same lifetimes.

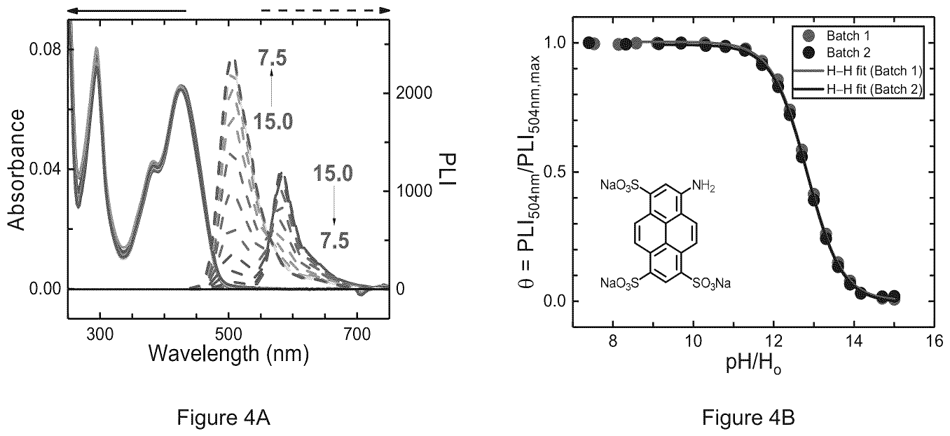

FIGS. 4A and 4B illustrate acid-base titrations of aqueous trisodium 8-aminopyrene-1,3,6-trisulfonate with steady-state absorption and photoluminescence detection in accordance with an embodiment. FIG. 4A shows absorption spectra and corrected steady-state photoluminescence spectra during excitation at 425 nm as the pH of the solution is varied between 15.0 (using the Hammett basicity scale) and 7.5. FIG. 4B shows normalized steady-state photoluminescence intensity (θ) at the wavelength of maximum emission (504 nm) for the data in FIG. 4A (red), and a second trial (black), as a function of solution pH, and simultaneous global analysis of both steady-state datasets via nonlinear least-squares best fits to the Henderson-Hasselbalch (H-H) equation (Equation 3) yields pK*_{a pseudo}=12.83±0.01. Substitution of this pK*_{a pseudo} value and the excited-state lifetime of the protonated neutral amine form of the photoacid into Equation 5 results in a bimolecular rate constant of (2.992±0.004)×10⁹ M⁻¹ s⁻¹ for the forward direction of Reaction 1 with B=OH⁻(aq).

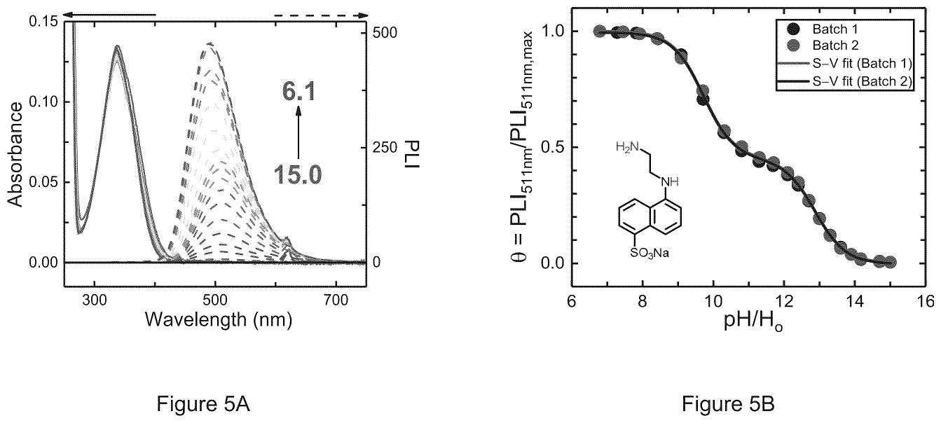

FIGS. 5A and 5B illustrate acid-base titrations of aqueous sodium 5-((2-aminoethyl)amino)naphthalene-1-sulfonate with steady-state absorption and photoluminescence detection in accordance with an embodiment. The photoacid does intramolecular ESPT to increase its pH sensing range to that encompassed by the pKₐ of the free amino group, extending the pH sensing to more acidic pH values of about 8 to about 11.5, where the latter value is the acidic limit of the range that can be sensed by APTS. FIG. 5A shows absorption spectra and corrected steady-state photoluminescence spectra during excitation at 310 nm as the pH of the solution was varied between 15.0 (using the Hammett basicity scale) and 6.1. FIG. 5B shows normalized steady-state photoluminescence intensity (θ) at the wavelength of maximum emission (504 nm) for the data in FIG. 5A (red), and a second trial (black), as a function of solution pH, and simultaneous global analysis of both steady-state datasets via nonlinear least-squares best fits to the nonlinear multi-quencher Stern-Volmer (S-V) equation yields pKₐ=10.06±0.02 for the aliphatic primary amine, the quenching constants for the bimolecular excited-state deprotonation of the photoacid by OH⁻(aq) of K_{SV,OH}_{^{−}}=30±1 M⁻¹ and by the aliphatic primary amine of K_{SV,NH}_{₂}=1.20±0.02 M⁻¹, and a bimolecular rate constant of (23±1)×10⁸ M⁻¹ s⁻¹ for the forward direction of Reaction 1 with B=OH⁻(aq) and a unimolecular rate constant of (0.95±0.01)×10⁸ s⁻¹ for the excited-state deprotonation by the aliphatic primary amine. Substitution of the latter bimolecular rate constant and the excited-state lifetime of the protonated neutral amine form of the photoacid from FIGS. 3A and 3B into Equation 5 results in a predicted pK*_{a pseudo}=12.53±0.06.

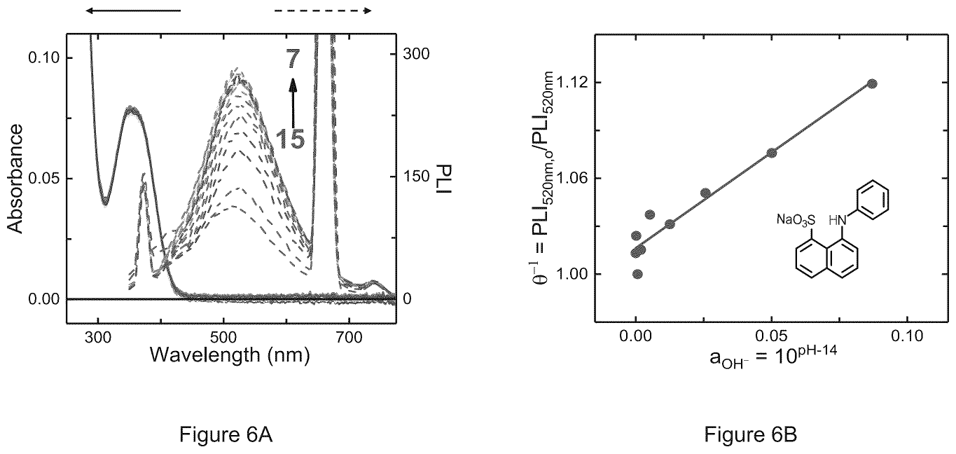

FIGS. 6A and 6B illustrate acid-base titrations of aqueous sodium 8-anilinonaphthalene-1-sulfonate with steady-state absorption and photoluminescence detection in accordance with an embodiment. FIG. 6A shows absorption spectra and corrected steady-state photoluminescence spectra during excitation at 330 nm as the pH of the solution was varied between 15 (using the Hammett basicity scale) and 7. FIG. 6B shows inverse of the normalized steady-state photoluminescence intensity (θ⁻¹) at the wavelength of maximum emission (520 nm) for the data in FIG. 6A as a function of the activity of OH⁻(aq). Best fits of the steady-state data to the traditional linearized Stern-Volmer (S-V) equation with OH⁻(aq) as the quencher (inverse of Equation 4) yields K_{SV,OH}_{^{−}}=1.2±0.1 M⁻¹ and a bimolecular rate constant of (48±4)×10⁸ M⁻¹ s⁻¹ for the forward direction of Reaction 1 with B=OH⁻(aq). Substitution of this bimolecular rate constant and the excited-state lifetime of the neutral amine form of the photoacid from the literature of 0.25 ns into Equation 5 in the main text resulted in a predicted pK*_{a pseudo}=13.92±0.04.

To further support the hypothesis that pK*_{a pseudo} values derived from steady-state photoluminescence spectroscopy data are kinetically gated by ESPT with OH⁻(aq) and photoacid excited-state lifetime, pK*_{a pseudo} values are determined for several aromatic amine photoacids with different excited-state lifetimes. These data are then best fit to the following equation, which should be appropriate assuming the reasonable assumption that this series of molecules exhibits similar encounter-controlled diffusion-limited bimolecular quenching rate constants with OH⁻(aq), that the rate of the backward direction of Reaction 1 is smaller than rate of return of the deprotonated excited-state photoacid to its electronic ground state, and that a constant pK_{w} value of 14 is sufficient over a small range of ionic strengths,

pK*_{a pseudo}=−log τ_{o,PAH*}+(−log k_{q,ss,OH}_{^{−}}+pK_{w}) (5)

A semilogarithmic plot of pK*_{a pseudo} versus excited-state lifetime yields an average k_{+q,ss,OH}_{^{−}} of about (5.0±0.1)×10⁹ M⁻¹ s⁻¹, which is a value close to that predicted based on encounter-controlled diffusion-limited reactivity, and further supports that photoluminescence quenching occurs via interaction with OH⁻(aq) by a dynamic process.

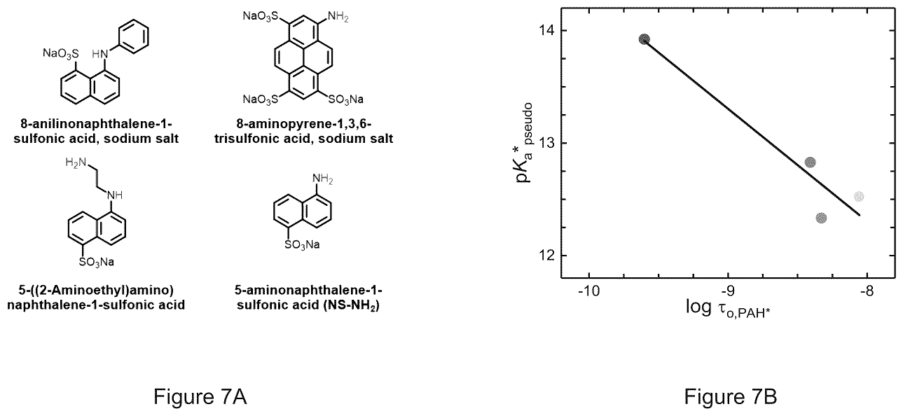

FIGS. 7A and 7B illustrate photoacid lifetime-dependent pK*_{a pseudo} values experimentally determined by Henderson-Hasselbalch fitting of acid-base titration data with steady-state photoluminescence detection in accordance with an embodiment. FIG. 7A shows series of aminoarene photoacids used to determine k_{+q,ss,OH-}. FIG. 7B shows pK*_{a pseudo} of aminoarene photoacids (8-anilinonaphthalene-1-sulfonic acid, sodium salt (red, τₒ=0.25 ns), 8-aminopyrene-1,3,6-trisulfonic acid, trisodium salt (orange, τₒ=3.88 ns), NS—NH₂ (green, τₒ=4.69 ns) and 5-((2-aminoethyl)amino)naphthalene-1-sulfonic acid, sodium salt (yellow, τₒ=8.82 ns) as a function of log (τ_{o,PAH*}) and best fitted using Equation 5 to yield a y-intercept equal to 4.3±0.1, which corresponds to k_{+q,ss,OH-}=(5.0±0.1)×10⁹ M⁻¹ s⁻¹. Excited-state lifetimes of the aminoarene photoacids are obtained using time-resolved photoluminescence spectroscopy.

Given the support for the dynamic nature of the excited-state quenching process, it is important to realize that use of the Stern-Volmer equation to quantify bimolecular quenching rate constants is only accurate when the quenching process is essentially unidirectional, and therefore irreversible in relation to the excited-state lifetime of the deprotonated excited-state photoacid, i.e. NS—NH⁻*. Conversely, reversible bidirectional ESPT occurs when the rate of the backward direction of Reaction 1 is larger than rate of return of NS—NH⁻* to its electronic ground state, which necessitates that the Stern-Volmer equation be modified to include rate constants for ESPT in the forward and backward directions (Reaction 1) and excited-state lifetimes for both protonated and deprotonated excited-state species. In the case of NS—NH₂ at pH values as large as 15, no definitive spectroscopic signals due to NS—NH⁻* and/or NS—NH⁻ are observed within the detection limit of the time-resolved photoluminescence and transient absorption spectroscopy systems (time resolution of ˜1 ns). Moreover, time-correlated single photon counting photoluminescence spectroscopy (time resolution of about 200 ps) and ultrafast transient absorption spectroscopy (time resolution of about 1 ps) are performed at pH 7 and pH 14 and observed excited-state lifetimes for NS—NH₂* are extracted from these data. The observed excited-state lifetime at pH 7 is consistent with that measured using nanosecond time-resolved photoluminescence spectroscopy data, while the observed excited-state lifetime at pH 14 is faster than the time resolution of the instrument, suggesting that ESPT is essentially a unidirectional and irreversible process. Also, since pKₐ>20 for NS—NH₂, ground-state proton transfer from water to NS—NH⁻ to regenerate NS—NH₂ is expected to occur on the sub-picosecond timescale, which is faster than the instrument time resolution. Hence, the observed transient absorption signals are due to NS—NH⁻.

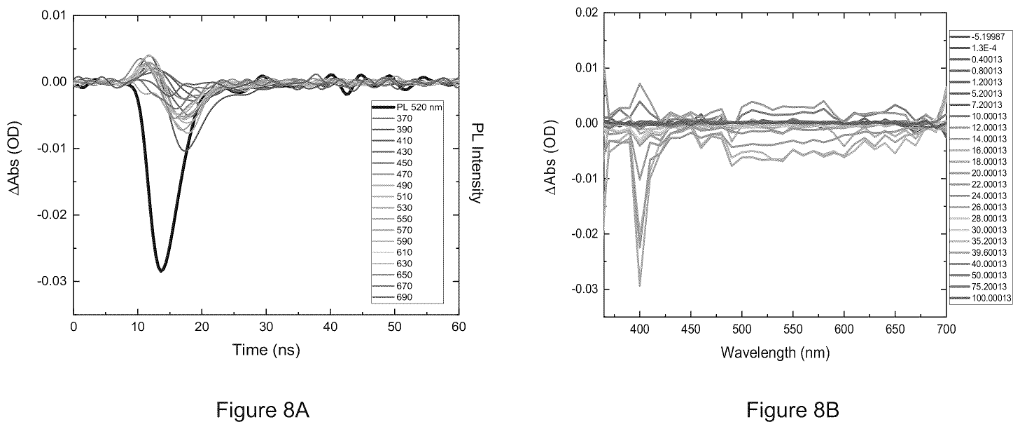

FIGS. 8A and 8B illustrate transient absorption spectroscopy of NS—NH₂ in accordance with an embodiment. The measurement is carried out in aqueous 3 M KOH with excitation at 355 nm and power of 0.7 mJ/pulse. Changes in absorbance obtained from the transient absorption data are plotted in FIG. 8A as a function of time for a series of wavelengths in nm and FIG. 8B as a function of wavelength for a series of times in ns.

Assuming that photoluminescence quenching occurs by ESPT from NS—NH₂* to OH⁻(aq), the data support that when a_{OH}_{^{−}} is small (i.e. at pH less than about 12), ESPT can be quite slow compared to the excited-state lifetime of NS—NH₂*, due to mass action (FIG. 2B). The non-unity quantum yield for ESPT in weakly alkaline aqueous solutions afforded us an opportunity to evaluate a series of aqueous proton-accepting quenchers (glycine (Gly(aq)), proline (Pro(aq)), and trifluoroethanol (TFE(aq))) for their ability to undergo ESPT with NS—NH₂*. In order to clearly observe ESPT to a species other than OH⁻(aq), added proton-accepting quenchers had to be more basic (ΔG^{o}<0), or slightly more acidic (ΔG^{o}>0), than NS—NH₂*, and less basic than OH⁻(aq). The occurrence of this process may not be clear from the data obtained at pH>12.5, because of the rapid rate of ESPT to OH⁻(aq), however at pH<12.5, direct ESPT to the proton-accepting quencher is apparent. As pH values approach and pass the pKₐ of the proton-accepting quencher, the rate of ESPT slows from a decrease in the concentration of proton-accepting quencher due to its protonation. This is supported by observations from analogous experiments performed using different concentrations of quencher. Best fits of measured photoluminescence spectroscopy data to a modified Stern-Volmer equation for a two-quencher system, including both OH⁻(aq) and proton-accepting quencher, provided bimolecular rate constants for deprotonation of the photoacid by each quencher,

$${θ}^{- 1} = \frac{{I}_{0}}{I} = 1 + {K}_{SV , {OH}^{-}} {a}_{{OH}^{-}} + {K}_{SV , quencher} {a}_{B} \qquad ( 6 )$$

$$θ = \frac{I}{{I}_{0}} = \frac{1}{1 + ( {K}_{SV , {OH}^{-}} ) {10}^{( pH - {pK}_{w} )} + ( {K}_{SV , quencher} ) \frac{{a}_{B} + {a}_{{BH}^{+}}}{1 + {10}^{( {pK}_{a , quencher} - pH )}}} \qquad ( 7 )$$

where K_{SV,OH}_{^{−}}=K*⁻¹_{b} and K_{SV,quencher}=k_{+q,quencher}τ_{o,PAH*} are the dynamic quenching constants for excited-state proton transfer to OH⁻(aq) and proton-accepting quencher, respectively, k_{+q,quencher} is the bimolecular rate constant (M⁻¹ s⁻¹) for ESPT quenching by the proton-accepting quencher, and the sum of the activities of B and BH⁺ is approximated as the total concentration of the proton-accepting quencher. While the pKₐ of the proton-accepting quencher is an adjustable parameter during best fitting, extracted pKₐ values are close to pKₐ values obtained from the acid-base titration curves of the proton-accepting quenchers. Changing the proton-accepting quencher to one with a smaller pKₐ value results in a slower non-diffusion-limited rate constant for ESPT with NS—NH₂*. The observation of ESPT directly from NS—NH₂* to each of two different amino acids, Gly and Pro, is notable, and may have important implications for biological systems where direct protonation of proteins can induce cellular responses.

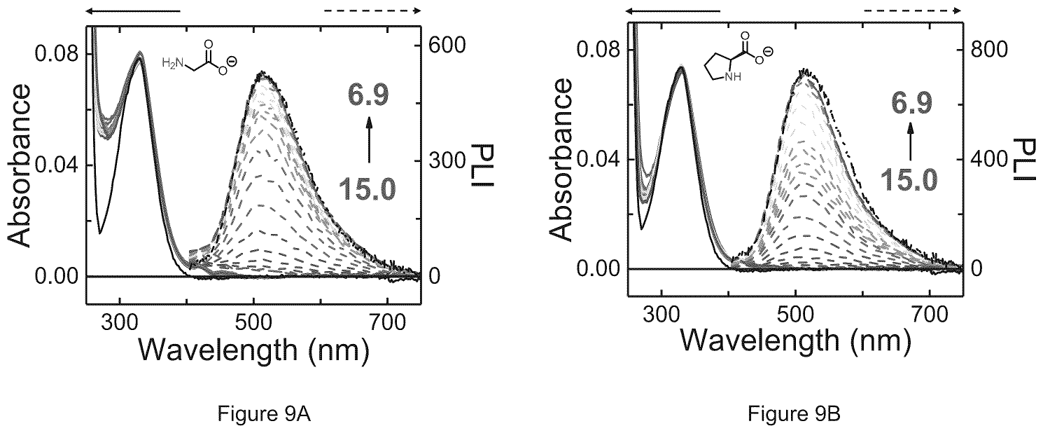

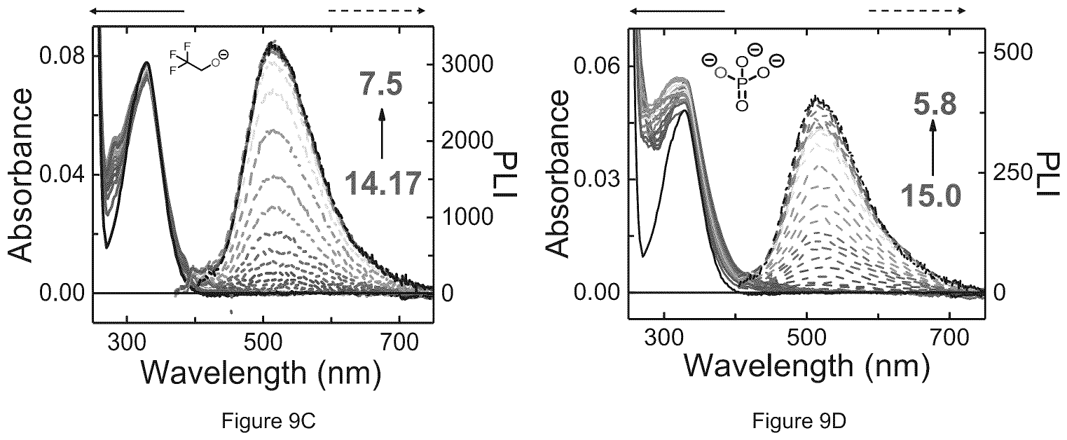

FIGS. 9A through 9D illustrate acid-base titrations of aqueous solutions of NS—NH₂ in the presence of proton-accepting quenchers with absorption and photoluminescence detection in accordance with an embodiment. Absorption spectra and corrected steady-state photoluminescence spectra during (A) excitation at 310 nm with 1 M total glycine concentration as the pH of the solution was varied between 15.0 (using the Hammett basicity scale) and 6.9, (B) excitation at 310 nm with 1 M total proline concentration as the pH of the solution is varied between 15.0 (using the Hammett basicity scale) and 6.9, (C) excitation at 310 nm with 1 M total trifluoroethanol concentration as the pH of the solution is varied between 14.17 (using the Hammett basicity scale) and 7.5, and (D) excitation at 325 nm with 1 M total phosphate concentration as the pH of the solution is varied between 15.0 (using the Hammett basicity scale) and 5.8. Solid and dashed black lines correspond to the absorption spectra and corrected steady-state photoluminescence spectra during excitation at 310 nm for an aqueous solution of NS—NH₂ at pH 6.8 without any added proton-accepting quencher. The majority of the changes in the absorbance at about 300 nm are because of absorption by the quencher.

Table 2 lists driving-force-dependent rate constants for direct excited-state proton transfer from NS—NH₂* to various proton-accepting quenchers.

TABLE 2
Rate constants.

| | | | | Diffusion | |
|---|---|---|---|---|---|
| | | pK_{a,BH+} | k_{+q} | Coefficient | k_{+q,corr} |
| Proton acceptor | Chemical structure | (Equation 7) | (10⁸ M⁻¹ s⁻¹) | (10⁻⁶ cm²/s) | (10⁸ M⁻¹ s⁻¹) |
| Hydroxide (OH⁻(aq)) | 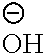 | 14/— | 100 ± 3 | 52.70 | 100 ± 3 |
| Trifluoroethanol (TFE(aq)) | 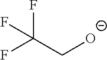 | 12.4/12.6 | 11.2 ± 2.2 | 6.00 | 58.7 ± 11.5 |
| Phosphate (PO₄³⁻(aq)) | 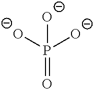 | 11.4/— | 5.4 ± 0.9 | 8.79 | 22.6 ± 3.8 |
| Proline (Pro(aq)) | 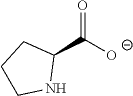 | 10.7/10.8 | 1.70 ± 0.05 | 8.79 | 7.11 ± 0.21 |
| Glycine (Gly(aq)) | 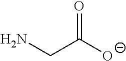 | 9.7/9.9 | 0.39 ± 0.02 | 10.60 | 1.44 ± 0.07 |

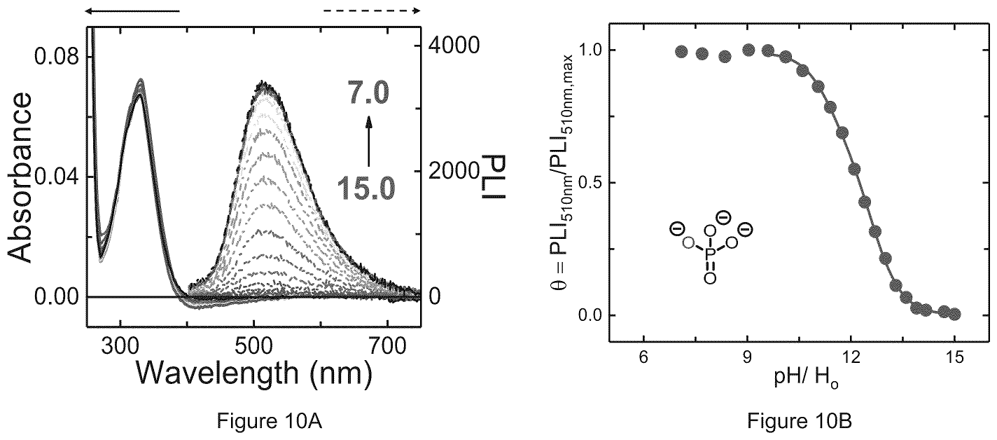

FIGS. 10A and 10B illustrate acid-base titrations of aqueous NS—NH₂ in the presence of 0.17 M potassium phosphate as the proton-accepting quencher with absorption and photoluminescence detection and best fits of photoluminescence data to the modified Stern-Volmer equation in accordance with an embodiment. FIG. 10A shows absorption spectra and corrected steady-state photoluminescence spectra during excitation at 310 nm with 0.17 M total phosphate concentration as the pH of the solution was varied between 15.0 (using the Hammett basicity scale) and 7. Solid and dashed black lines correspond to the absorption spectra and corrected steady-state photoluminescence spectra during excitation at 310 nm for an aqueous solution of NS—NH₂ at pH 6.8 without any added proton-accepting quencher. FIG. 10B shows normalized photoluminescence intensity at the wavelength of maximum emission for NS—NH₂* (510 nm) as a function of solution pH and best fit to Equation 7, which yield K_{SV,OH}_{^{−}}=37±2 M⁻¹ and K_{SV,PO}_{₄}_{^{3−}}=2.2±0.3 M⁻¹. Dividing these quenching constants by the excited-state lifetime of NS—NH₂* in the absence of quencher afforded bimolecular rate constants for excited-state deprotonation of NS—NH₂* by OH⁻(aq) of (163±8)×10⁸ M⁻¹ s⁻¹ and by PO₄³⁻(aq) of (11±2)×10⁸ M⁻¹ s⁻¹.

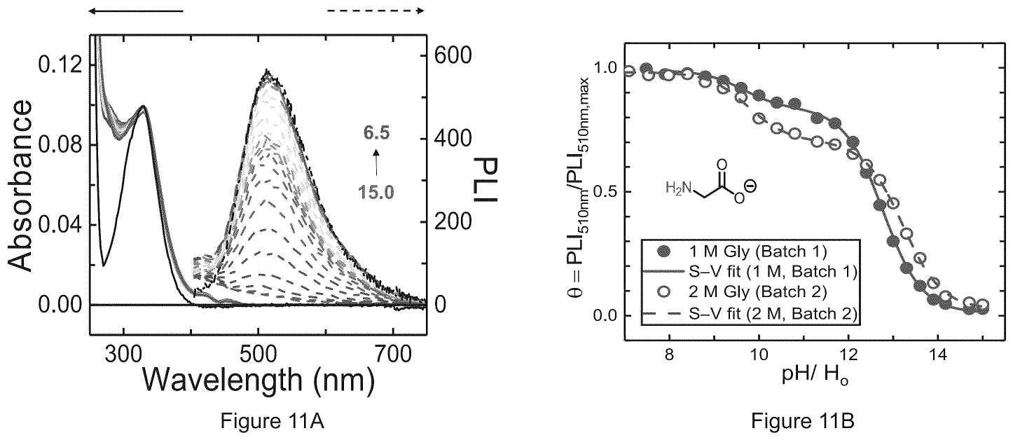

FIGS. 11A and 11B illustrate acid-base titrations of aqueous NS—NH₂ in the presence of glycine as the proton-accepting quencher with absorption and photoluminescence detection and best fits of photoluminescence data to the modified Stern-Volmer equation in accordance with an embodiment. FIG. 11A shows absorption spectra and corrected steady-state photoluminescence spectra during excitation at 310 nm with 2 M total glycine concentration as the pH of the solution was varied between 15.0 (using the Hammett basicity scale) and 6.5. Solid and dashed black lines correspond to the absorption spectra and corrected steady-state photoluminescence spectra during excitation at 310 nm for an aqueous solution of NS—NH₂ at pH 6.8 without any added proton-accepting quencher. FIG. 11 B shows normalized photoluminescence intensity at the wavelength of maximum emission for NS—NH₂* (510 nm) as a function of solution pH. Total concentration of glycine was kept constant at 1 M (solid circles) and 2 M (open circles) throughout the titration. For 1 M glycine (solid circles), best fitting of the data to Equation 7 (solid line) yields K_{SV,OH}_{^{−}}=20±1 M⁻¹ and K_{SV,glycine}=0.18±0.01 M¹. Dividing these quenching constants by the excited-state lifetime of NS—NH₂* in the absence of quencher afforded bimolecular rate constants for excited-state deprotonation of NS—NH₂* by OH⁻(aq) of (43±1)×10⁸ M⁻¹ s⁻¹ and by glycine(aq) of (0.39±0.02)×10⁸ M⁻¹ s⁻¹. For 2 M glycine (open circles), best fitting of the data to Equation 7 in the main text (dashed line) yielded K_{SV,OH}_{^{−}}=8.6±0.4 M⁻¹ and K_{SV,glycine}=0.20±0.01 M⁻¹. Dividing these quenching constants by excited-state lifetime of NS—NH₂* in the absence of quencher afforded bimolecular rate constants for excited-state deprotonation of NS—NH₂* by OH⁻(aq) of (38±2)×10⁸ M⁻¹ s⁻¹ and by glycine(aq) of (0.90±0.04)×10⁸ M⁻¹ s⁻¹.

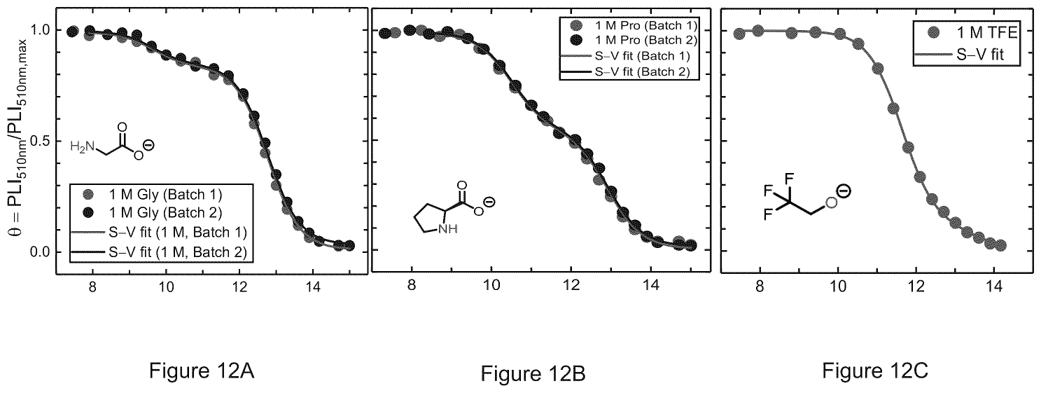

FIGS. 12A through 12C illustrate best fits of photoluminescence data obtained by acid-base titrations of aqueous solutions of NS—NH₂ in the presence of 1 M proton-accepting quenchers to the modified nonlinear Stern-Volmer equation in accordance with an embodiment. Normalized photoluminescence intensity at the wavelength of maximum emission for NS—NH₂* (510 nm) as a function of solution pH and with 1 M total proton-accepting quencher concentration for (A) glycine (Gly), (B) proline (Pro), and (C) trifluoroethanol (TFE). Best fitting of the data to Equation 7 provides for glycine K_{SV,OH}_{^{−}}=20±1 M⁻¹ and K_{SV,Gly}=0.18±0.01 M⁻¹, for proline K_{SV,OH}_{^{−}}=22±1 M⁻¹ and K_{SV,Pro}=0.80±0.02 M⁻¹, and for trifluoroethanol K_{SV,OH}_{^{−}}=30±10 M⁻¹ K and K_{SV,TFE}=5±1 M⁻¹. Dividing these quenching constants by the excited-state lifetime of NS—NH₂* in the absence of quencher afforded bimolecular rate constants for excited-state deprotonation of NS—NH₂* by Gly(aq) of (0.39±0.02)×10⁸ M⁻¹ s⁻¹ (and by OH⁻(aq) of (43±1)×10⁸ M⁻¹ s⁻¹), by Pro(aq) of (1.70±0.05)×10⁸ M⁻¹ s⁻¹ (and by OH⁻(aq) of (47±2)×10⁸ M⁻¹ s⁻¹), and by TFE(aq) of (11±2)×10⁸ M⁻¹ s⁻¹ (and by OH⁻(aq) of (60±30)×10⁸ M⁻¹ s⁻¹).

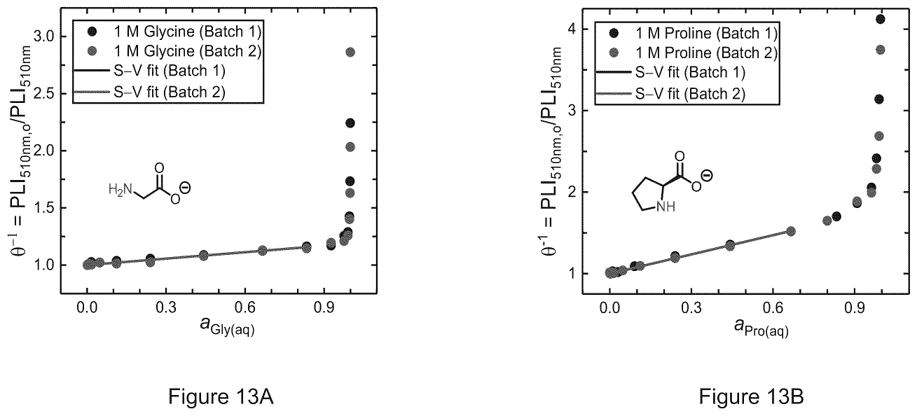

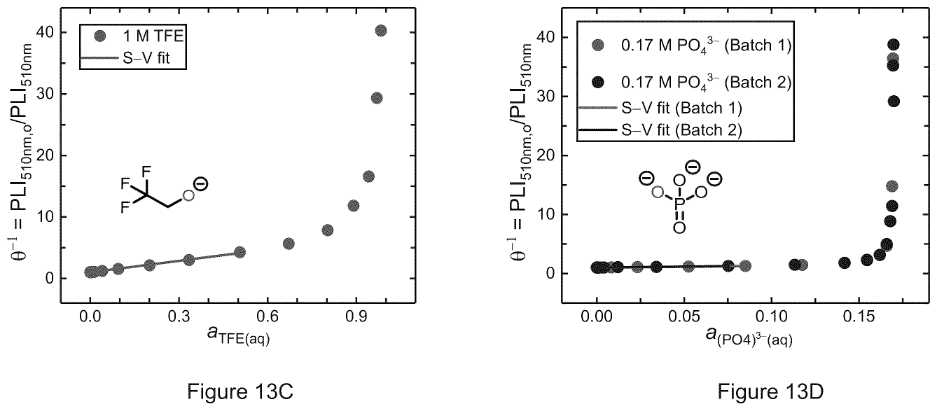

FIGS. 13A through 13D illustrate best fits of the inverse of the photoluminescence intensity data obtained by acid-base titrations of aqueous solutions of NS—NH₂ in the presence of proton-accepting quenchers to the modified linearized Stern-Volmer equation in accordance with an embodiment. Reciprocal of the normalized photoluminescence intensity at the wavelength of maximum emission for NS—NH₂* (510 nm) with constant total proton-accepting quencher concentration for (A) 1 M glycine (Gly), (B) 1 M proline (Pro), (C) 1 M trifluoroethanol (TFE), and (D) 0.17 M phosphate, of NS—NH₂ at wavelength of maximum emission (510 nm) as a function of the activity of glycine(aq) (Gly) and least-squares best fit to the traditional linearized Stern-Volmer equation with glycine(aq) as the quencher, which yields K_{SV,Gly}=0.19±0.01 M⁻¹ (versus K_{SV,Gly}=0.18±0.01 M⁻¹ from Equation 7). Total concentration of glycine is kept constant at 1 M throughout the titration. (B) Reciprocal of the normalized photoluminescence intensity of NS—NH₂ at 510 nm as a function of the activity of proline(aq) (Pro) and least-squares best fit to the traditional linearized Stern-Volmer equation with proline(aq) as the quencher, which yields K_{SV,proline}=0.79±0.01 M⁻¹ (versus K_{SV,proline}=0.80±0.02 M⁻¹ from Equation 7). Total concentration of proline was kept constant at 1 M throughout the titration. (C) Reciprocal of the normalized photoluminescence intensity of NS—NH₂ at 510 nm as a function of the activity of trifluoroethanol(aq) (TFE) and least-squares best fit to the traditional linearized Stern-Volmer equation with trifluoroethanol(aq) as the quencher, which yields K_{SV,TFE}=6.2±0.1 M⁻¹ (versus K_{SV,TFE}=5±1 M⁻¹ from Equation 7). Total concentration of trifluoroethanol is kept constant at 1 M throughout the titration. (D) Reciprocal of normalized photoluminescence intensity of NS—NH₂ at 510 nm as a function of the activity of phosphate(aq) and least-squares best fit to the traditional linearized Stern-Volmer equation with phosphate(aq) as the quencher, which yields K_{SV,PO}_{₄}_{^{3−}}=3.4±0.1 M⁻¹ (versus K_{SV,PO}_{₄}_{^{3−}}=2.2±0.3 M⁻¹ from Equation 7). Total concentration of phosphate is kept constant at 0.17 M throughout the titration.

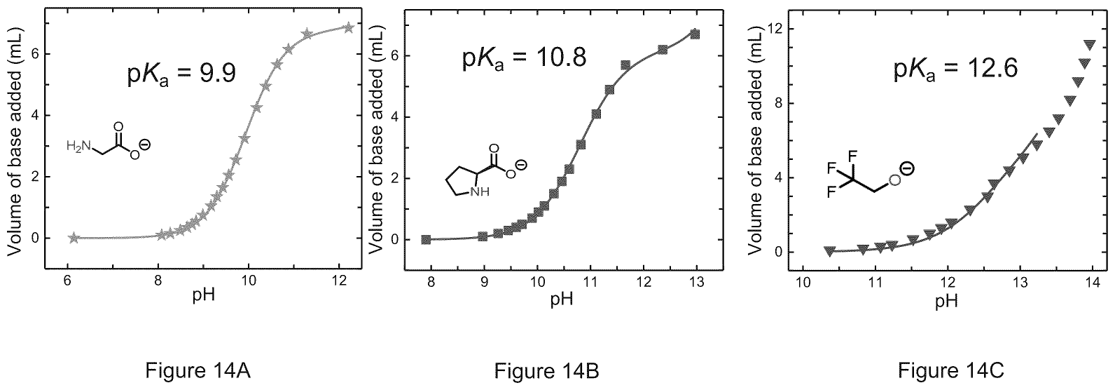

FIGS. 14A through 14C illustrate determination of pKₐ values of proton-accepting quenchers using acid-base titration curves in accordance with an embodiment. Acid-base titrations, using an aqueous strong base (4 M KOH), of aqueous solutions of (A) 1 M glycine, (B) 1 M proline, and (C) 1 M trifluoroethanol. Best fitting of the data provides the pKₐ value of glycine of 9.9, with a literature value of 9.6, the pKₐ value of proline of 10.8, with a literature value of 10.5, and the pKₐ value of trifluoroethanol of 12.6, with a literature value of 12.4.

The series of data in the presence of two proton-accepting quenchers, i.e. OH⁻ and B. To further support that a dynamic Stern-Volmer quenching process is operative, numerical simulations are performed using a chemical kinetics model that included experimentally derived rate constants and fluorimeter light intensity in the presence and absence of proton-accepting quenchers and varied excited-state lifetime of NS—NH⁻*. Notably for T_{NS—NH-*}<0.3 ns, titration behavior is nearly independent of T_{NS—NH-*}, suggesting ESPT to be essentially unidirectional and irreversible, further validating use of Equation 7 to accurately determine rate constants for ESPT.

Several embodiments provide accurate quantification of excited-state Brønsted-Lowry acidity and reorganization energy of weak photoacids using Marcus-Cohen bond-energy-bond-order (BEBO) theory. Data for this series of proton-accepting quenchers analyze the dependence of driving force on ESPT quenching rate constants and assess the validity of Marcus normal region behavior, as has been performed numerous times for excited-state electron transfer and proton-coupled electron transfer. Like excited-state electron-transfer quenching in polar solvents, ESPT is proposed to proceed through formation of an excited-state encounter complex between reactants prior to proton transfer, but unique to ESPT is dissociation of an excited-state encounter complex between products after proton transfer. Assume that return of the excited-state encounter complexes to their respective electronic ground states does not occur and that the final step is not rate determining. These assumptions lead to the following equation for the observed quenching rate constant, k_{+q,corr,i}, which is dominated by the slowest reaction step in the forward direction after taking into consideration pre-equilibrium of preceding steps,

$${k}_{+ q , corr , i} = {( \frac{1}{{k}_{+ EC , R}} + \frac{1}{{K}_{EC , R} {k}_{+ PT}} + \frac{1}{{K}_{EC , R} {K}_{PT} {K}_{EC , P}^{- 1} {k}_{- EC , P}} )}^{- 1} \qquad ( 8 )$$

where

$${K}_{EC , R} = \frac{{k}_{+ EC , R}}{{k}_{- EC , R}} and {K}_{EC , P} = \frac{{k}_{- EC , P}}{{k}_{+ EC , P}}$$

are equilibrium constants for formation of an excited-state encounter complex (EC) between reactants (R) and products (P), respectively, which each kinetically involve bimolecular encounter-controlled processes (k_{+EC,R} and k_{-EC,P}) and thermodynamically are dictated by effects due to electrostatics, sterics, and statistical entropic considerations.

$${77}^{} {K}_{PT} = \frac{{k}_{+ PT}}{{k}_{- PT}}$$

is the equilibrium constant for the unimolecular proton-transfer step, with rate constants of k_{+PT} and k_{-PT}, and are parameters that are needed in order to accurately apply theories of driving-force-dependent kinetic processes.

The overall change in the standard Gibbs free energy for the three-step excited-state proton-transfer reaction sequence can be written as follows,

ΔG^{o}=2.303RT(pK*_{a,NS—NH}_{₂}−pK_{a,quencher}) (9)

ΔG^{o}=ΔG_{EC,R}^{o}+ΔG_{PT}^{o}+(−ΔG_{EC,P}^{o})=2.303RTpK_{EC,R}+ΔG_{PT}^{o}−2.303RTpK_{EC,P} (10)

ΔG^{o=}2.303RT(pK*_{a,NS—NH}_{₂}−pK_{a,quencher}−PK_{EC,R}+PK_{EC,P}) (11)

where ΔG_{EC,R}^{o}, ΔG_{PT}^{o}and −ΔG_{EC,P}^{o} are the standard Gibbs free energy differences for the individual reaction steps in the excited-state proton-transfer reaction sequence. Kinetic data (Equation 8) and thermodynamic data (Equation 11) are analyzed using Marcus-Cohen bond-energy-bond-order (BEBO) theory, which is based on transition-state theory and results in the following relationship between ΔG_{PT}^{‡} and ΔG_{PT}^{o},

$${k}_{+ PT} = A exp ( \frac{- Δ {G}_{PT}^{‡}}{RT} ) = A exp ( - \frac{Δ {G}_{PT}^{o}}{2 RT} - \frac{Δ {G}_{o , PT}^{‡}}{RT} - \frac{Δ {G}_{o , PT}^{‡}}{RT ln 2} ln ( cosh ( \frac{Δ {G}_{PT}^{o} ln 2}{2 Δ {G}_{o , PT}^{‡}} ) ) ) \qquad ( 12 )$$

where A is the pre-exponential frequency factor (s⁻¹), ΔG_{PT}^{‡} is the standard Gibbs free energy of activation for the proton-transfer step, and ΔG_{o,PT}^{‡} is ΔG_{PT}^{‡} when ΔG_{PT}^{o}=0. Semilogarithmic plots of the observed effective rate constants k_{q,corr,i} for each proton-accepting quencher, i, versus the quencher pKₐ using values from Table 2 are best fit by fixing the encounter-controlled rate constants to an approximate diffusion-limited value, k_{+EC,R}=k_{-EC,P}=3×10¹⁰ M⁻¹ s⁻¹, A=4.1×10¹¹ s⁻¹, and a=5.4 Å. This Marcus-Cohen BEBO analysis yielded for NS—NH₂* a “true” pK*ₐ=11.7±0.1 and ΔG_{o,PT}^{‡}=0.080±0.005 eV.

Marcus-Cohen BEBO theory is based on a localized reaction with strong electronic overlap such that bond order, and thus bond energy, dominate the driving-force dependence of the rate constant. This theory generally results in values of ΔGₒ^{‡} that are smaller than those for electron-transfer reactions, which are often assumed to be less localized. The driving-force dependence of less localized reactions is dominated by reorganization of nuclei, with a total reorganization energy, λ, that equals 4ΔG_{o,ET}^{‡} under the typical Marcus quadratic relationship between the standard Gibbs free energy difference and the free energy of activation. The analysis seems appropriate using Marcus-Cohen BEBO theory, because ΔG_{o,PT}^{‡}<0.125 eV for ESPT from photoacids like those studied herein, yet ΔG_{o,ET}^{‡}>0.25 eV for electron-transfer reactions using similar molecules and solvents.

In some embodiments, the “true” pK*ₐ of NS—NH₂* experimentally derived is 11.7±0.1, compared to pK*_{a pseudo}=12.34±0.02 obtained by best fitting the photoluminescence spectroscopy data shown in FIG. 2B to the traditional Henderson-Hasselbalch equation. Although the difference between these two values is not large, it is important to realize that use of the traditional Henderson-Hasselbalch equation is incorrect, whereas the method in accordance with various embodiments that uses a dynamic Stern-Volmer quenching analysis coupled with a steady-state approximation and Marcus-Cohen BEBO theory is more accurate. Moreover, pK*_{a pseudo} and “true” pK*ₐ values can differ substantially. For example, as supported by the data in FIG. 7B, photoacids with shorter excited-state lifetimes than that for NS—NH₂* will result in larger values for pK*_{a pseudo}. Also, as supported by the data in Table 1, pK*_{a pseudo} values remain near constant, even when “true” pK*ₐ values are as small as about 3. This occurs because the traditional method to determine pK*ₐ values of weak photoacids and photobases incorrectly assumes that the excited state has reached both thermal and chemical quasi-equilibrium and therefore it does not account for cases where the combined rates of radiative and non-radiative decay are faster than the rate of ESPT.

Henderson-Hasselbalch analysis of steady-state photoluminescence spectroscopy data from weak photoacids can result in erroneous excited-state pKₐ values, which are influenced by the excited-state lifetime of the photoacid. Many embodiments provide methods and systems to accurately quantify pK*ₐ of weak photoacids and photobases. Via dynamic Stern-Volmer quenching analysis of data obtained for unidirectional excited-state proton-transfer reactions, observed rate constants for excited-state proton transfer to a series of proton-accepting quenchers are quantified. Rate constants abstracted assuming a steady-state approximation are analyzed using Marcus-Cohen BEBO theory in conjunction with measured ground-state pKₐ values of the quenchers to deduce the excited-state pKₐ of the photoacid. The extracted value of pK*ₐ is about 11.7±0.1.

Moderate photoacids and photobases can be used in combination with confocal fluorescent microscopy for measuring local OH⁻ and H⁺ activity, activity of protonic species including (but not limited to) phosphate, glycine, dissolved inorganic carbon (DIC) species such as bicarbonate and carbonate, and/or species such as acetate, formate.

In some embodiments, sensors are based on excited-state proton-transfer reactions from electronic triplet excited states. Most sensors based on excited-state proton-transfer reactions from their electronic singlet excited state are limited in their proton/hydroxide/DIC sensing ability due to the short electronic singlet excited-state lifetimes of organic molecules, which is typically on the order of tens of nanoseconds. These lifetimes restrict the proton/hydroxide/DIC concentration sensing ability of these molecules to concentrations of a few millimolar or more. The sensing ability of these molecules can be enhanced to a concentration range of a few micromolar to as low as tens of nanomolar by incorporating heavy atoms in these molecules. Upon photoexcitation, the strong spin-orbit coupling due to the heavy atoms in these molecules induces an intersystem crossing to the electronic triplet excited states, which can typically last for more than microseconds to a few milliseconds. The long triplet excited-state lifetimes enable the detection of very slow excited-state proton-transfer reactions due to the slow mass action kinetics at low proton/hydroxide/DIC concentrations, thus making it possible to quantify the local proton/hydroxide/DIC concentrations on the micromolar-nanomolar scale. If the triplet excited state in these molecules is emissive at room temperature or at low temperatures via phosphorescence, a direct relation can be derived between the intensity of emission from the protonated form of the triplet excited state of the sensor and the local pH or pOH or the DIC concentration. If the triplet excited state is not emissive in these molecules, then the fluorescence emission intensity from the singlet excited state can be indirectly used to quantify the local pH or pOH or the DIC concentration, if there is an attainment of steady-state for the intersystem crossing reaction between the singlet and the triplet excited states of the protonated form of the sensor. In both the abovementioned cases, the setup will be similar to the one described for sensors based on excited-state proton-transfer reactions from their singlet excited states. The yield for intersystem crossing and phosphorescence in such sensors can be increased by (i) incorporating a heavy atom or a carbonyl group in the structure of the molecules, (ii) introducing salts of heavy atoms in the system, (iii) increasing rigidity (e.g., as an aggregate, in a host-guest cage, in a polymer, in the solid-state), or (iv) photoexcitation of a transition metal coordination complex that is used as a triplet sensitizer and subsequent triplet energy transfer to form the triplet excited state of the sensor molecule.

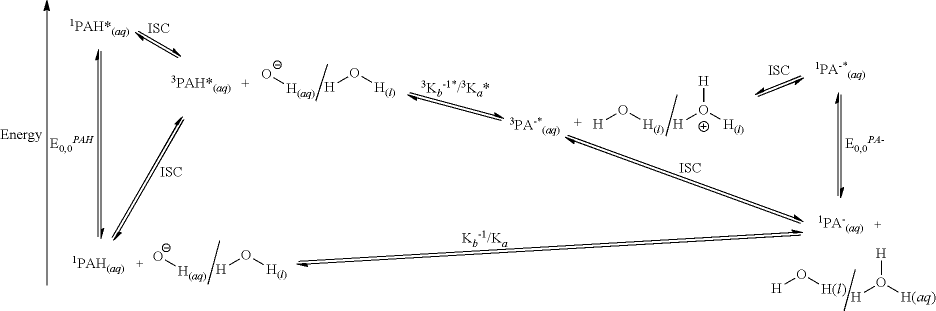

Example of molecule that can be used under this mechanism include sodium 6-bromo-5-aminonaphthalene-1-sulfonate:

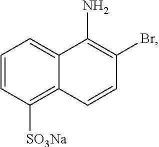

wherein Br and/or SO3Na can be on any position of the phenyl ring.

In some embodiments, sensors based on parallel excited-state intermolecular and intramolecular proton-transfer reactions from electronic singlet excited states (FIGS. 5A-5B). As mentioned, most sensors based on excited-state proton-transfer reactions from their electronic singlet excited state are limited in their proton/hydroxide/DIC sensing ability to the concentration scale of a few millimolar or more due to the short electronic singlet excited-state lifetimes of organic molecules, which is typically on the order of tens of nanoseconds. This sensing ability can be enhanced by an order of magnitude to detect proton/hydroxide/DIC concentrations as low as hundreds of micromolar by incorporating non-conjugated proton accepting groups in the structure of the sensor (FIGS. 5A-5B). Along with the excited-state intermolecular proton-transfer reaction from the sensor to the aqueous proton/hydroxide/DIC species, these structurally modified sensors can also perform an excited-state intramolecular proton-transfer reaction to the non-conjugated proton-accepting group within the sensor. The probability of this excited-state intramolecular proton-transfer reaction depends on the extent of the protonation of the non-conjugated proton accepting group, which depends on the proton/hydroxide/DIC concentration. The enhancement in the proton/hydroxide/DIC sensing ability using this mechanism depends on the Brønsted-Lowry acidity (or pKₐ value of the conjugate acid) of the non-conjugated proton-accepting group and the rate of the excited-state intramolecular proton-transfer reaction. An aromatic amine-based sensor without the non-conjugated proton accepting group can sense local pOH between 0 and 3. Typically, by having an aliphatic amine as the non-conjugated proton accepting group (pKₐ of the conjugate acid ˜10) incorporated in the structure of an aromatic amine-based sensor, the local pOH sensing ability can be enhanced by several orders of magnitude to a pOH of around 5 or 6 (FIGS. 5A-5B). The emission from the protonated and/or deprotonated forms of the sensors with the non-conjugated proton-accepting group will be measured and analyzed using the similar method and setup to the one described for sensors without the non-conjugated proton-accepting group.

Examples of molecule that can be used under this mechanism:

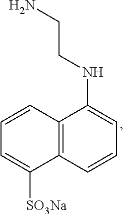

can be excited below 350 nm.

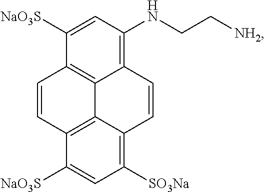

can be excited using 400 nm light.

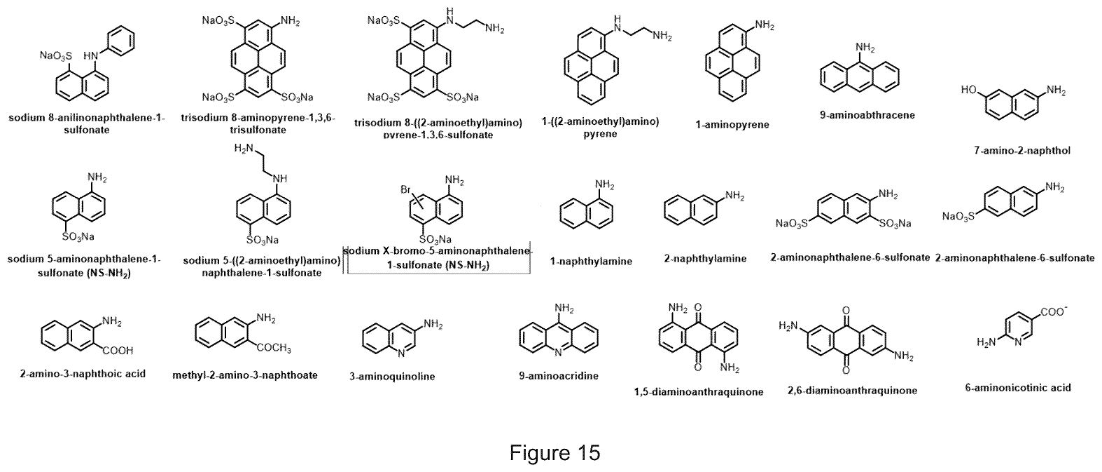

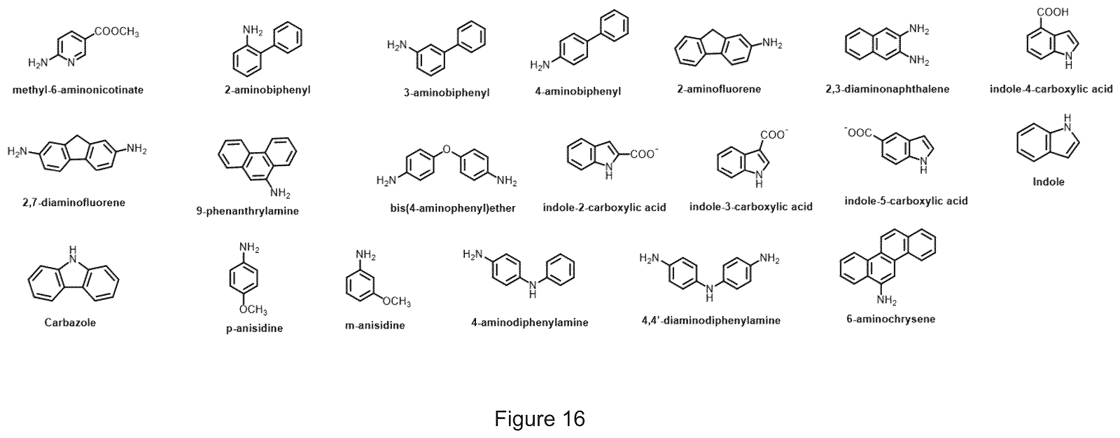

FIGS. 15 and 16 illustrate various aromatic and heterocyclic amine based compounds as photoacids in accordance with an embodiment. For the top two lines of compounds, the amino and the sulfonate groups can be at any position and the compounds can have any number of sulfonate groups. Sulfonates and carboxylates are ideal as they increase water solubility of the compounds. Apart from these groups, the compounds can have functional groups such as sulfones, sulphonamide, amides, ethers, esters, ketones, aliphatic or aromatic hydroxy, aliphatic or aromatic amino, alkyl, aryl, heterocyclic N, heterocyclic O, heterocyclic S, halides, cyano, nitro, quaternary ammonium. The number and the relative position of these groups will not impact their applicability significantly. It will slightly change the sensing region as it would affect the acidity of the aromatic amine. All the aromatic amine based compounds can be used to sense pOH less than 3; or less than 4.

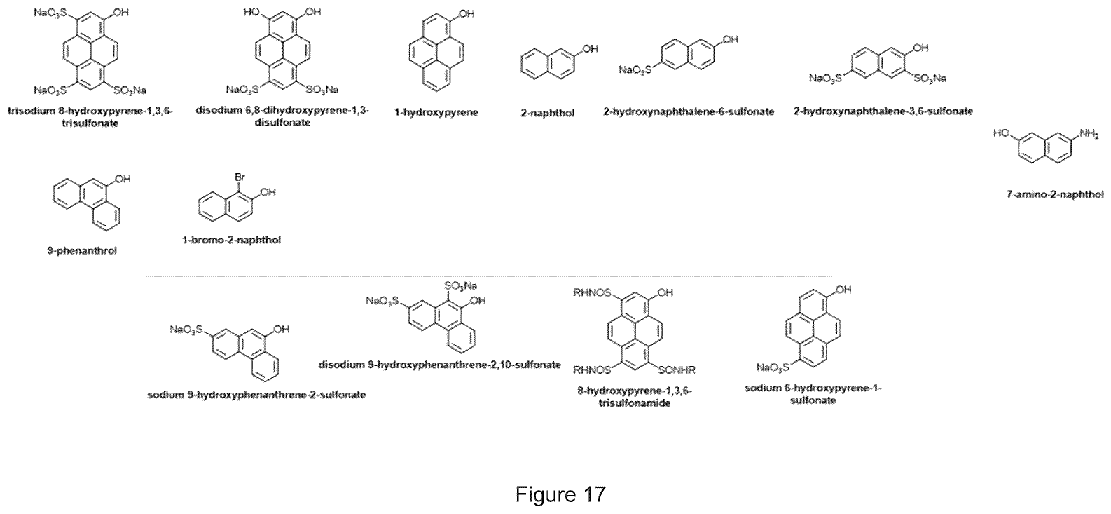

FIG. 17 illustrates aromatic hydroxy based compounds as photoacids that can be used to sense pOH between about 4 and 9 in accordance with an embodiment. For the top line of compounds, the hydroxy and the sulfonate groups can be at any position and the compounds can have any number of sulfonate groups. Sulfonates and carboxylates are ideal as they increase water solubility. Apart from these groups, the compounds can have functional groups such as sulfones, sulphonamide, amides, ethers, esters, ketones, aliphatic or aromatic hydroxy, aliphatic or aromatic amino, alkyl, aryl, heterocyclic N, heterocyclic S, halides, cyano, nitro, quaternary ammonium. The number and the relative position of these groups will not impact their applicability significantly. It will slightly change the sensing region as it would affect the acidity of the aromatic hydroxy group.

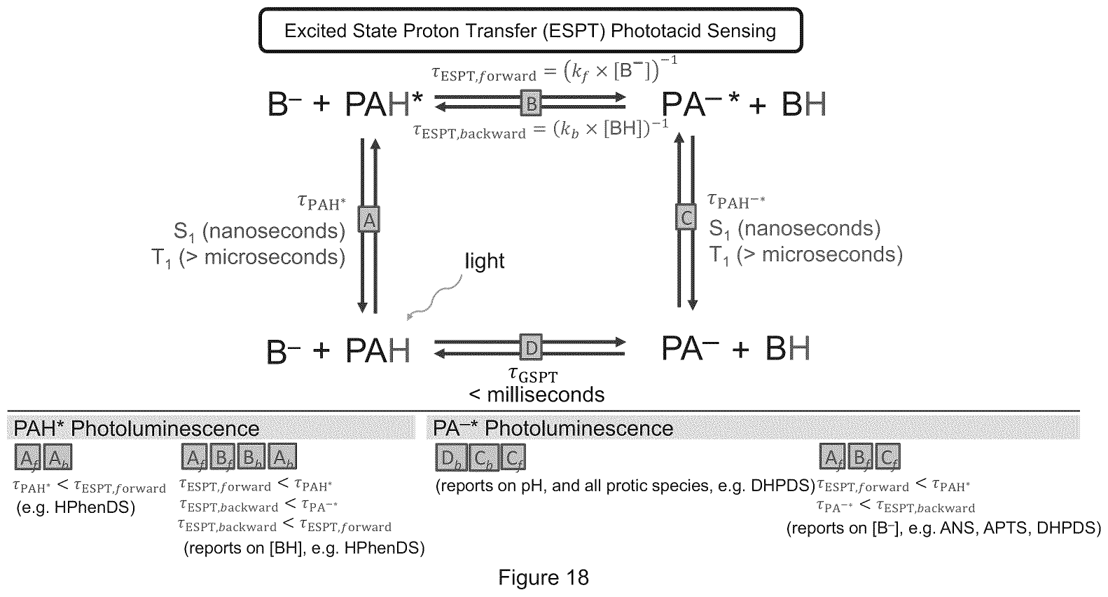

FIG. 18 illustrates design rules for photoacid and/or photobase sensing in accordance with an embodiment.

FIGS. 19A and 19B illustrate properties of aqueous disodium 9-hydroxyphenanthrene-3,10-disufonate in accordance with an embodiment. Dye parameters, such as pKₐ values and ESPT to water yields, determine their availability and therefore ability to sense dissolved protic species other than H⁺.

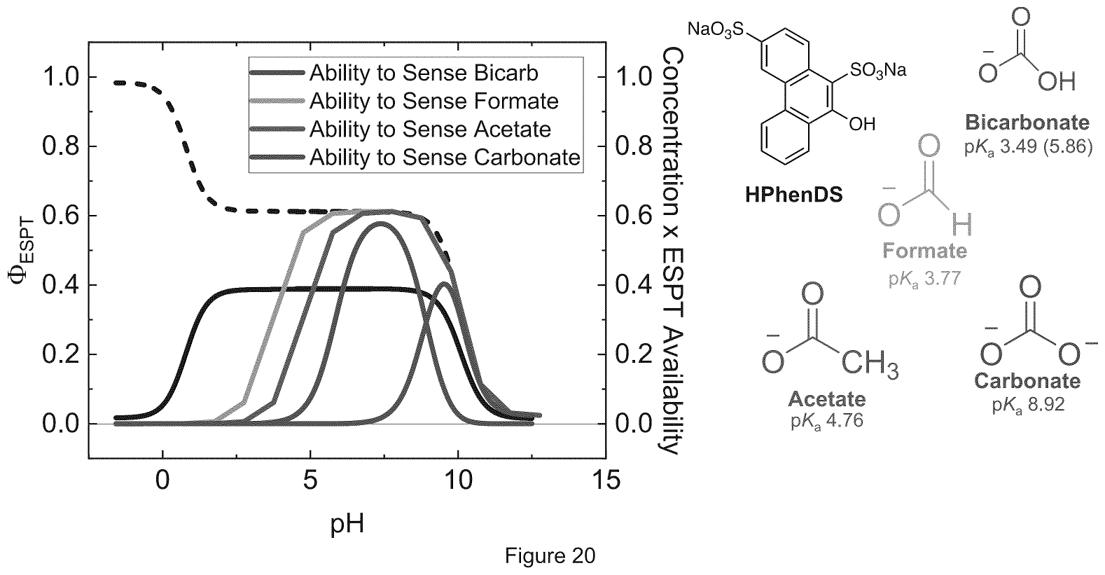

FIG. 20 illustrates the ability of aqueous disodium 9-hydroxyphenanthrene-3,10-disufonate (HPhenDS) to sense various proton acceptors in accordance with an embodiment. Sensing targets include, but are not limited to bicarbonate, formate, acetate, and carbonate. ESPT availability and ESPT to water curves are calculated from steady-state absorption and photoluminescence data for 15 μM HPhenDS across the pH window indicated at constant ionic strength (except for pH values below 0). Concentrations of all buffers were simulated to be 1 M total salt added. Ability to sense is predicted by estimating total concentration at a given pH value based on the pKₐ value of the buffer and fit to a Henderson-Hasselbalch-type equation. The resultant concentration is then multiplied by the ESPT availability of HPhenDS at each pH value.

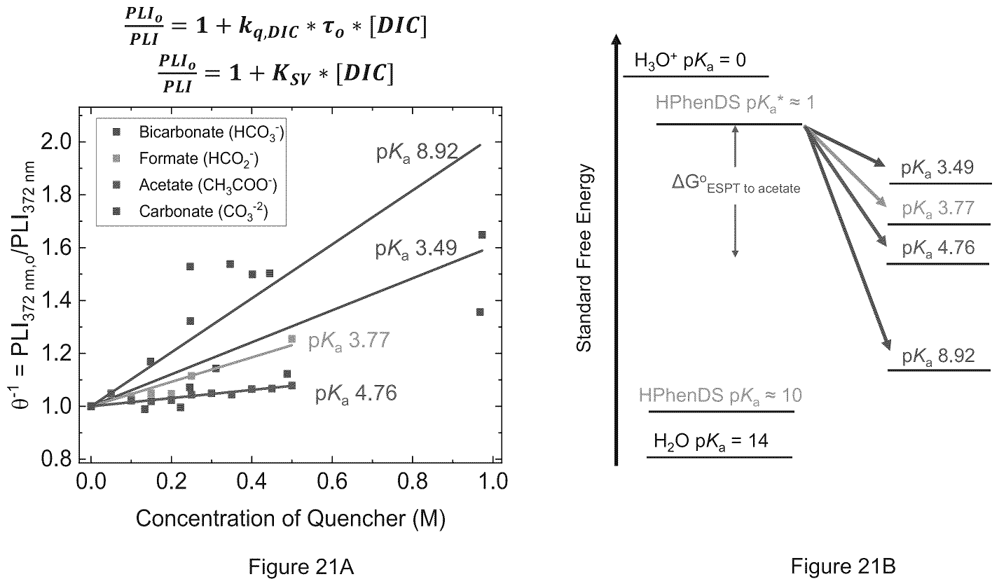

FIGS. 21A and 21B illustrate Stern-Volmer analysis for quenching constant Kₛᵥ in accordance with an embodiment. K_{SV,Bicarbanate} is about 0.60507 M⁻¹. K_{SV,Formate} is about 0.46234 M⁻¹. K_{SV,Acetate} is about 0.15484 M⁻¹. K_{SV,Carbanate} is about 1.02049 M⁻¹. These data include fits and experiments performed at constant ionic strength to ensure consistent dye pKₐ values. D_{Bicarbonate} is about 1.17×10⁻⁵ cm² s⁻¹. D_{Formate} is about 1.454×10⁻⁵ cm² s⁻¹. D_{Acetate} is about 1.089×10⁻⁵ cm² s⁻¹. D_{carbonate} is about 0.81×10⁻⁵ cm² s⁻¹.

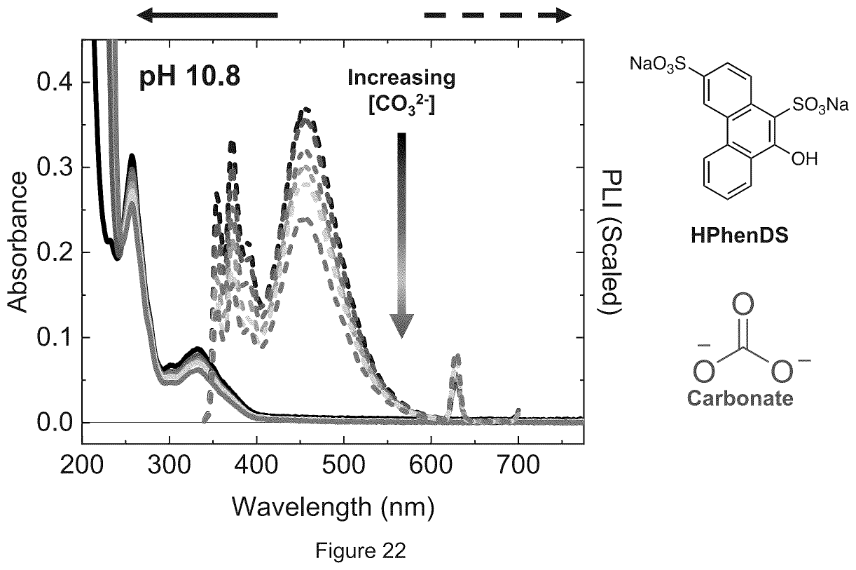

FIG. 22 illustrates static quenching of photoacids due to quenching by sodium carbonate in accordance with an embodiment. Absorption changes indicate static quenching, when dye concentration and pH are constant, which also constitutes a suitable fluorescent sensing mechanism based on a decrease in photoluminescence intensity from the electronic excited state of the protonated photoacid.

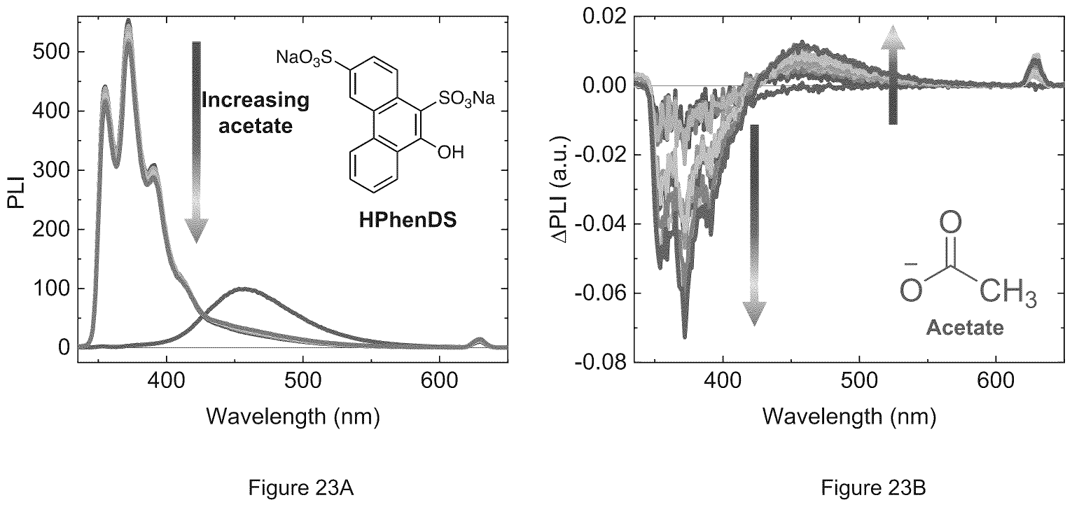

FIGS. 23A and 23B illustrate changes in photoluminescence intensity of aqueous HPhenDS due to quenching by sodium acetate in accordance with an embodiment. Changes in photoluminescence intensity provide information on the quenching mechanism. Deprotonated emission increases as protonated emission decreases, suggesting that the quenching mechanism is likely dynamic ESPT to the quencher.

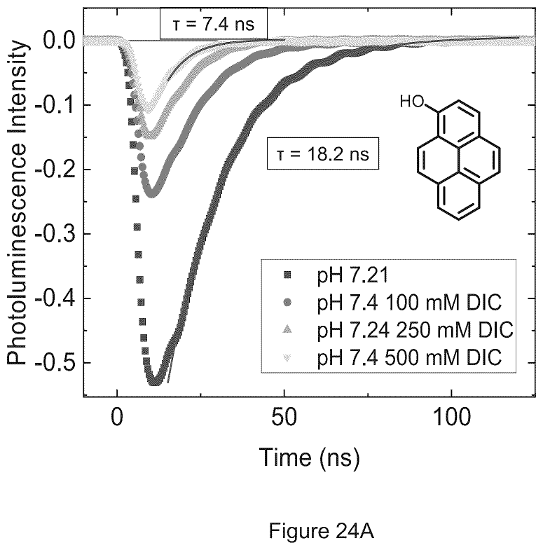

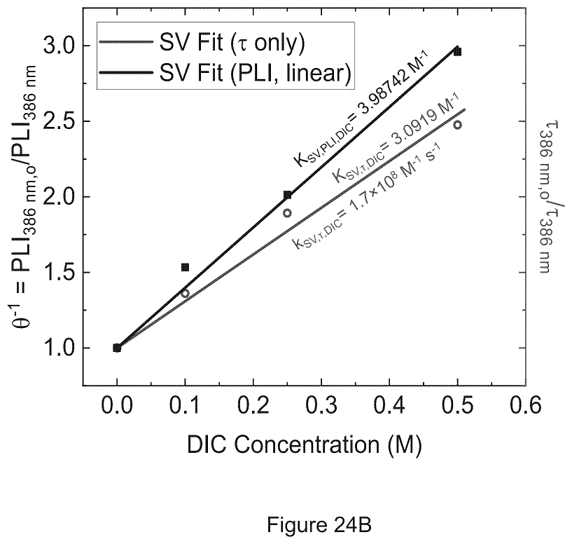

FIGS. 24A and 24B illustrate static and dynamic quenching of aqueous 1-hydroxypyrene due to quenching by dissolved inorganic carbon species in accordance with an embodiment. 1-hydroxypyrene has a ground state pKₐ of about 9 and pseudo-excited-state pK*ₐ of about 4. While static quenching results in the decreased formation of the excited state, time-resolved photoluminescence spectroscopy can detect changes due to dynamic quenching. Conditions: Time-resolved photoluminescence spectroscopy data for aqueous 1 μM 1-hydroxypyrene with varying concentrations of dissolved inorganic carbon (DIC) prepared from sodium bicarbonate. Transients were generated by placing the solution in a 1 cm path length cuvette under 355 nm excitation (pulse width ˜4 ns FWHM, pulse energy 0.3 mJ per pulse) and detected at the peak emission wavelength of 1-hydroxypyrene of 386 nm. Overlaid in red are best fits to a single decaying exponential function starting at 15 ns to ensure that deconvoluted peak features were not fit and/or using a deconvolution process to correct for the instrument response function.

### CO₂ Reduction

Storing renewable energy effectively for long time periods is important in order to reach negative CO₂ emissions. The concept of electrochemical CO₂ reduction (CO₂R) is compelling because it enables the storage of renewable energy in the form of chemical bonds. CO₂R establishes CO₂ and water (H₂O) as the primary sustainable feedstocks to form useful chemicals and fuels, thereby closing the carbon cycle. The electrochemical CO₂R process is complex and there are many challenges that need to be overcome before this technology is energy-efficient and selective enough to be commonly used at an industrial scale.

One promising approach is the use of gas diffusion electrodes (GDEs). This type of electrode addresses the problem of mass transfer limitations that are encountered in conventional catalytic setups by delivering CO₂ in the gas phase to a catalyst in contact with a liquid electrolyte. Most GDEs include a macro-porous gas diffusion layer topped with a hydrophobic microporous layer that is then subsequently coated with a catalyst. The catalyst can be wetted by a thin layer of aqueous electrolyte to provide ionic conductivity but not limit CO₂ transport to the surface. This setup allows for increased current densities by more than one order of magnitude over conventional setups. For a conventional setup in which two electrodes are placed in CO₂-saturated electrolyte, mass transport to the cathode limits the rate of CO₂ consumption and hence, the maximum current density magnitude may not exceed 30 mA/cm². In addition, tailored GDEs can achieve current density magnitudes larger than about 1 A/cm².

Various parameters influence the activity and selectivity of a GDE. The interplay between these operating parameters can dictate the CO₂R performance. The choice of catalyst material can influence the system's performance. One common CO₂R catalyst is copper, because its moderate binding energy to CO as a reaction intermediate allows for its further reduction to desirable higher-order carbon products such as ethanol, propanol, ethylene, and acetate. (See, e.g., R. Kortlever, et al., J. Phys. Chem. Lett. 2015, 6, 4073-4082; K. Kuhl, et al., Energy Environ. Sci. 2012, 5, 7050-7059; S. Nitopi, et al., Chem. Rev. 2019, 119, 7610-7672; the disclosures of which are incorporated herein by reference.) Furthermore, the influence of various parameters (such as the composition and structure of the GDE, i.e. pore size, hydrophobicity, surface depositions or the presence of microstructures) on the selectivity and activity of CO₂R, may not be well understood well. (See, e.g., B. Kim, et al., J. Power Sources 2016, 312, 192-198; L.-C. Weng, et al., Phys. Chem. Chem. Phys. 2018, 20, 16973-16984; P. Jeanty, et al., J. CO₂ Util. 2018, 24, 454-462; E. R. Cofell, et al., ACS Appl. Mater. Interfaces 2021, 13, 15132-15142; the disclosures of which are incorporated herein by reference.) Other parameters that may affect GDE activity and selectivity include the applied potential, the properties of the electrolyte (e.g. the constituent ions and the viscosity), the cell configuration, and the choice of ion-exchange membranes. In addition to the aforementioned parameters, the local activities of hydroxides, a_{OH}_{^{−}}, and protons, a_{H}_{⁺}, for which the pOH and pH values are a measure, are important because both species are involved in the CO₂R process. The pOH value is defined as pOH=−log₁₀(a_{OH}_{^{−}}) and the pH value as pH=−log₁₀(a_{H}_{⁺}). In many cases, hydroxide and proton activity can be approximated as the concentration. At equilibrium, pH+pOH=pK_{w}, with pK_{w}=14 under ambient conditions, so if the system is in equilibrium, the pH can be directly inferred from the pOH.

For a GDE at open circuit, CO₂ may diffuse through the macro-porous and microporous layers into the electrolyte where it rapidly reacts with OH⁻ to form bicarbonate and carbonate anions. This decreases the local OH⁻ concentration and thereby increases the pOH in the electrolyte. Due to the participation of CO₂ in these buffer reactions, the ability to map the spatially and time-resolved pOH around a GDE enables to assess the local concentration of CO₂ in the electrolyte around a GDE.

At a non-zero current, a portion of the CO₂ molecules is reduced to form products such as carbon monoxide, formic acid, methane or ethylene, among others. During this non-equilibrium process, one OH⁻ is created, or one buffer species is deprotenated for each electron involved. The same holds true for the competing hydrogen evolution reaction (HER) that needs to be suppressed to maximize the CO₂R yield. As a result, at sufficiently high current densities, the pOH may decrease. This effect is in competition with an increase in pOH caused by unreduced CO₂ molecules that undergo reactions to form bicarbonate and carbonate anions. As a result, a low observed pOH indicates the presence of CO₂ reduction activity.

In addition, the pH and pOH can impact the reactivity and selectivity of CO₂R. High pH (corresponding to low pOH) may suppress the parasitic HER and shift the CO₂R selectivity towards C₂₊ products. (See, e.g., Z. Zhang, ACS Energy Lett. 2020, 5, 3101-3107; X. Liu, et al., Nat. Commun. 2019, 10, 32; K. Yang, et al., J. Am. Chem. Soc. 2019, 141, 15891-15900; L. Wang, et al., ACS Catal. 2018, 8, 7445-7454; the disclosures of which are herein incorporated by reference.) The reason for the latter may be that OH⁻ actively suppresses the creation of single carbon products (Ci) and hydrogen molecules (H₂), while it does not affect the C₂₊ current density. This leads to an increased Faradaic efficiency (FE) towards C₂₊ products at a given current density.

pOH in the vicinity of an operating GDE is an important parameter to optimize the performance of a GDE. pOH may vary as a function of distance from the electrode surface. In addition, it also varies in the plane parallel to the surface if there are any inhomogeneities such as microcavities present on the surface. Measuring techniques that can map pOH around an operating GDE with high resolution in three dimensions are desired.

Previous efforts towards this end have included theoretical studies of the pH around GDEs performing CO₂R. (See, e.g., L.-C. Weng, et al., Phys. Chem. Chem. Phys. 2018, 20, 16973-16984; N. Nesbitt, et al., J. Phys. Chem. C. 2021, 125, 24, 13085-13095; S. Suter, et al., Energy Environ. Sci. 2019, 12, 1668-1678; the disclosures of which are herein incorporated by reference.) Experimental approaches have involved scanning electrochemical microscopy (SECM), surface-enhanced Raman (SERS), electrochemical atomic force microscopy (EC-AFM) and surface-enhanced infrared spectroscopy (SEIRAS). (See, e.g., A. Botz, et al., Angew. Chem., Int. Ed. 2018, 57, 12285-12289; S. Dieckhöfer, et al., Chem.—Eur. J. 2021, 27, 5906-5912; X. Lu, et al., J. Am. Chem. Soc. 2020, 142, 15438-15444; N. Nesbitt, et al., J. Electrochem. Soc. 2021, 168, No. 044505; M. C. O. Monteiro, et al., Curr. Opin. Electrochem. 2021, 25, No. 100649; N. C. Rudd, et al., Anal. Chem. 2005, 77, 6205-6217; the disclosures of which are herein incorporated by reference.) While these techniques are powerful and can reach spatial resolutions on the nanometer scale, they do not have the ability to map the operando pH/pOH of an entire macroscopic sample in three spatial dimensions.

Many embodiments combine confocal microscopy and weak photoacids in mapping local pOH and/or pH in micrometer scale and in three dimensions. Several embodiments implement fluorescent confocal laser scanning microscopy (CLSM) in the pH measurement. CLSM enables time-resolved measurements in three spatial dimensions. The spatial resolution of this technique can reach about 250 nm under ideal conditions. The time resolution can vary from microseconds to several seconds depending on the size and spatial resolution of the frame of interest. The combination of time resolution with sub-micrometer spatial resolution in three spatial dimensions with high accuracy enables pOH-mapping in accordance with many embodiments. In various embodiments, it enables mapping of the local pOH value under operating conditions over a wide current density scale, from 0 to about 200 mA/cm² in magnitude; or greater than about 200 mA/cm² in magnitude. Mapping the operando pOH in three dimensions with high resolution enables probing the pOH within microstructures on a sample surface. The methods enable measuring the operando pOH within cavities in the surface of various samples including (but not limited to) electrodes, working electrodes of an electrochemical cell, and gas diffusion electrodes. Measuring the pOH of a GDE surface can correlate the microstructure geometry of a GDE with its CO₂R performance.

The ratiometric fluorescent photoacid dye DHPDS is sensitive to pH values between 6 and 10. The sensing mechanism of the photoacid DHPDS involves proton-transfer reactions in its electronic ground state to perturb its absorption spectrum. This is the mechanism used by fluorescent pH indicators in biological studies at near-neutral-pH conditions. With DHPDS, the local pH at the GDE surface may increase from pH 6.8 to greater than 10 as the magnitude of the current density is increased from 0 to −28 mA/cm² in 100 mM KHCO₃ electrolyte. In several embodiments, the pH inside trenches 5-20 μm wide in the GDE surface locally increases more than on the GDE surface. In a number of embodiments, the pH increases as the trench width diminishes which indicates that narrow trenches exhibit higher CO₂R activity than wider trenches and planar surfaces. Weak photoacids, such as APTS, do not undergo proton-transfer reactions in its electronic ground state at near-neutral-pH and alkaline-pH conditions. Instead, the fluorescent signal of APTS is altered via quenching of its thermally equilibrated electronic excited state by direct proton transfer to aqueous OH⁻ as discussed above. Aqueous dissolved inorganic carbon species do not interfere with this process. The aromatic amine form of APTS can be used as a probe for the pOH value and is sensitive to pOH values between about 0 and about 2.8, compared to pOH 4-8 for DHPDS. Several embodiments combine DHPDS with APTS for local pOH sensing, which is able to cover a pOH range from 0 to 8 (with a gap between 2.8 and 4) and investigate operating GDEs under current densities as large in magnitude as −200 mA/cm². Some embodiments explore the influence of different bicarbonate concentrations in the electrolyte and of different microstructure geometries.

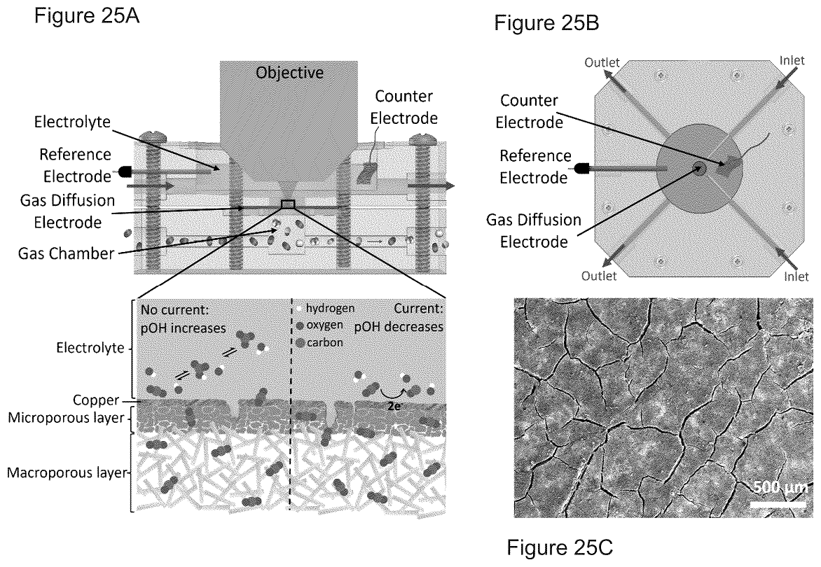

FIGS. 25A through 25C illustrate a local pOH measurement setup in accordance with an embodiment. FIG. 25A shows a cross section of an electrochemical cell and a confocal microscope objective. The electrochemical cell can be combined with a confocal microscope such as CLSM for mapping local pOH. Two fluorescent dyes DHPDS and APTS can be used to map the pOH around an operating GDE performing CO₂R over a wide pOH range. An electrochemical cell compatible with CLSM is shown in FIG. 25A. The maximum spatial resolution of the confocal microscope can be about 250 nm in the x-y plane and about 500 nm in the z-direction, however, electrolyte flow introduces noise, so the resolution is estimated to be on the order of one micron.

The electrochemical cell comprises of an electrolyte chamber with two perpendicular electrolyte inlets and outlets and is open at the top which allows the water immersion objective of the confocal microscope to be immersed into the electrolyte. The reference electrode, counter electrode, and GDE (working electrode) are immersed in an aqueous electrolyte. The GDE is in contact with a gas chamber that allows the flow of gaseous CO₂. The GDE can be made of a Sigracet 22 BB carbon paper substrate covered with 300 nm Cu as well as a carbon black, graphite and Nafion coating. The reference electrode can be a silver/silver chloride electrode, and the counter electrode can be a Pt electrode. For experiments at constant current densities, a leakless silver/silver chloride reference electrode and a platinum mesh counter electrode are submerged into the electrolyte.

The enlargement (FIG. 25A) shows a schematic cross section of the carbon paper GDE (not to scale). The substrate's surface is covered by an irregular pattern of trenches in micrometer scale as shown schematically as a cross section in the enlargement. CO₂ gas can transfer through the GDE. CO₂ can react with water and form bicarbonate and/or carbonate to reach equilibrium. If no current is passing as shown in the left hand side, the pOH increases as a result of the CO₂ reaction. Under an applied current as shown in the right hand side, the pOH decreases as a result of the CO₂R reactions. FIG. 25B shows a top view of the electrochemical cell showing two perpendicular electrolyte inlets and outlets.

FIG. 25C shows a top-down scanning electron microscopy (SEM) image of the GDE surface (Sigracet 22BB carbon paper with 300 nm Cu). The substrate's surface is covered by an irregular pattern of trenches about 5-30 μm wide which can be seen from the SEM image. The trenches cover approximately 6% of the sample surface. Energy dispersive X-ray spectroscopy (EDS) measurements reveal that copper covers not only the planar carbon paper surface but also the trench walls and bottoms.

Some embodiments use APTS in the absence of electrical current to investigate the diffusion of CO₂ through a GDE. For this, 1 M KOH electrolyte (pOH 0) with 100 μM APTS can be used. The fluorescence signal is mapped in the plane perpendicular to the electrode surface as a function of time with one frame captured approximately every four seconds. After one minute of continuous measurements, a 10 standard cubic centimeters per minute (SCCM) CO₂ gas stream is fed into the gas chamber of the electrochemical cell and the change in pOH in the electrolyte can be observed. The measurements are performed both with and without circulating the electrolyte at a rate of 6 mL/min.

In several embodiments, both dyes DHPDS and APTS can be used to map the pOH around an operating GDE performing CO₂R at current densities between about 0 mA/cm² and about −200 mA/cm². Measurements are performed in the plane parallel to the electrode surface, at about 20 μm above the surface, at the surface, and at 20 μm below the surface inside a trench. A CO₂-saturated aqueous KHCO₃ solution with KHCO₃ at concentrations of about 100 mM, 200 mM and 400 mM spiked with about 100 μM DHPDS or about 200 μM APTS is used as the electrolyte and pumped through two perpendicular inlets at a rate of about 6 mL/min. The CO₂ gas flow through the gas chamber is set to about 10 SCCM. The electrolyte with dilute dye is removed from the cell and replaced after each measurement. Every measurement is performed at least three times. The CO₂R performance of equivalent copper on carbon paper GDEs is tested with gas chromatography.

Certain embodiments show the local pOH in the electrolyte surrounding a GDE changed upon exposure to CO₂ at open circuit. The pOH measurement combines time resolution with the capability to spatially resolve the local pOH inside inhomogeneities in the surface of a GDE. CO₂ reacts with OH⁻ and water molecules in the electrolyte to form bicarbonate and carbonate anions. This increases the pOH which becomes an indicator for the CO₂ diffusion pattern.

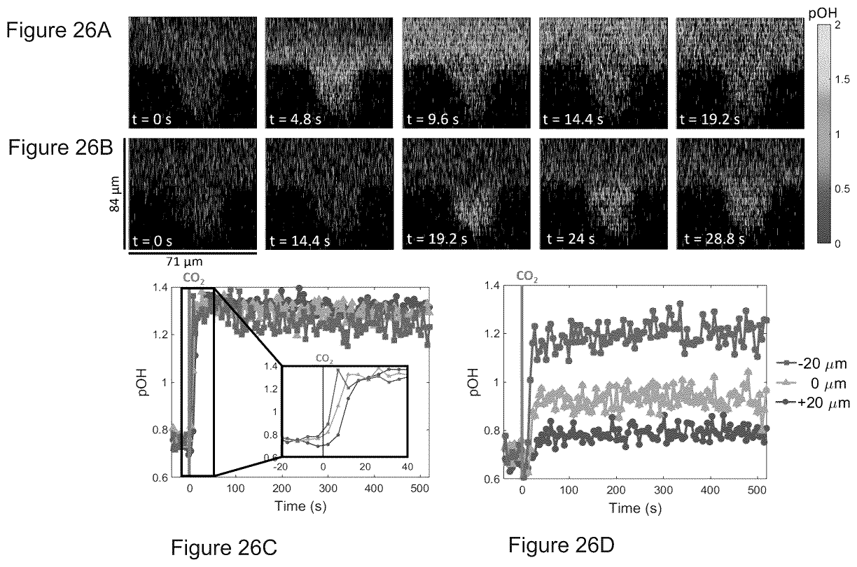

FIGS. 26A through 26D illustrate local pOH mapping near a GDE with and without electrolyte flow in accordance with an embodiment. Changing pOH in the electrolyte due to CO₂ diffusion around a trench in a carbon paper GDE at open circuit are shown without electrolyte flow (A and C) and with electrolyte flow (B and D). Measurements are performed with 1M KOH electrolyte with 100 μM APTS, 10 SCCM CO₂ turned on at the backside of the electrode at t=0 s. Frames in A and B show pOH maps as a cross section through a trench in the plane perpendicular to the electrode surface for different times. C and D track the average pOH at locations 20 μm above the surface (+20 μm), at the surface (0 μm) and 20 μm below the surface in the trench (−20 μm), as specified in the first frame of A as a function of time. The vertical gray lines indicate the start of the CO₂ flow.

FIG. 26A shows color-coded maps of the local pOH in the plane perpendicular to the electrode surface as a cross-section through a trench as well as the above electrolyte for different times without electrolyte flow. t=0 s is the time when the CO₂ flow through the gas chamber of the electrochemical cell is turned on. A distinct change in pOH is immediately visible in the first frame after starting the CO₂ flow but it is restricted to the trench. The pOH changes at the electrode surface and in the bulk electrolyte as time proceeds. In FIG. 26C, the average pOH at three different positions is tracked as a function of time. Locations at 20 μm above the electrode surface (+20 μm), at the electrode surface (0 μm), and 20 μm below the electrode surface inside the trench (−20 μm) are tracked. The pOH is averaged along these lines as a function of time. The vertical gray line in FIG. 26C indicates the time when the CO₂ gas supply is turned on. This data confirms that the pOH first changes inside the trench, then at the GDE surface and approximately five seconds later at 20 μm above the surface, which is consistent with the gaseous CO₂ feed coming from the backside of the GDE. After about 20 s, the pOH values converge at all three positions monitored and remain constant for the duration of the experiment. An analogous measurement was performed in a region of the electrode void of trenches and the pOH increases at a slower rate in comparison to measurements at a location with a trench. This demonstrates that microstructures such as trenches promote faster CO₂ transport through a GDE substrate.

The experiment is repeated under an electrolyte flowrate of 6 mL/min as shown in FIG. 26B. The first change in pOH is only visible after 19 s, compared to less than 5 s without electrolyte flow. A significant increase in pOH caused by the diffusion of CO₂ is solely observed inside the trench. FIG. 26D tracks the pOH over time. This confirms that the pOH increases little at the GDE surface as well as 20 μm above the surface, and even within the trench, the pOH remains below the value obtained without electrolyte flow. A steady state, with constant pOH up to 20 μm above the electrode surface, is reached after 40 s. However, the pOH at the three locations does not converge to a single value, in contrast to the measurements performed with stationary electrolyte. Electrolyte flow results in a well-defined boundary layer around the GDE surface which leads to a CO₂ concentration gradient. In the absence of electrolyte recirculation, diffusion is the dominant transport mechanism for CO₂ and subsequent CO₂R products. When the electrolyte is circulated however, convection dominates the mass transfer and causes OH⁻ to be more quickly removed from the GDE surface. This prevents the pOH from rising as much as it would without electrolyte flow. As the electrolyte is more stationary inside trenches, a larger pOH increase can be observed in these confined spaces.

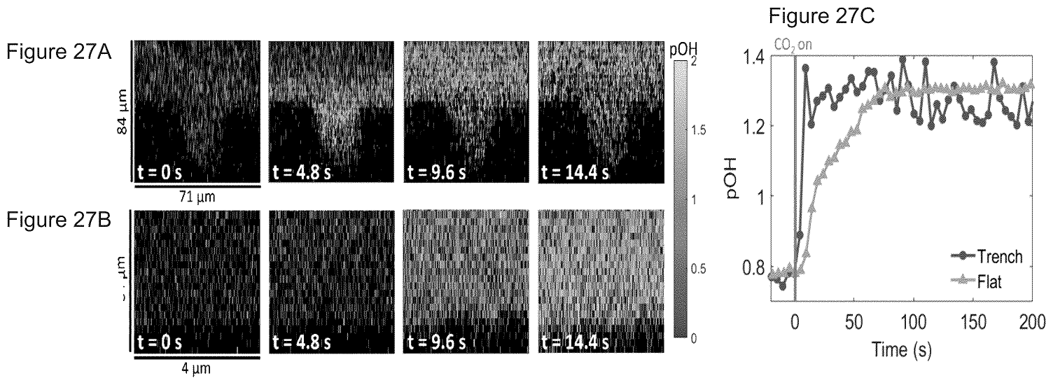

FIGS. 27A through 27C illustrate local pOH mapping near a GDE around a trench and far away from any trench in accordance with an embodiment. FIG. 27 shows the pOH change in the electrolyte due to CO₂ diffusion through a carbon paper GDE (A) with a trench, (B) without a trench, both without electrolyte flow. Measurements performed with 1M KOH electrolyte with 100 μM APTS, 10 SCCM CO₂ turned on at t=0 s. A and B show pOH maps in the plane perpendicular to the electrode surface for different times. C shows average pOH at a location 20 μm above the surface, showing how it changes as a function of time both with and without a trench. The vertical gray line indicates when the CO₂ flow was turned on.

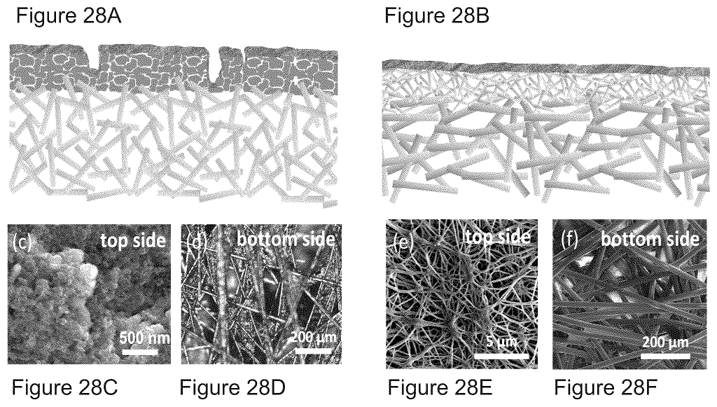

CO₂ diffusion through homogeneous GDE substrates made of laminated polytetrafluoroethylene (PTFE) with pore sizes ranging between 0.1 to 0.2 μm and 0.45 μm, are reported. FIGS. 28A through 28F illustrate schematic representations of the structure of both a carbon paper GDE and a PTFE GDE together with SEM images in accordance with an embodiment. As can be seen, schematic representations of the structure of a Sigracet 22 BB carbon paper GDE (A) and a PTFE membrane GDE (not to scale) (B), both are coated with 300 nm Cu, together with SEM images of the top side (C) and the bottom side (D) of the carbon paper GDE as well as of the top side (E) and the bottom side (F) of the PTFE GDE.

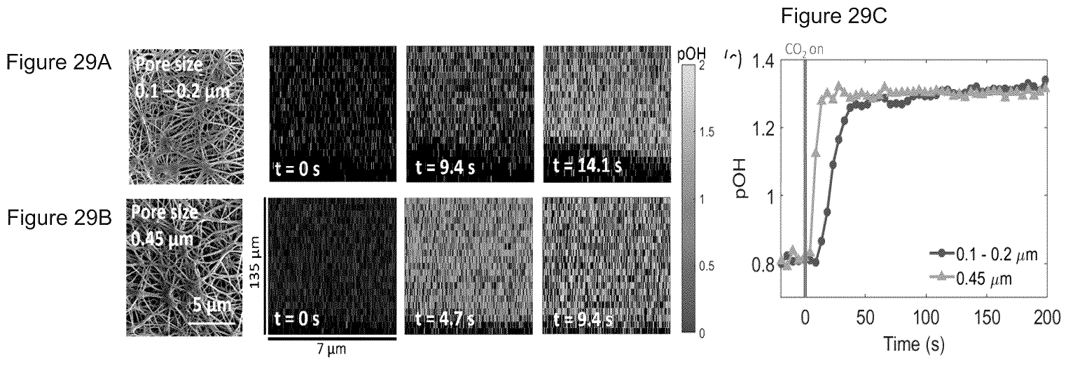

FIGS. 29A through 29C illustrate comparison of the flow patterns through PTFE GDEs with different pore sizes in accordance with an embodiment. pOH change in the electrolyte due to CO₂ diffusion through a PTFE GDE with pore size 0.1-0.2 μm (A) and 0.45 μm (B), both without electrolyte flow. Measurements are performed in 1 M KOH electrolyte with 100 μM APTS, 10 SCCM CO₂ turned on at t=0 s. (A) and (B) show SEM images of the GDE as well as pOH maps as a cross section in the plane perpendicular to the electrode surface for different times. FIG. 25C shows change in average pOH at a location 20 μm above the surface as a function of time for both GDE substrates with different pore sizes. The vertical gray line indicates when the CO₂ flow is turned on. As can be seen, the pOH in the electrolyte above the surface increases faster for PTFE with a larger pore size. After 45 seconds it converges to the same value for both substrates. This shows that, not only microcavities in a GDE's surface, but also larger pore size can promote faster CO₂ transport. However, there is a critical pore size that should not be exceeded, otherwise the pores will be flooded with liquid electrolyte during an experiment. This has been observed for a laminated PTFE substrate with pore sizes of 5 μm or greater. Flooding prevents effective CO₂ transport and inhibits CO₂ diffusion to catalytic sites.

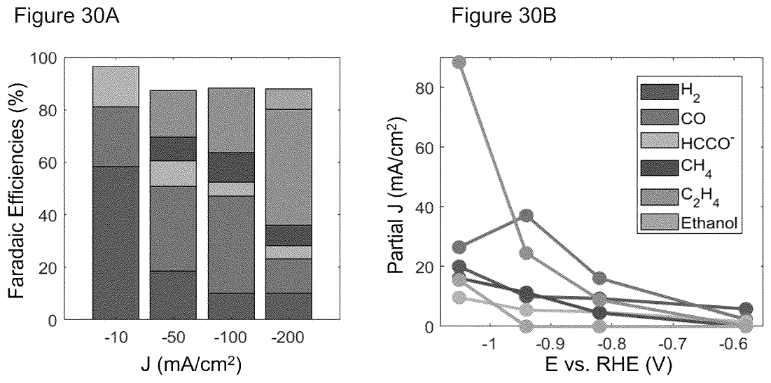

Gas chromatography for different current densities can be performed on copper GDEs to evaluate the CO₂R performance. H₂ production dominates for low current density magnitudes. As the magnitude of the current density increases, more CO₂R products can be seen, and the selectivity shifts towards C₂₊ products. Ethylene for current densities of −50 mA/cm² or higher in magnitude and ethanol for <200 mA/cm² can be observed. FIGS. 30A and 30B illustrate Faradic efficiency and partial current density of copper GDEs in accordance with an embodiment. CO₂R performance is characterized using 300 nm Cu on carbon paper GDEs. FIG. 26A shows Faradaic efficiencies at different current densities. FIG. 26B shows partial current densities for different products as a function of electrode potential vs. the reversible hydrogen electrode.

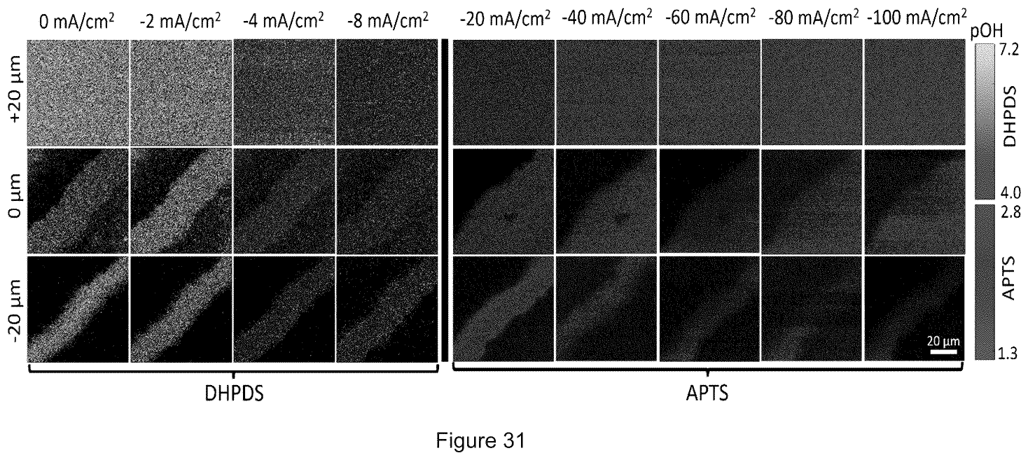

Combining the two pOH-dependent fluorescent ratiometric dyes, DHPDS and APTS, enables to cover the pOH range from 0 to 8. In the context of CO₂R, a low local pOH under operation indicates high CO₂R activity and is desirable because high pH can help suppress the parasitic HER and favor the formation of C₂₊ products. FIG. 31 illustrates displays pOH maps in the plane parallel to the electrode surface in accordance with an embodiment. The pOH maps are taken in the plane parallel to the electrode surface about 20 μm above the surface, at the surface and about 20 μm below the surface inside a trench in 100 mM KHCO₃ electrolyte for different current densities between 0 mA/cm² and −100 mA/cm², obtained with 100 μM DHPDS (left) and 200 μM APTS (right). APTS degrades and slowly loses its fluorescence for high current densities. This may be connected to the reduction of APTS at the electrode surface. Despite the slow degradation of APTS, the pOH measurements obtained with APTS are reliable because APTS is a ratiometric dye. The pOH value is calculated from the ratio between two signals that are captured independently in two different wavelength intervals. As some dye molecules degrade, both signals become weaker. This leads to a decreased signal-to-noise ratio, however, the ratio between both signals remains unchanged. The dye degradation effect could be mitigated by using an APTS concentration of 200 μM (compared to DHPDS, where 100 μM is sufficient), removal and replacement of the electrolyte after each measurement, and the introduction of two perpendicular electrolyte inlets to ensure the transportation of fresh APTS to the GDE surface. Some of the panels under high current densities still appear relatively dark and noisy. This is especially evident inside the trench as the electrolyte is more stationary in confined spaces and this encumbers the transport of fresh, undegraded dye. However, since APTS is a ratiometric dye, the pOH it predicts does not depend on concentration. At magnitudes of the current density of about −200 mA/cm², fluorescence signal can still be collected to determine the pOH.

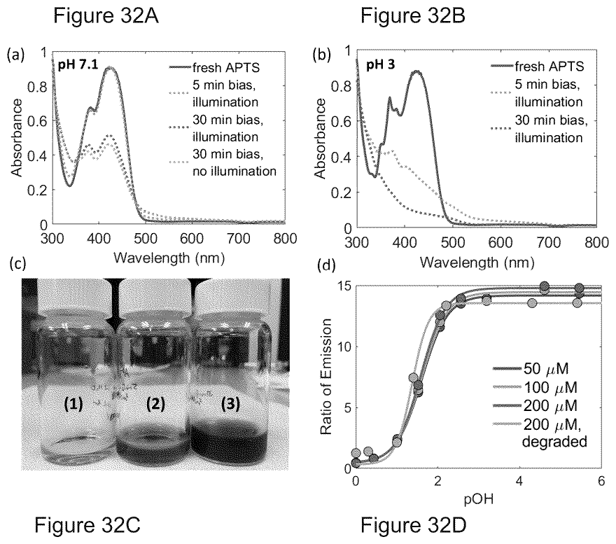

FIGS. 32A-32D illustrate electronic absorption spectra of APTS in accordance with an embodiment. FIG. 32A illustrates electronic absorption spectra of 200 μM APTS in aqueous 100 mM KHCO₃, as freshly prepared, and exposed to a GDE operating at −100 mA/cm² for 5 minutes under laser illumination, and for 30 minutes, with and without laser illumination. (b) Electronic absorption spectra of 200 μM APTS in an aqueous HCl pH 3 solution as freshly prepared and exposed to a GDE operating at −100 mA/cm² under laser illumination for 5 minutes and for 30 minutes. (c) Photographs of aqueous 10 mM APTS stock solutions: (1): fresh, (2): degraded by exposure to a GDE operating at −100 mA/cm² for 5 minutes, (3): degraded by exposure to a GDE operating at −100 mA/cm² for 30 minutes. (d) Calibration curves of APTS with the measured ratio of emission as a function of pOH together with best fit curves for different APTS concentrations between 50 μM and 200 μM and for 200 μM APTS that was degraded by exposure to a GDE operating at −100 mA/cm² for 5 minutes (solution (2) in FIG. 32C).

For a current density of J equals to about 0 mA/cm², the pOH equals 7.2 everywhere (pOH of CO₂-saturated 100 mM KHCO₃). When the current is non-zero, the local pOH decreases because OH⁻ is created as a byproduct of CO₂R. The pOH is lower at the electrode surface than 20 μm above the surface because CO₂ is reduced at the electrode surface and for the pOH to decrease at +20 μm, OH⁻ has to diffuse away from the surface. Due to electrolyte flow, a concentration gradient is created. Furthermore, the pOH inside the trench is lower than at the surface. This can be seen in the panels for current densities of −2 mA/cm² and −20 mA/cm².

The surface morphology of copper does not change during CO₂R experiments, confirmed by SEM as well as EDS measurements for samples before and after CO₂R. Potassium deposits may appear on the sample after CO₂R that originate from KHCO₃ molecules in the electrolyte, but the copper catalyst doesn't change in appearance, neither in the trenches nor on the planar electrode surface.

In many embodiments, the pOH sensitivity of the photoacid DHPDS can be extended to pOH from about 2.5 to about 8, excited at about 405 nm (laser power 1.2%, gain 100) and about 485 nm (laser power 2%, gain 80) and the emission is collected between 495 nm and 835 nm. The extended pOH range can be achieved by excitation of the absorption peak of DHPDS around 405 nm. With the new laser settings, the calibration curve of DHPDS can be fitted with a sigmoidal curve:

$$\begin{matrix}{RoE}_{DHPDS} = \frac{1.147}{1 + exp ( - 1.014 \cdot ( pH - 8.504 ) )} + 0.08953 \\ pH = 8.504 - \frac{1}{1.014} ln ( \frac{1.147}{{RoE}_{DHPDS} - 0.08953} - 1 )\end{matrix} .$$

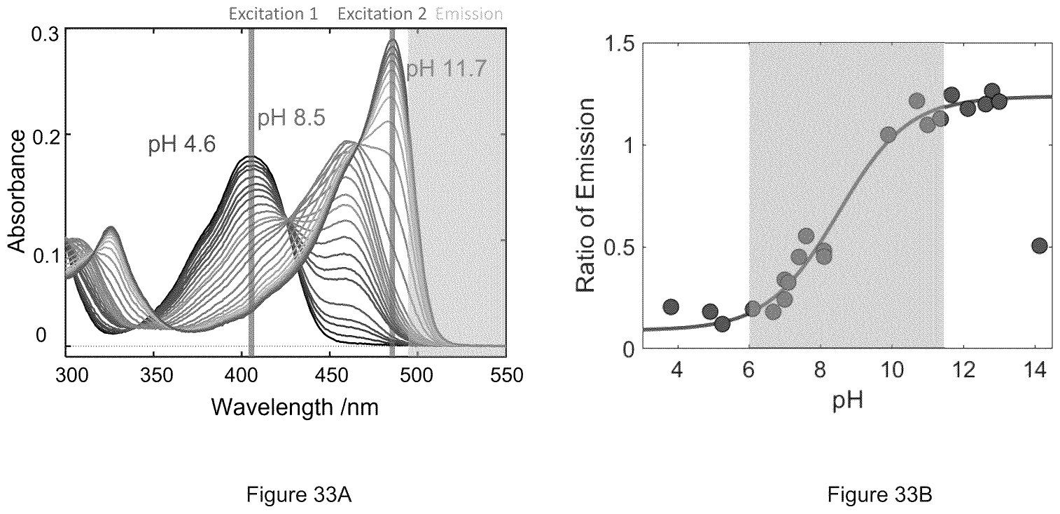

FIG. 33A illustrates the calibration of DHPDS in accordance with an embodiment. Previous setting with Zeiss LSM 710: excitation 1 at 458 nm (diode laser), laser power 100%, gain 800; excitation 2 at 488 nm (diode laser), laser power 20%, gain 800. Detection at 505-754 nm. Best setting with Leica Stellaris 5: excitation 1 at 405 nm (diode laser), laser power 1.2%, gain 100 excitation 2 at 485 nm (white laser), laser power 2%, gain 80. Detection at 495-835 nm.

FIG. 33B illustrates the ratio of emission of DHPDS in accordance with an embodiment. Based on the equations above, DHPDS is sensitive to pH from about 6 to about 11.5.

The pOH sensitivity of APTS in a basic environment is from about 0.5 to about 2.5, excited at about 405 nm (laser power 2%) and at about 448 nm (laser power 0.3%) and the emission is collected at about 460 nm-550 nm (gain 13) and about 570 nm-840 nm (gain 25). This sigmoidal calibration curve of APTS:

$${RoE}_{APTS} = \frac{- 4.311}{1 + exp ( - 5.616 \cdot ( pH - 12.45 ) )} + 4.343 \\ {pH}_{DHPDS} = 12.45 - \frac{1}{5.616} ln ( \frac{- 4.311}{{RoE}_{DHPDS} - 4.343} - 1 )$$

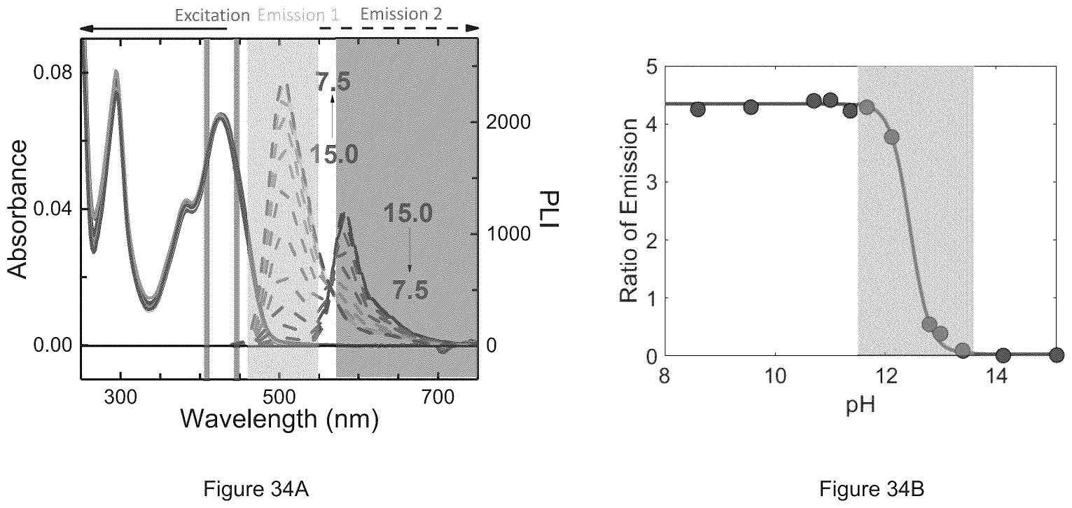

FIG. 34A illustrates the calibration of APTS in basic pH in accordance with an embodiment. Previous setting with Zeiss LSM 710: excitation at 458 nm (diode laser), laser power 100%; detection 1 at 480-550 nm, gain 800; detection 2 at 551-754 nm, gain 800. Best setting with Leica Stellaris 5: excitation at 405 nm (diode laser), laser power 2% and at 448 nm (diode laser), laser power 0.3%; detection 1 at 460-550 nm, gain 13. Detection 2 at 570-840 nm, gain 25.

FIG. 34B illustrates the ratio of emission of APTS in basic pH in accordance with an embodiment. Based on the equations above, APTS is sensitive to the activity of OH⁻ in the pH range from about 11.5 to about 13.5.

By combining DHPDS and APTS with the settings described, a pOH sensitivity between 0.5 and 8 with no gap can be achieved.

Further, APTS can also be used to sense the local pH value in acidic environments between pH about 0.5 and 2.5. In acidic pH, APTS may not work via quenching of its thermally equilibrated electronic excited state by direct proton transfer to aqueous OH⁻ but rather undergoes a proton-transfer reaction in its electronic ground state to perturb its absorption spectrum, similar to DHPDS. The absorption spectrum of APTS in acidic pH exhibits two peaks which would make it a candidate for a ratiometric dye, however, one of these peaks is at a wavelength below 405 nm which is the lowest wavelength that can be excited by most commercially available confocal microscopes. Therefore, to measure spatially resolved maps of the local pH value with most confocal microscopes, only one peak can be excited and APTS can be used as a non-ratiometric dye. When it is excited at 405 nm (laser power 2%) and 448 nm (laser power 0.3%) and the emission is collected at 460 nm-550 nm (gain 13), a linear calibration curve results with a pH sensitivity between 0.5 and 2.5. The linear fit curve takes the form

$$E = 85.24 \cdot pH - 38.95 \\ pH = \frac{E + 38.95}{85.24} , for 5 \leq E \leq 175$$

where E stands for the emission signal.

These photoacid calibration measurements are performed with a Leica Stellaris 5 upright confocal microscope with a HC FLUOTAR L 25x/0.95 W VISIR water immersion objective.

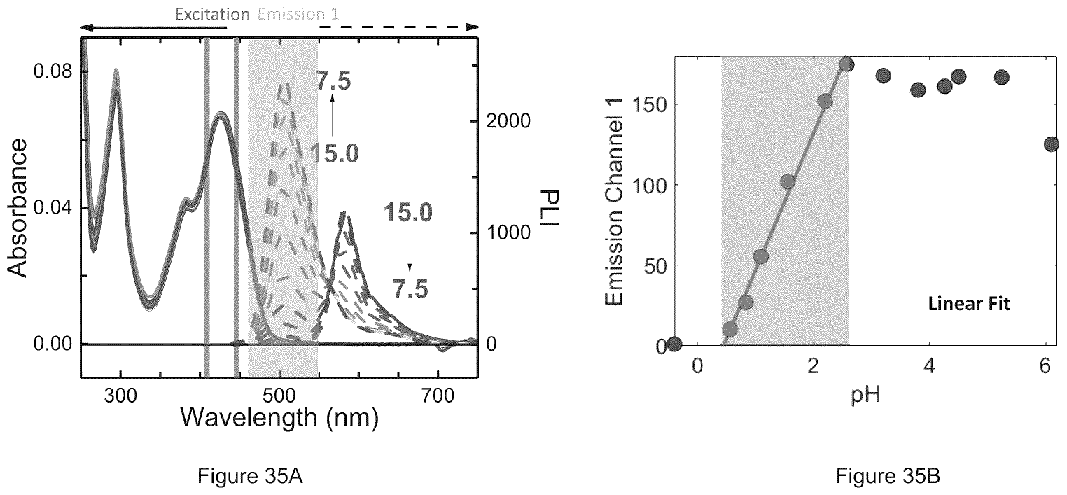

FIG. 35A illustrates the calibration of APTS in acidic pH in accordance with an embodiment. Best setting with Leica Stellaris 5: excitation at 405 nm (diode laser), laser power 2% and at 448 nm (diode laser), laser power 0.3%. Detection 1 at 460-550 nm, gain 11. Detection 2 at 570-840 nm, gain 90.

FIG. 35B illustrates the ratio of emission of APTS in acidic pH in accordance with an embodiment. Based on the equations above, APTS is sensitive to pH from about 0.5 to about 2.5.

### EXEMPLARY EMBODIMENTS

Although specific embodiments of systems and apparatuses are discussed in the following sections, it will be understood that these embodiments are provided as exemplary and are not intended to be limiting.

### Example 1: Materials and Devices

Chemicals used for experiments are reagent grade and are used without any further purification, unless otherwise specified. The following chemicals are used as purchased: hydrochloric acid (36.5-38% w/v), potassium hydroxide (86%), glycine (>99%), L-proline (>99%), trifluoroethanol (>99%) potassium phosphate (>98%), sodium acetate (>99%), potassium chloride (>99%), phosphoric acid (85% w/w), 5-amino-1-naphthalenesulfonic acid, sodium salt (NS—NH₂) (>98%), 5-((2-aminoethyl)amino)naphthalene-1-sulfonic acid, sodium salt (>98%), 8-anilinonaphthalene-1-sulfonic acid, sodium salt (>98%). Ultrahigh purity deionized water is used to make all solutions. Potassium bicarbonate (KHCO₃, 99.95%), potassium hydroxide (KOH), CO₂ gas (research grade, 99.999%), 6,8-dihydroxy-1,3-pyrenedisulfonic acid (DHPDS, ≥97.0%), 8-Aminopyrene-1,3,6-trisulfonic acid trisodium salt (APTS, ≥96.0%), Sigracet 22 BB carbon paper, laminated PTFE membrane filters (pore size 0.1-0.2 μm and 0.45 μm), copper (99.999%), Pt mesh (99.9%, 0.0726 mm diameter wires), leakless Ag/AgCl reference electrode. All materials were used without further modification.

8-Aminopyrene-1,3,6-trisulfonic acid, trisodium salt is synthesized and purified or purchased from Millipore Sigma. With the compound dissolved in deuterated methanol, ¹H NMR and ¹³C NMR spectra are recorded (500 MHz for ¹H NMR and 125 MHz for ¹³C NMR). Spectral information is as follows: ¹H NMR (500 MHz, CD₃OD) δ 8.19 (s, ¹H), 8.43 (d, 1 H), 8.93 (d, ¹H), 9.06 (d, 1 H), 9.16 (d, ¹H), 9.31 (s, ¹H); ¹³C NMR (125 MHz, CD₃OD) δ 113.47, 116.29, 117.98, 120.61, 122.84, 123.47, 124.64, 126.40, 126.64, 127.48, 130.02, 130.56, 134.71, 135.09, 140.99, 144.54.

AMOD dual electron beam deposition system (Angstrom Engineering), NOVA NanoSEM 450 scanning electron microscope confocal with an Oxford Instrument's Xmax 80 mm2, Oakton 5+ pH meter, Denver Instruments Ultra Basic pH meter, Zeiss LSM 710 confocal microscope with a WN Achroplan 63x water immersion objective (numerical aperture 0.9), Biologic SP-200 potentiostat, Masterflex 77120-62 pump, CO₂ gas flow controller (Alicat Scientific), SRI-8610 gas chromatograph.

Copper gas diffusion electrodes are fabricated by electron-beam deposition of 300 nm copper on Sigracet 22BB carbon paper. An AMOD dual electron beam deposition system (Angstrom Engineering) is used. 300 nm of Cu is deposited on the microporous layer of the carbon paper substrate at a rate of 2 Å/s with a rotating substrate holder. The deposited samples are spray-coated, first with a solution of one part deionized water, one part isopropyl alcohol and 2.5 mg carbon black per mL of solution, then with a solution of one part deionized water, one part isopropyl alcohol and 0.5 mL of 5 weight % Nafion per mL of solution. Both coatings are applied from a distance of eight centimeters for one second. The samples are then dried overnight in vacuum.

A NOVA NanoSEM 450 scanning electron microscope is used to capture images of the samples. The spot size is set to three and the acceleration voltage to 15 kV. To identify if copper is present inside trenches, energy dispersive X-ray spectroscopy (EDS) is performed with an Oxford Instrument's Xmax 80 mm2 in the aforementioned SEM with a spot size of five.

The electrochemical cell used for pOH imaging with confocal microscopy is designed to be compatible with the confocal microscope. Because a water-immersion objective is used, the electrolyte chamber needs to be open at the top. This means that the cell is oriented horizontally, otherwise the electrolyte would spill. The working distance of the water immersion objective is 1.7 mm. In order to allow the objective to be placed this close to the GDE surface, the cell operates without ion-exchange membranes. The cell is 3D-printed, the surfaces are sanded. A rubber gasket is placed in between the bottom gas chamber part and the top electrolyte chamber part for sealing. A hole where the GDE is placed connects the gas and electrolyte chambers, which is circular and has a surface area of 0.2 cm². For experiments with applied current, a leakless Ag/AgCl reference electrode is used, and a Pt mesh is dipped into the electrolyte as the counter electrode. The electrolyte chamber, including the tubes used for pumping, holds approximately 10 mL of electrolyte when the objective is immersed into it.

### Example 2: Characterization

Several embodiments use the steady-state ultraviolet-visible electronic absorption and photoluminescence spectroscopy for characterization. Equal amounts of aromatic amine photoacids are portioned into five separate 100 mL volumetric flasks. For the non-proton-accepting quencher experiments, the five flasks are filled to the volumetric marker with aqueous solutions of 1 M HCl, 1 M KOH, 2 M KOH, 3 M KOH, and 4 M KOH. The aqueous 1 M KOH solution is titrated with the aqueous 1 M HCl solution to reach the desired pH values from 14 to 6, and the H⁺ activities are measured using a pH meter (pH/Ion 510). For pH values more alkaline than 14, the pH meter does not accurately report H⁺ activity and therefore the Hammett acidity scale is used to approximate H⁺ activity. Electronic absorption spectra and photoluminescence spectra are acquired using absorbance and fluorescence spectrometer(s), using a square-bottom quartz cuvette (1 cm path length) at room temperature. Electronic absorption spectra are baselined on a spectrum of deionized water and were corrected for scattering of light. Photoluminescence spectra are recorded by exciting with 310 nm light, slit widths for the excitation and emission monochromators were set to 5 nm, and the PMT detector voltage is set to 600 V. Photoluminescence spectra are corrected for changes in solution refractive index, inner filter effects and the wavelength-dependent correction factor of the fluorimeter. For experiments that use non-OH⁻ proton-accepting quenchers, equal amounts of the quencher are added to the dry volumetric flask intended to form the acidic and basic aqueous photoacid solutions, to prevent changes in total quencher concentration during the titration, and titrations are performed similarly to those in the absence of added proton-accepting quenchers. Although the total quencher concentration is kept constant throughout the titration, the activity of the deprotonated quencher species varied as a function of solution pH according to Equation 3. Ionic strength is matched at the most alkaline pH values; however, it is experimentally difficult to maintain the same ionic strength throughout the titration. Normalized photoluminescence intensities as a function of solution pH are obtained by dividing the corrected photoluminescence intensities at the wavelength of maximum photoluminescence to the maximum corrected photoluminescence intensity at the same wavelength. Maximum photoluminescence intensity is obtained for solutions at near neutral pH (a_{OH-}≈10⁻⁷), which is considered to be a reasonable approximation of the photoluminescence intensity in the absence of OH⁻ quencher required for use in the Stern-Volmer analysis.

Some embodiments use nanosecond time-resolved photoluminescence and transient absorption spectroscopies. Photoacid samples with near-neutral pH values obtained by acid-base titration are placed in a 1 cm pathlength quartz cuvette. Time-resolved spectra are acquired using a custom nanosecond spectroscopy system and the excitation source is the 355 nm pulse from the frequency-tripled 1064 nm fundamental line of an Nd:YAG laser. The laser power is measured prior to measurement using a thermal power sensor head to be 0.7 mJ per pulse. Emitted light passes through focusing optics and a filter wheel equipped with a long-pass filter to filter out stray laser light, enters a monochromator, and the intensity is measured by a photomultiplier tube housed by a 5-stage photomultiplier tube housing removed from LKS60 laser flash photolysis spectrometer. For transient absorption spectroscopy measurements, the probe beam is generated by a xenon arc lamp bulb (150 W, 18 V, 6200 K) and an optical chopper, frequency-locked to the pump beam, is used to reduce unnecessary illumination of samples. The sample is placed at a 45° angle with respect to the pump and probe beams. The detector system is powered by a high-voltage power supply electrically biased at 700-900 V (PS325/2500V-25W) and the resulting signal is digitized by an oscilloscope terminated at 50 Ohms. Data is acquired from 700 nm to 360 nm in 10 nm steps by averaging up to 4000 shots at a 10 Hz repetition rate. Before and after time-resolved measurements, a full electronic absorption spectrum is measured from 1100 nm to 200 nm and compared to the spectrum before pulsed-laser experiments to qualitatively ensure minimal dye degradation.

### Example 3: Ratiometric Dyes

DHPDS and APTS are each ratiometric dyes that report on the local activity of OH⁻, because their spectra exhibit at least two distinct peaks that change in intensity in different directions upon altering the pH or pOH. The ratio of emission from either dye is determined by calculating the ratio of the signals from both peaks. It is independent of the local dye concentration, within the concentration ranges used in the experiments. To determine calibration curves of the ratio of emission as a function of pOH, aqueous solutions of known pOH are prepared. For this, aqueous stock solutions of KOH and HCl were diluted with pure water. The pOH of the solutions is confirmed by measuring the pH separately with two different pH meters (and calculating the pOH using pOH =14−pH). Both pH meters are calibrated with buffer solutions at pH 4, pH 7, and pH 10 before use. In the prepared solutions with known pOH, 100 μM DHPDS or 100 μM APTS is diluted from a stock solution. A laser beam scans the sample solutions line by line over the center of a liquid droplet, which is repeated three times and the average ratio of emission is calculated and correlated with the known pOH. For both dyes, the ratio of emission is plotted as a function of pOH and best fit to a sigmoidal function:

$$For DHPDS : {( Ratio of Emission )}_{DHPDS} = \frac{33.72}{( 1 + exp ( 1.413 \cdot ( {pOH}_{DHPDS} - 5.971 ) )} + 5.571 \to {pOH}_{DHPDS} = 5.917 = \frac{1}{1.413} ln ( - 1 + \frac{33.72}{{( Ratio of Emission )}_{DHPDS} - 5.571} ) \qquad ( S 1 )$$

$$For APTS : {( Ratio of Emission )}_{APTS} = \frac{5.005}{( 1 + exp ( - 2.743 \cdot ( {pOH}_{APTS} - 2.05 ) )} + 0.1041 \to {pOH}_{APTS} = 2.05 - \frac{1}{2.743} ln ( - 1 + \frac{5.005}{{( Ratio of Emission )}_{APTS} - 0.1041} ) \qquad ( S 2 )$$

In the case of DHPDS, three distinct peaks in the absorption spectra are important for the calibration curve, one for each of the doubly protonated (R—(OH)₂), monoprotonated (R—(OH)(O⁻)), and doubly deprotonated (R—(O⁻)₂) states of the dye in its electronic ground state. Because DHPDS is a strong photoacid (pK*ₐ≈0), excitation of either protonation state of DHPDS at near-neutral-pH conditions results in emission from a deprotonated form of the thermally equilibrated electronic excited state of the dye. This is because the kinetics for excited-state proton transfer are significantly faster than the excited-state lifetime of the dye and thus the thermally equilibrated electronic excited-state of the dye reaches chemical quasi-equilibrium. DHPDS is excited separately using 458 nm laser light (100% maximum power) and 488 nm laser light (20% maximum power) with the pinhole set to 70.1 μm and the gain set to 800 for each channel. Emitted light is detected in the wavelength interval of 505-754 nm separately for each excitation wavelength, and thus the emission ratio is the ratio between the signals collected from the two excitations. That emission ratio data as a function of pOH fits well to the nonideal Henderson-Hasselbalch equation, also known as the Hill equation,

$$( Ratio of Emission ) = \frac{1}{1 + {10}^{n ( pH - {pK}_{a obs}^{*} )}} , \qquad ( S 3 )$$

with n the Hill coefficient ideality factor, pK*_{a obs} an effective excited-state pKₐ, and pH=14−pOH, to obtain the calibration curve. The main contributor to the nonideal behavior of the titration data is likely the two pKₐ values for DHPDS, which is well supported by the observation of two isosbestic points in the titration data.

In the case of APTS in aqueous alkaline environments, two distinct peaks in the fluorescence spectra are important for the calibration curve, one for each of the protonated (R—NH₂) and deprotonated (R—NH^{—}) states of the dye in its thermally equilibrated electronic excited state. Because APTS is a very weak acid (pKₐ>14), deprotonation of its electronic ground state requires pH>14. Thus, only the protonated electronic ground state of APTS as the aromatic amine can be excited. However, in the presence of a large concentration of OH⁻, the thermally equilibrated electronic excited state can be quenched via proton transfer to OH⁻ to form the deprotonated electronic excited state. Thus, emission can be observed from either protonation state, as the amine (R—NH₂*) or the aminide (R—NH⁻*). As such, APTS is excited using 458 nm laser light (100% power) with the pinhole set to 57.1 μm and the gain set to 800. Emitted light is detected separately in the wavelength intervals of 480-550 nm and 551-754 nm, and thus the emission ratio is the ratio between the signals collected in the two emission wavelength ranges. That emission ratio data as a function of pH is best fit to the nonideal nonlinear dynamic Stern-Volmer equation and OH⁻ as the quenching species,

$$( Ratio of Emission ) = \frac{1}{1 + {( ( {K}_{SV , {OH}^{-}} ) {a}_{{OH}^{-}} )}^{n}} , \qquad ( S 4 )$$

with K_{SV,OH}_{^{−}} the Stern-Volmer quenching constant, a_{OH}_{^{−}} the activity of OH⁻ equals 10^{-pOH}, and n and ideality factor, to obtain the near-ideal calibration curve.

When performing measurements with the dye DHPDS in the current density range between 0 and −20 mA/cm², no significant decrease in photoluminescence intensity was observed. Some loss of fluorescent signal is observed for cathodic current densities of 100 mA/cm² in magnitude, or larger, but in our application the signal of DHPDS saturates for current densities larger in magnitude than 20 mA/cm² so this effect is not relevant herein.

However, for APTS shows a decrease in photoluminescence intensity for current density magnitudes>80 mA/cm² and we used APTS to investigate the operation of a GDE with current densities as high as 200 mA/cm² in magnitude. To understand this effect, the stability of APTS under different conditions is evaluated. A decrease in photoluminescence intensity from APTS with and without light and for solutions with pH 7.1 and pH 3 is seen, where the degradation effect is more pronounced for the pH 3 solution. Furthermore, a significant change is observed in color of a 10 mM APTS stock solution that is exposed to −100 mA/cm² for 30 minutes, from bright green to brown, that persisted for days without indication of reverting back to its original form (FIGS. 32A-32D). This suggests an irreversible chemical transformation and not a transient instability, such as formation of an excited-state triplet state or a metastable state. The most significant and irreversible decrease in photoluminescence intensity from aqueous APTS under the following simultaneous conditions: (i) cathodic current densities>80 mA/cm² in magnitude, and (ii) closer to the electrode surface and/or within trenches. The presence of illumination does not seem to play a role. In addition, we do not think that CO₂R products are resulting in observed degradation, because the steady-state photoluminescence spectrum of APTS showed minimal change in intensity as concentration of dissolved inorganic carbon increased. Hence, APTS may be being reduced at the electrode surface.

Irrespective, calibration curves of fresh APTS solutions with different APTS concentrations, as well as a curve that was measured with an APTS stock solution that was exposed to −100 mA/cm² for 5 minutes, are nearly identical, suggesting that APTS is suitable to use as a pOH sensor even in the presence of significant degradation to a less emissive product. This can be explained by the ratiometric nature of APTS as a pOH sensor.

For each of DHPDS and APTS, the dye is dissolved in solution and placed under a Zeiss LSM 710 confocal microscope with a WN Achroplan 63x water immersion objective dipped into the solution. A laser beam scans the sample line by line with the settings described above. For both dyes, the pOH is calculated with the calibration curves obtained in Equations S1 and S2.

### Example 4: pOH Imaging

Experiments to visualize CO₂ diffusion through a porous GDE are performed with the electrochemical cell described above. The pOH is resolved with the dye APTS according to the above explained procedure. 1 M KOH (pOH 0) is chosen as the electrolyte, so an expected increase in pOH upon exposure to CO₂ can be detected with APTS. Experiments are performed with carbon paper GDEs prepared as described above, both at locations with a trench present and at locations without a trench present. In addition, laminated PTFE substrates with different pore sizes, coated with 300 nm Cu in the same way as carbon paper, are investigated. Experiments are carried out both with and without electrolyte flow through two perpendicular inlet tubes at a rate of 6 mL/min. Measurements are performed in the plane perpendicular to the GDE surface by scanning the laser line by line and moving the stage in the z-direction. The measuring speed is adjusted such that capturing one frame takes four to five seconds. The experiment is conducted as a time-series. A CO₂ gas stream of 10 SCCM through the gas chamber along the back of the GDE was turned on after 1 minute of continuous measurements. This time point was later defined as t=0 s.

Experiments to map the pOH around an operating GDE performing CO₂ reduction are performed with the electrochemical cell and the GDE described above. Aqueous electrolytes of different KHCO₃ concentrations are used (100 mM, 200 mM and 400 mM). Before each experiment, the electrolyte is bubbled with 30 SCCM CO₂ gas for at least 30 minutes. The pH is monitored with a pH meter and bubbling is continued until the pH stabilized. This ensured that the electrolyte is saturated with CO₂. All experiments are conducted with both DHPDS and APTS dyes. The dye is dissolved in the CO₂-saturated electrolyte: DHPDS at a concentration of 100 μM to investigate current densities smaller in magnitude than −20 mA/cm², APTS at a concentration of 200 μM for 100 mM KHCO₃ electrolyte/300 μM for 200mM and 400 mM KHCO₃ electrolyte, to investigate current densities larger in magnitude than −20 mA/cm². The electrochemical cell is assembled with a Cu GDE, Ag/AgCl leakless reference electrode and Pt mesh counter electrode. The cell is placed under the confocal microscope and the electrolyte chamber is filled with the prepared electrolyte. All experiments are conducted with electrolyte flow (6 mL/min through two perpendicular inlets) and with a gas stream of 10 SCCM CO₂ through the gas chamber of the electrochemical cell. To determine the series resistance of the cell filled with electrolyte, potentiostatic electrochemical impedance spectroscopy (PEIS) is performed before each experiment. This allowed to perform an 85% IR electronic compensation of the electrochemical potential. A trench that is approximately 20 μm wide was identified on the GDE surface. The stage is positioned such that the focal point of the objective was 20 μm below the GDE surface inside the trench. A constant current is applied with the potentiostat. Measuring under galvanostatic conditions enables a constant flux of ions between electrodes. The system is allowed to reach steady state for 15 seconds, then a frame is captured in the x-y plane as described above. The speed is set to three such that taking one image takes approximately 45 seconds. The same procedure is repeated for the focal point being at the GDE surface and 20 μm above the surface for various different current densities. In between each measurement, the electrolyte is removed and replaced to introduce fresh, unused dye. All measurements are conducted at least three times.

An electrochemical cell optimized for use with gas chromatography is used for product detection during the performance of CO₂R experiments with copper on carbon paper GDEs. A leakless Ag/AgCl electrode served as reference electrode and a platinum mesh as counter electrode. An anion exchange membrane (AGC, Selemion AMV) is used to separate cathode and anode. The gas chamber takes the form of a serpentine channel at the back of the GDE. The cell is sonicated before each experiment for at least 40 minutes and rinsed thoroughly after each experiment. 100 mM KHCO₃ saturated with CO₂ is pumped through the catholyte and anolyte chambers at a rate of 6.3 mL/min. CO₂ is fed into the gas chamber at a rate of 10 SCCM. A flow meter placed before and after the cell is used to ensure that there were no gas leaks. The gas coming from the cell is returned to a electrolyte bath as a precaution in case of electrolyte breakthrough through the GDE. From there, the gas is sent through a vapor trap to a gas chromatograph. Chronopotentiometry experiments (constant current) are carried out at −10, −50, −100 and −200 mA/cm² with a potentiostat. Before each experiment, potetiostatic electrochemical impedance spectroscopy (PEIS) is carried out to measure the resistance of the cell. This allowed to compensate the electrochemical potential by 85% with IR compensation.

### Example 5: 6-bromo-5-aminonaphthalene-1-sulfonate

6-bromo-5-aminonaphthalene-1-sulfonate can be synthesized following the protocol described below. The threads of a 20 mL scintillation vial was taped with Teflon tape. To this vial, sodium 5-aminonaphthalene-1-sulfonate (111.5 mg, 0.5 mmol), N-bromosuccinimide (86 mg, 0.5 mmol), and mandelic acid (12 mg, 20 mol %) were added. The solids were then dissolved in a solution of H₂O:MeCN (1:1 v/v, 4 mL) and stirred at room temperature for 24 h. The reaction was then transferred to a separatory funnel, quenched with saturated NaHCO₃, and extracted with EtOAc. The aqueous layer was collected and concentrated under reduced pressure and the remaining solids were triturated with MeOH. The resultant mixture was then filtered, and the filtrate was collected and absorbed onto Celite under reduced pressure. The resulting powder was purified using RediSep Gold Normal-Phase Silica Columns (MeOH/DCM 0:1-1:1 gradient, TLC R_{f}=0.47 in MeOH/DCM 1:3) and the fractions were collected and concentrated under reduced pressure to yield 20.6 mg of a pale orange solid (14%). ¹H NMR (500 MHz, CD₃OD) δ 8.17 (dd, J=2.85, 0.94 Hz, 1 H), 8.15 (s, 1 H), 8.11 (dd, J=9.23, 0.57 Hz, 1 H), 7.53 (d, J=9.24 Hz, 1 H), 7.45 (dd, J=8.41, 7.39 Hz, 1 H). ESI-TOF calculated for C₁₀H₇BrNO₃S⁻ [M-Na]⁻301.9, 299.9, found 301.8, 299.7.

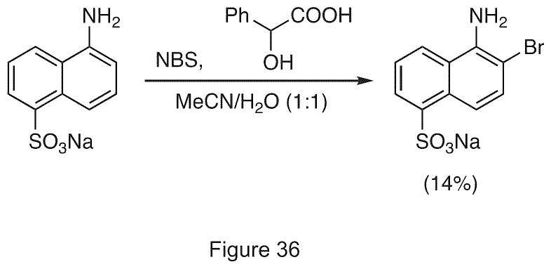

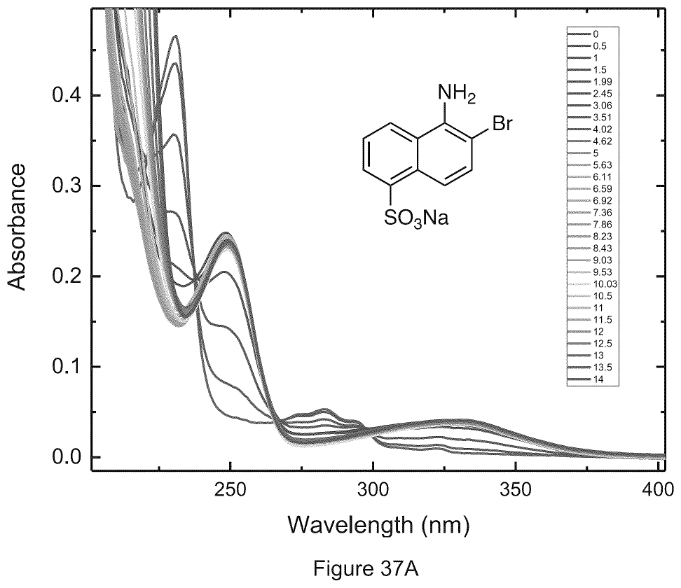

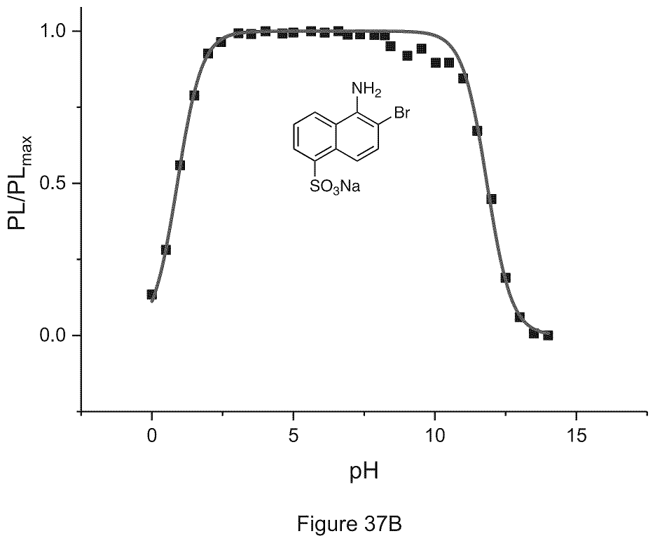

FIG. 36 illustrates a synthesis scheme of 6-bromo-5-aminonaphthalene-1-sulfonate in accordance with an embodiment of the invention. FIG. 37A illustrates electronic absorption spectra of aqueous sodium bromo-aminonaphthalene-sulfonate at the indicated pH values and room temperature (20-25° C.) in accordance with an embodiment of the invention. FIG. 37B illustrates photoluminescence titration data of aqueous sodium 6-bromo-5-aminonaphthalene-1-sulfonate illustrating three regions of pH sensing in accordance with an embodiment of the invention.

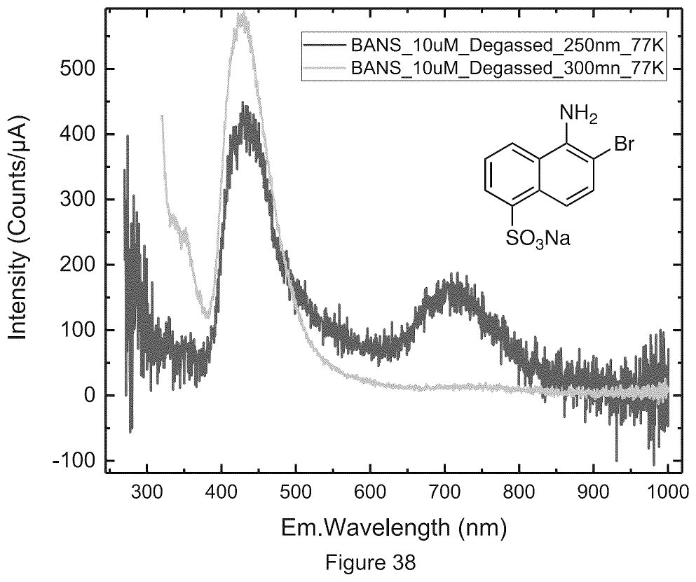

FIG. 38 illustrates the photoluminescence intensity of 6-bromo-5-aminonaphthalene-1-sulfonate in a frozen ethanol/methanol glass (4:1, v/v) at 77 K in accordance with an embodiment of the invention.

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A measurement system comprising:
a confocal microscope; and
an electrochemical cell comprising an electrode submerged in an electrolyte comprising a photochemical compound; wherein a change in a species concentration in the electrolyte at the electrode changes a fluorescent signal of the photochemical compound such that the confocal microscope detects the fluorescent signal change to measure the concentration of the species;
wherein the photochemical compound comprises a photoacid or a photobase;
wherein the species is selected from the group consisting of: OH⁻, H⁺, a proton acceptor, a proton donor, a dissolved inorganic carbon, formate, acetate, glycine, and phosphate; and
wherein the measured concentration signal has a time resolution of less than one second, and a spatial resolution of less than one micron.

2. The system of claim 1, wherein the photoacid or the photobase is a ratiometric fluorescent dye and the fluorescent signal is independent of the photoacid or the photobase concentration.

3. The system of claim 1, wherein a base-10 logarithm of an acid dissociation constant (pKₐ) of the photoacid in ground-state is greater than 14.

4. The system of claim 3, wherein the photoacid is selected from the group consisting of: 8-aminopyrene-1,3,6-trisulfonic acid trisodium salt (APTS), 8-anilinonaphthalene-1-sulfonic acid sodium salt, 5-((2-aminoethyl)amino)naphthalene-1-sulfonic acid sodium salt, 5-aminonaphthalene-1-sulfonic acid sodium salt (NS—NH₂), 6-bromo-5-aminonaphthalene-1-sulfonic acid sodium salt, and any combinations thereof.

5. The system of claim 1, wherein the photoacid comprises APTS and DHPDS, and the measured concentration signal is pOH ranging from 0 to 8.

6. The system of claim 1, wherein photoacid comprises APTS, and the measured concentration signal is pH ranging from 0 to 4.

7. The system of claim 1, wherein the photoacid comprises 5-((2-aminoethyl)amino)naphthalene-1-sulfonic acid sodium salt, and the measured concentration signal is pOH ranging from 0 to 6.

8. The system of claim 1, wherein the photoacid comprises 9-hydroxyphenanthrene-3,10-disufonic acid disodium salt, and the species is a dissolved inorganic carbon, formate, acetate, or a proton acceptor.

9. The system of claim 1, wherein the photoacid comprises 1-hydroxypyrene, and the species is a dissolved inorganic carbon.

10. The system of claim 1, wherein the photoacid comprises 6-bromo-5-aminonaphthalene-1-sulfonic acid sodium salt, and the species is a proton acceptor; wherein the detection occurs from a triplet electronic excited state.

11. The system of claim 1, wherein the measured concentration signal has a spatial resolution from 250 nm to one micron.

12. The system of claim 1, wherein the confocal microscope is selected from the group consisting of: a confocal laser scanning microscope, a laser confocal scanning microscope, a fluorescence confocal laser scanning microscope.

13. The system of claim 1, further comprising a gas chamber in contact with the electrode and the electrode is a gas diffusion electrode.

14. The system of claim 13, wherein gaseous carbon dioxide is fed through the gas chamber and reacts with OH⁻ to form bicarbonate and carbonate anions, resulting in a decrease in OH⁻ concentration.

15. The system of claim 14, wherein an applied current at the electrode induces carbon dioxide reduction reactions that generate OH⁻; wherein an increase in applied current density results in a decrease in pOH.

16. The system of claim 15, wherein the current density ranges from 0 mA/cm² to 200 mA/cm² in magnitude.

17. The system of claim 13, wherein the gas diffusion electrode comprises a macro-porous gas diffusion layer, a hydrophobic microporous layer, and a catalyst.

18. The system of claim 13, wherein the gas diffusion electrode comprises a surface with a plurality of trenches.

19. The system of claim 18, wherein the plurality of trenches has an irregular pattern with a width ranging from 5 microns to 30 microns.

20. The system of claim 18, wherein a pOH inside the plurality of trenches is lower than the gas diffusion electrode surface.

21. A method for measuring pOH comprising:
connecting a confocal microscope with an electrochemical cell comprising an electrode submerged in an electrolyte comprising a photochemical compound; wherein a change in a species concentration in the electrolyte at the electrode changes a fluorescent signal of the photochemical compound;
measuring the fluorescent signal with the confocal microscope; and
generating a concentration of the species based on the measured fluorescent signal;
wherein the photochemical compound comprises a photoacid or a photobase;
wherein the species is selected from the group consisting of: OH⁻, H⁺, a proton acceptor, a proton donor, a dissolved inorganic carbon, formate, acetate, glycine, and phosphate; and
wherein the measured concentration signal has a time resolution of less than one second, and a spatial resolution of less than one micron.

22. The method of claim 21, wherein the photoacid or the photobase is a ratiometric fluorescent dye and the fluorescent signal is independent of the photoacid or the photobase concentration.

23. The method of claim 21, wherein a base-10 logarithm of an acid dissociation constant (pKₐ) of the photoacid in ground-state is greater than 14.

24. The method of claim 21, wherein the photoacid is selected from the group consisting of: 8-aminopyrene-1,3,6-trisulfonic acid trisodium salt (APTS), 8-anilinonaphthalene-1-sulfonic acid sodium salt, 5-((2-aminoethyl)amino)naphthalene-1-sulfonic acid sodium salt, 5-aminonaphthalene-1-sulfonic acid sodium salt (NS—NH₂), 6-bromo-5-aminonaphthalene-1-sulfonic acid sodium salt, and any combinations thereof.

25. The method of claim 21, wherein the photoacid comprises APTS and DHPDS, and the measured concentration signal is pOH ranging from 0 to 8.

26. The method of claim 21, wherein the photoacid comprises APTS, and the measured concentration signal is pH ranging from 0 to 4.

27. The method of claim 21, wherein the photoacid comprises 5-((2-aminoethyl)amino)naphthalene-1-sulfonic acid sodium salt, and the measured concentration signal is pOH ranging from 0 to 6.

28. The method of claim 21, wherein the photoacid comprises 9-hydroxyphenanthrene-3,10-disufonic acid disodium salt, and the species is a dissolved inorganic carbon, formate, acetate, or a proton acceptor.

29. The method of claim 21, wherein the photoacid comprises 1-hydroxypyrene, and the species is a dissolved inorganic carbon.

30. The method of claim 21, wherein the photoacid comprises 6-bromo-5-aminonaphthalene-1-sulfonic acid sodium salt, and the species is a proton acceptor; wherein the measurement occurs from a triplet electronic excited state.

31. The method of claim 21, wherein the measured pOH has a spatial resolution from 250 nm to one micron.

32. The method of claim 21, wherein the confocal microscope is selected from the group consisting of: a confocal laser scanning microscope, a laser confocal scanning microscope, a fluorescence confocal laser scanning microscope.

33. The method of claim 21, wherein the electrochemical cell further comprises a gas chamber in contact with the electrode and the electrode is a gas diffusion electrode.

34. The method of claim 33, wherein gaseous carbon dioxide is fed through the gas chamber and reacts with OH⁻ to form bicarbonate and carbonate anions, resulting in a decrease in OH⁻ concentration.

35. The method of claim 34, wherein an applied current at the electrode induces carbon dioxide reduction reactions that generates OH⁻; wherein an increase in applied current density results in a decrease in pOH.

36. The method of claim 35, wherein the current density ranges from 0 mA/cm² to 200 mA/cm² in magnitude.

37. The method of claim 33, wherein the gas diffusion electrode comprises a macro-porous gas diffusion layer, a hydrophobic microporous layer, and a catalyst.

38. The method of claim 33, wherein the gas diffusion electrode comprises a surface with a plurality of trenches.

39. The method of claim 38, wherein the plurality of trenches has an irregular pattern with a width ranging from 5 microns to 30 microns.

40. The method of claim 38, wherein the pOH inside the plurality of trenches is lower than the gas diffusion electrode surface.
